(19) United States
(12) Patent Application Publication
(10) Pub. No.: US 2025/0258928 A1
(43) Pub. Date: Aug. 14, 2025

(54) SYSTEMS AND METHODS FOR MODELING MICRO-PROTECTIONS USING CYBERSECURITY DATA AND THIRD-PARTY PARAMETERS

(71) Applicant: AS0001, Inc., Carmel, IN (US)

(72) Inventor: Jonathan J. Thompson, Carmel, IN (US)

(73) Assignee: AS0001, Inc., Carmel, IN (US)

(21) Appl. No.: 19/169,879

(22) Filed: Apr. 3, 2025

Related U.S. Application Data
(63) Continuation of application No. 18/983,083, filed on Dec. 16, 2024.
Application No. 18/983,083 is a continuation of application No. 18/627,890, filed on Apr. 5, 2024, now Pat. No. 12,189,787.
Application No. 18/627,890 is a continuation-in-part of application No. 18/203,630, filed on May 30, 2023.
(60) Provisional application No. 63/457,671, filed on Apr. 6, 2023.
(60) Provisional application No. 63/347,389, filed on May 31, 2022.

(51) Int. Cl. G06F 21/57; H04L 9/32

(52) U.S. Cl. CPC G06F 21/577; H04L 9/3213

(57) ABSTRACT

Systems, methods, and computer-readable storage media for providing a composable cyber resilience object. A method can include identifying, by one or more processing circuits, a posture state of at least one entity, generating or selecting a first plurality of code blocks corresponding with a parameters of at least one third-party, and determining the entity qualifies for protection based on the posture state and the rules or conditions. The method can include generating or selecting a second plurality of code blocks including functions to provide the protection based on the rules or conditions and generating the composable cyber resilience object by integrating a portion of the first plurality of code blocks and the second plurality of code blocks into at least one data structure. The method can include linking the composable cyber resilience object and a computing or networking infrastructure of the entity using a communication interface or structure.

### CROSS-REFERENCE TO RELATED PATENT APPLICATIONS

The present application is a continuation-In-part of U.S. Non-Provisional patent application Ser. No. 18/983,083, filed Dec. 16, 2024, which is a Continuation of U.S. Non-Provisional patent application Ser. No. 18/627,890, filed Apr. 5, 2024, which is a Continuation-in-part of U.S. Non-Provisional patent application Ser. No. 18/203,630, filed May 30, 2023, which claims the benefit of U.S. Provisional Patent Application No. 63/347,389, filed May 31, 2022, and U.S. Provisional Patent Application No. 63/457,671, filed Apr. 6, 2023, each of which is incorporated herein by reference in its entirety and for all purposes.

### BACKGROUND

The present disclosure relates generally to computer security architecture and software for information security and cybersecurity. In a computer networked environment, entities such as people or companies have vulnerability that can result in security incidents. Some entities can desire to implement protections, and some entities can desire to offer protections.

### SUMMARY

Some implementations relate to relate to a method for providing a composable cyber resilience object, the method including identifying, by one or more processing circuits, a posture state of at least one entity based at least on configurations, assets, incidents, or safeguards of the at least one entity. The method can include generating or selecting, by the one or more processing circuits, a first plurality of code blocks corresponding with a plurality of parameters of at least one third-party, and the plurality of parameters correspond with one or more rules or conditions for providing at least one protection to the at least one entity. The method can include determining, by the one or more processing circuits, the at least one entity qualifies for the at least one protection based on the posture state and the one or more rules or conditions. The method can include generating or selecting, by the one or more processing circuits, a second plurality of code blocks including one or more functions to provide the at least one protection based on the one or more rules or conditions. The method can include generating, by the one or more processing circuits, the composable cyber resilience object, and generating can include integrating at least a portion of the first plurality of code blocks and the second plurality of code blocks into at least one data structure corresponding with one or more functions or fields of the composable cyber resilience object. The method can include linking, by the one or more processing circuits, the composable cyber resilience object and at least one computing or networking infrastructure of the at least one entity using a communication interface or structure.

In some implementations, the at least one data structure corresponds with at least one control structure, and integrating at least a portion of the first plurality of code blocks and the second plurality of code blocks into the at least one data structure includes generating, by the one or more processing circuits, the at least one control structure configured to update metadata of the first plurality of code blocks and perform the one or more functions of the second plurality of code blocks based at least on the metadata, and identifying, by the one or more processing circuits using the at least one control structure, at least one of (i) an update to the metadata or the one or more functions or (ii) a cyber event or incident corresponding with the at least one computing or networking infrastructure of the at least one entity.

In some implementations, the method can include, in response to identifying the at least one of (i) the update to the metadata or the one or more functions or (ii) the cyber event or incident, updating, by the one or more processing circuits, using the at least one control structure, the metadata of the first plurality of code blocks or the one or more functions, or performing, by the one or more processing circuits, using the at least one control structure, at least one function of the one or more functions to provide the at least one protection based on the metadata of the first plurality of code blocks. The method can include generating, by the one or more processing circuits, a ledger record corresponding with the metadata of the first plurality of code blocks or the at least one function, and recording, by the one or more processing circuits, the ledger record to a distributed ledger or data source.

In some implementations, the first plurality of code blocks include at least a declarations block, and the method can include receiving, by the one or more processing circuits using the communication interface or structure, an update corresponding with the one or more rules or conditions or the at least one computing or networking infrastructure of the at least one entity, and updating, by the one or more processing circuits, the composable cyber resilience object by (i) updating metadata of the declarations block and (ii) re-generating the second plurality of code blocks based at least on the declarations block.

In some implementations, the second plurality of code blocks include one or more coverage blocks, the one or more coverage blocks corresponding with at least one agreement by the at least one third-party to provide the at least one protection and including at least one function of the one or more functions, and the method can include performing, by the one or more processing circuits, the at least one function, wherein performing causes the one or more coverage blocks to provide at least one of a ransomware protection data package, a fault protection data package, or an interruption protection data package to the at least one computing or networking infrastructure using the communication interface or structure.

In some implementations, the first plurality of code blocks include at least an exclusion block, and the method can include determining, by the one or more processing circuits using the exclusion block, a restriction or limitation corresponding with providing the at least one protection based on modeling the configurations, assets, incidents, or safeguards of the at least one entity and the plurality of parameters of the at least one third-party, and updating, by the one or more processing circuits, the composable cyber resilience object by (i) updating metadata of the exclusion block and (ii) re-generating the second plurality of code blocks based on the restriction or limitation.

In some implementations, the first plurality of code blocks include at least a conditions block, and the method can include transmitting, by the one or more processing circuits using the conditions block, one or more compliance requests to the at least one computing or networking infrastructure of the at least one entity, updating, by the one or more processing circuits based on at least one response to the one or more compliance requests, the one or more rules or conditions for providing the at least one protection by updating metadata of the conditions block, and the at least one response to the one or more compliance requests includes compliance data corresponding with the configurations, assets, incidents, or safeguards of the at least one entity, and configuring, by the one or more processing circuits using the conditions block, one or more additional compliance requests for the at least one entity based the plurality of parameters or the at least one response to the one or more compliance requests.

In some implementations, the method can include receiving, by the one or more processing circuits using the communication interface or structure, one or more updated configurations, assets, incidents, or safeguards of the at least one entity; modeling, by the one or more processing circuits, the one or more updated configurations, assets, incidents, or safeguards to determine an updated security posture; and updating, by the one or more processing circuits, the composable cyber resilience object by (i) updating metadata of the first plurality of code blocks and (ii) re-generating or re-selecting the second plurality of code blocks based on the updated security posture.

In some implementations, the method can include determining, by the one or more processing circuits, the at least one entity qualifies for the at least one protection based on modeling a cyber resilience of the at least one computing or networking infrastructure using one or more of the configurations, assets, incidents, or safeguards and the plurality of parameters of the at least one third-party.

In some implementations, the linking the composable cyber resilience object to the at least one computing or networking infrastructure can include identifying, by the one or more processing circuits, at least one resource of the at least one computing or networking infrastructure using the communication interface or structure, and the at least one resource corresponds to at least one of the configurations, assets, incidents, or safeguards of the at least one entity, and storing, by the one or more processing circuits, in a distributed ledger or data source corresponding with the at least one computing or networking infrastructure, at least one of an identifier or metadata corresponding with the composable cyber resilience object in association with the at least one resource.

Some implementations relate to a system for providing a composable cyber resilience object. The system can include one or more processing circuits configured to identify a posture state of at least one entity based at least on configurations, assets, incidents, or safeguards of the at least one entity. The one or more processing circuits can be configured to generate or select a first plurality of code blocks corresponding with a plurality of parameters of at least one third-party, and the plurality of parameters correspond with one or more rules or conditions for providing at least one protection to the at least one entity. The one or more processing circuits can be configured to determine at least one entity qualifies for the at least one protection based on the posture state and the one or more rules or conditions. The one or more processing circuits can be configured to generate or select a second plurality of code blocks including one or more functions to provide the at least one protection based on the one or more rules or conditions; generate the composable cyber resilience object, and generating includes integrating at least a portion of the first plurality of code blocks and the second plurality of code blocks into at least one data structure corresponding with one or more functions or fields of the composable cyber resilience object. The one or more processing circuits can be configured to link the composable cyber resilience object and at least one computing or networking infrastructure of the at least one entity using a communication interface or structure.

In some implementations, the at least one data structure corresponds with at least one control structure, and wherein to integrate at least a portion of the first plurality of code blocks and the second plurality of code blocks into the at least one data structure, the one or more processing circuits to generate the at least one control structure configured to update metadata of the first plurality of code blocks and perform the one or more functions of the second plurality of code blocks based at least on the metadata, and identify, using the at least one control structure, at least one of (i) an update to the metadata or the one or more functions or (ii) a cyber event or incident corresponding with the at least one computing or networking infrastructure of the at least one entity.

In some implementations, the one or more processing circuits can be configured to, in response to identifying the at least one of (i) the update to the metadata or the one or more functions or (ii) the cyber event or incident, update, using the at least one control structure, the metadata of the first plurality of code blocks or the one or more functions, or perform, using the at least one control structure, at least one function of the one or more functions to provide the at least one protection based on the metadata of the first plurality of code blocks. The one or more processing circuits can be configured to generate a ledger record corresponding with the metadata of the first plurality of code blocks or the at least one function and record the ledger record to a distributed ledger or data source.

In some implementations, the first plurality of code blocks include at least a declarations block, and the one or more processing circuits to receive, using the communication interface or structure, an update corresponding with the one or more rules or conditions or the at least one computing or networking infrastructure of the at least one entity, and update the composable cyber resilience object by (i) updating metadata of the declarations block and (ii) re-generating the second plurality of code blocks based at least on the declarations block.

In some implementations, the second plurality of code blocks include one or more coverage blocks, the one or more coverage blocks corresponding with at least one agreement by the at least one third-party to provide the at least one protection and including at least one function of the one or more functions, and the one or more processing circuits to perform the at least one function, wherein performing causes the one or more coverage blocks to provide at least one of a ransomware protection data package, a fault protection data package, or an interruption protection data package to the at least one computing or networking infrastructure using the communication interface or structure.

In some implementations, the first plurality of code blocks include at least an exclusion block, and the one or more processing circuits to determine, using the exclusion block, a restriction or limitation corresponding with providing the at least one protection based on modeling the configurations, assets, incidents, or safeguards of the at least one entity and the plurality of parameters of the at least one third-party, and update the composable cyber resilience object by (i) updating metadata of the exclusion block and (ii) re-generating the second plurality of code blocks based on the restriction or limitation.

In some implementations, the first plurality of code blocks include at least a conditions block, and the one or more processing circuits to transmit, using the conditions block, one or more compliance requests to the at least one computing or networking infrastructure of the at least one entity, update, based on at least one response to the one or more compliance requests, the one or more rules or conditions for providing the at least one protection by updating metadata of the conditions block, and the at least one response to the one or more compliance requests includes compliance data corresponding with the configurations, assets, incidents, or safeguards of the at least one entity, and configure, using the conditions block, one or more additional compliance requests for the at least one entity based the plurality of parameters or the at least one response to the one or more compliance requests.

In some implementations, the one or more processing circuits to receive, using the communication interface or structure, one or more updated configurations, assets, incidents, or safeguards of the at least one entity, model, by the one or more processing circuits, the one or more updated configurations, assets, incidents, or safeguards to determine an updated security posture, and update, by the one or more processing circuits, the composable cyber resilience object by (i) updating metadata of the first plurality of code blocks and (ii) re-generating or re-selecting the second plurality of code blocks based on the updated security posture.

In some implementations, the one or more processing circuits to determine the at least one entity qualifies for the at least one protection based on modeling a cyber resilience of the at least one computing or networking infrastructure using one or more of the configurations, assets, incidents, or safeguards and the plurality of parameters of the at least one third-party.

In some implementations, the techniques described herein relate to a non-transitory computer readable storage medium (CRM) including one or more instructions stored thereon, the one or more instructions executable by one or more processing circuits to identify a posture state of at least one entity based at least on configurations, assets, incidents, or safeguards of the at least one entity, generate or select a first plurality of code blocks corresponding with a plurality of parameters of at least one third-party, and the plurality of parameters correspond with one or more rules or conditions for providing at least one protection to the at least one entity, determine at least one entity qualifies for the at least one protection based on the posture state and the one or more rules or conditions, generate or select a second plurality of code blocks including one or more functions to provide the at least one protection based on the one or more rules or conditions, generate a composable cyber resilience object, wherein generating includes integrating at least a portion of the first plurality of code blocks and the second plurality of code blocks into at least one data structure corresponding with one or more functions or fields of the composable cyber resilience object, and link the composable cyber resilience object and at least one computing or networking infrastructure of the at least one entity using a communication interface or structure.

### BRIEF DESCRIPTION OF THE DRAWINGS

FIG. 1A depicts a block diagram of an implementation of a system for managing and configuring incident responses, according to some implementations.

FIG. 1B depicts a block diagram of a more detailed architecture of certain systems or devices of FIG. 1A, according to some implementations.

FIG. 2 depicts a computer system, according to some implementations.

FIG. 3 depicts an architecture that facilitates data acquisition and analysis, according to some implementations.

FIGS. 4A-4B depicts a flowchart for a method for incident response preparedness and readiness, according to some implementations.

FIG. 5 depicts an example vendor-provider marketplace, according to some implementations.

FIG. 6 depicts a flowchart for a method for capturing the state of capabilities, according to some implementations.

FIG. 7 depicts a block diagram of an implementation of a security architecture for modeling a protection application, according to some arrangements.

FIGS. 8A-8C depict example graphical user interfaces, according to some arrangements.

FIG. 9 depicts a flowchart of a method for modeling a protection application, according to some arrangements.

FIG. 10 depicts a block diagram of an implementation of a system for modeling micro-protections using cybersecurity data and third-party parameters, according to some implementations.

FIG. 11 depicts a block diagram of a system for providing a composable cyber resilience object, according to some implementations.

FIG. 12 depicts a block diagram of a system for providing a composable cyber resilience object, according to some implementations, according to some implementations.

FIG. 13 depicts a flowchart of a method for modeling micro-protections using cybersecurity data and third-party parameters, according to some implementations.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Referring generally to the FIGURES, systems and methods relate generally to implementing a cybersecurity framework. In some implementations, the system and methods herein relate to a security architecture that employs modeling to protect data and align security postures. In some implementations, the system and methods herein relate to an architecture for modeling micro-protections using cybersecurity data and third-party parameters.

Many existing cybersecurity systems and architectures face several challenges that limit their effectiveness in managing and responding to cyber threats. One technical problem is that traditional computing architectures lack mechanisms for dynamically generating and executing modular policy logic across distributed infrastructures. For example, conventional approaches use static configuration files or precompiled logic that cannot adapt in real-time to changes in network states, third-party requirements, or cyber threats. Further, using static data can include performing manual updates and redeployments, leading to operational delays, stale logic, and/or missed cyber response windows. Further, existing systems fail to provide structured or composable objects that can bind both machine-readable metadata and executable logic in a unified format. That is, existing architectures cannot construct or maintain data structures that encode both the decision criteria of a policy (e.g., thresholds, exclusions, and/or posture qualifiers) and the execution pathways (e.g., security triggers, and/or response routines) in a modular and updatable manner. The lack of composability at the object level prevents reliable runtime modification and complicates integration across various cyber systems. That is, existing systems can lack without a unified structure for managing external rules and internal posture data and can use hardcoded duplication or isolated silos for policy logic, which in turn increases synchronization errors, limits auditability, and prevents computational scalability. Thus, existing systems include architectural flaws that degrade runtime performance, reduce visibility into protective measures, and restrict ability to automate incident-driven responses.

In some implementations, the systems and methods described herein address technical challenges associated with static or isolated cyber data by dynamically generating or assembling a composable cyber resilience object that integrates conditional logic and executable code into a unified data structure. For example, the systems and methods described herein can identify a posture state of a given infrastructure or network and can retrieve, select, and/or generate first code segments corresponding to third-party rules or conditions and second code segments that define actionable protection logic tied to the rules or conditions. Further, the systems and methods herein can integrate or embed the code segments into a unified data structure (e.g., composable object) that represents both policy logic and corresponding execution behavior and link the data structure to particular computing resources or network interfaces to facilitate real-time or near real-time responses (e.g., activation of safeguards, triggering of compliance workflows, etc.) to posture changes or cyber events.

In addition, the composable object can be updated without redeploying a full policy because fields, metadata, and/or functions of the composable object are independently modifiable over a period of time, which reduces processing load and/or memory use associated with regenerating and/or updating full data sets. Further, by linking the composable object a computing or networking infrastructure, the, the systems and methods herein can coordinate policy logic to align with evolving infrastructure states and/or real-time threats facing an entity network. That is, the systems and methods herein provide an architecture that facilitates runtime execution of various customized protections (or micro-protections) based on continuously updated posture data, providing a flexible, modular, and integrated approach to cybersecurity enforcement that is not achievable through traditional policy documents or static rule-based approaches. That is, the systems and methods herein reflect an improvement over traditional approaches by dynamically modeling cyber resilience posture, generating a dynamic cyber resilience object, and coordinating protections across entities and third-parties by executing conditional logic stored in the object without relying on manual intervention or static code.

Another technical problem facing existing cybersecurity systems and architectures is a lack of integrated incident response capabilities. In particular, many existing systems operate in silos, with separate tools for threat detection, response, and recovery. This lack of integration can lead to delays in response times, miscommunication between teams, and a lack of overall visibility into the security posture of an organization. Another problem is the lack of streamlined processes for engaging with third-party vendors for incident response services. Organizations often have to navigate through complex procurement processes during a cyber incident, losing time that could be used to mitigate the incident. Additionally, organizations often struggle to accurately assess their readiness to respond to incidents. They lack clear visibility into their own capabilities and limitations, and often do not have an effective way to communicate this information to potential response providers. Yet another problem with existing cybersecurity systems and architectures is the inability to dynamically adapt to changes in the security landscape. Many existing systems employ static defenses that are unable to adjust to new threats as they arise. This leads to vulnerabilities as attackers continually evolve their strategies and methods. Moreover, static systems also fail to account for changes in the organizational infrastructure and operations, such as the adoption of new technologies or changes in business processes, which can introduce new potential points of attack. This inability to dynamically adapt hampers the ability to maintain a robust security posture, leaving the organization exposed to a continuously evolving threat landscape.

Accordingly, the ability to prevent cyber threats, such as hacking activities, data breaches, and cyberattacks, provides entities and users (e.g., provider, institution, individual, and company) improved cybersecurity by creating a customized cybersecurity framework tailored to their specific attributes. This framework helps entities understand their current cybersecurity vulnerabilities and also connects them with appropriate vendors offering targeted protection plans. The customized framework enhances the protection of sensitive data, such as medical records and financial information, proprietary business data, and also helps safeguard the reputation of the entity. In addition to improving protection, the tailored cybersecurity framework also has the potential to reduce financial costs associated with data breaches, such as falling stock prices, costs of forensic investigations, and legal fees. The detailed design and execution of cybersecurity models for detecting and addressing vulnerabilities provide dynamic monitoring of various relationships, such as network, hardware, device, and financial relationships, between entities and vendors. The approach of providing a customized cybersecurity framework allows for significant improvements in cybersecurity by improving network security, infrastructure security, technology security, and data security. With vendors actively monitoring entities, immediate response to potential threats can be facilitated, thus further enhancing the overall security posture of the entity. This approach mitigates existing vulnerabilities and also anticipates potential threats, offering an adaptive and proactive solution to cybersecurity.

Furthermore, by utilizing a customized cybersecurity framework for entities and users, it is possible to understand existing vulnerabilities, link them to specific assets, and provide targeted protection strategies, offering the technical benefit of generating personalized remediation recommendations and avoiding and preventing successful hacking activities, cyberattacks, data breaches, and other detrimental cyber-incidents. As described herein, the systems and methods of the present disclosure can facilitate the connection of entities to suitable vendors, offering security plans tailored to their specific vulnerabilities and attributes. An additional benefit from the implementation of a customized cybersecurity framework is the ability to streamline the process of identifying and addressing vulnerabilities. This improvement facilitates rapid risk reduction but also allows for the ongoing monitoring of the entity cybersecurity status by the vendor, providing continuous protection and immediate response to potential threats. The implementation of such a framework allows entities to understand and address their current vulnerabilities but also empowers them to make informed decisions about their cybersecurity strategy. This includes selecting from a range of vendor plans and services, activating these plans, and having the peace of mind that their cybersecurity is being actively monitored and managed by professionals.

Additionally, the present disclosure provides a technical enhancement of dynamic cybersecurity architecture comprehension. For example, an entity cybersecurity vulnerabilities can be automatically understood and mapped within the process of implementing a customized cybersecurity framework, eliminating maintaining separate inventories of network weaknesses, infrastructure vulnerabilities, operating systems susceptibilities, etc. In some implementations, the implementation of this customized cybersecurity framework includes identifying potential security gaps associated with a particular entity or device identifier, such as a domain identifier (e.g., a top-level domain (TLD) identifier, a subdomain identifier, or a URL string pointing to a particular directory), an IP address, a subnet, etc. As a result, rather than separately assessing at least one (e.g., each) subclass of vulnerabilities, a computing system can utilize a unified view into a computing environment of a particular target entity (e.g., via the readiness system of the security architecture) and centrally manage the understanding of different types of vulnerabilities and associated potential security threats. For example, by initiating a comprehensive vulnerability assessment in a single operation. These vulnerability identification operations, described further herein, can include computer-executed operations to discern the entity cybersecurity status and potential threats, determine vulnerabilities based on this status and subsequently connect the entity to suitable vendors offering appropriate cybersecurity plans.

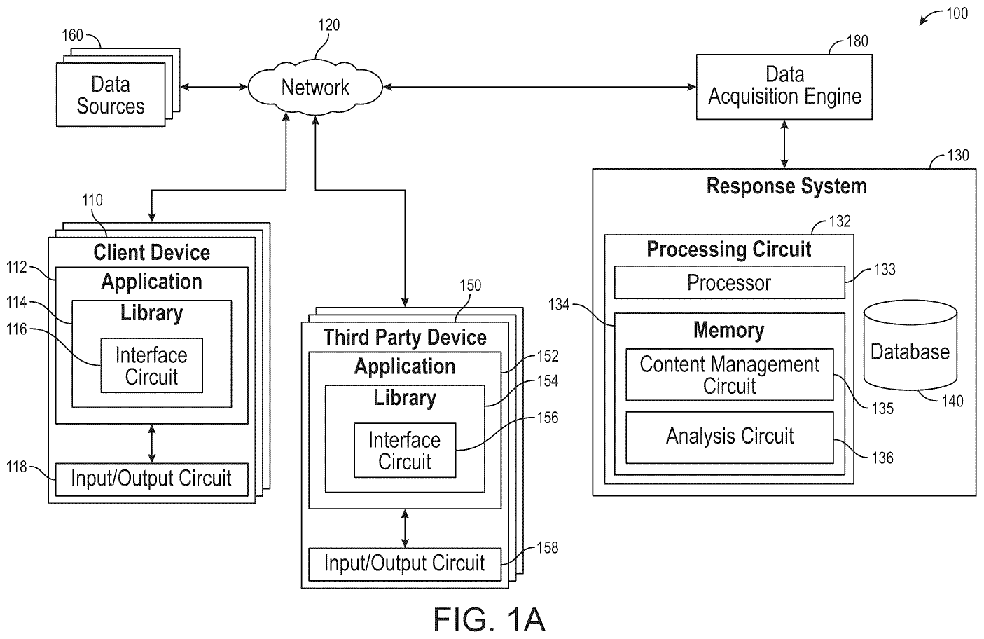

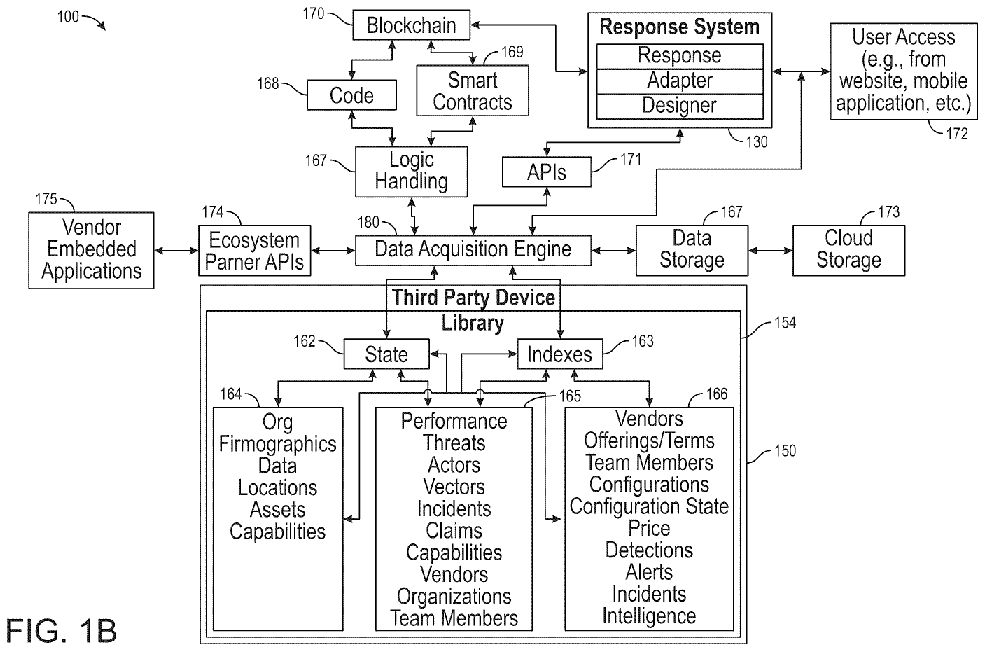

Referring to FIGS. 1A-1B generally, system 100 is an implementation of a security architecture utilizing modeling to provide an incident response management platform that includes multiple components, such as client device 110, response system 130, third party computing systems 150, and data sources 160. These components can be interconnected through a network 120 that supports secure communication protocols such as TLS, SSL, and HTTPS. In some implementations, the response system 130 can generate and provide an application for incident response readiness that guides users through the steps to prepare for and manage incidents effectively. The application can integrate with various technologies and vendors to purchase services to resolve issues, and provides integration points for incident response workflow management. For example, users can access a marketplace within the application to purchase products, insurance, and services, and can determine the capabilities, limitations, and threat focus of the organization. In some implementations, the response system 130 also presents the readiness of the organization to incident response providers and automatically routes them to pre-associated panel vendors or organization-selected vendors, contracting and activating the incident room immediately.

In some implementations, the response system 130 can integrate readiness, including insurer data, into various third party computing systems via APIs. In some implementations, the response system 130 can map an incident response (IR) plan from a static document or documents to the task enablers in Responder that bring them to life, showing where the tasks for partners such as IR firms, insurers, and breach counsel are covered by the IR plan and IR playbook. The response system 130 can decompose the response plan into associated actionable tasks and activities by the organization, incident response providers, and other stakeholders, and provides different users and partners with a unified view of tasks, activities, and progress/status tracking.

In some implementations, the response system 130 stores data regarding milestones in an authoritative data source such as blockchain (e.g., database 140) such that results are traceable and linkable. For example, issues can be identified, tasks can be created, work can be routed to vendors, and proof of resolution can be recorded. In some implementations, the response system 130 can also supports real-time status tracking of policy-aligned tasks to status updates provided for incident response. In some implementations, instant intake is achieved by a remote embeddable widget on a website, which starts an incident response process that begins with a proposal stage and continues through workflows to achieve response readiness based on pre-defined logic and automation. For example, services can be purchased or extended within the application, and in the event of an inbound incident, the application facilitates routing to a claim manager.

In some implementations, the response system 130 can provide an application for incident response readiness that guides users through the steps to determine they are prepared for any potential incidents. The application can be designed to integrate with technology and vendors to purchase services that are used to resolve any issues. For example, the user can access the application through a variety of devices, including client device 110. In particular, the application can offer integration points for incident response workflow management to allow users to streamline their incident response process. The organization incident readiness feature of the response system 130 offers several features, including the integration of readiness, including insurer data, into various third party computing systems, such as via an API. By integrating with third party computing systems, the response system 130 can determine that users have access to up-to-date information regarding the organizational readiness for potential incidents. In addition, the response system 130 can offer incident response plan mapping from a static plan document to the task enablers in Responder, which allows the tasks associated with partners such as IR firms, insurers, and breach counsel to be measurable and identified.

Still referring to FIGS. 1A-1B generally, the response system 130 can offer a marketplace for purchasing products, insurance, and services for and/or in event of an incident. The marketplace includes various vendors that offer different products and services which can be used by users to choose a fit for their organization based on their capabilities, limitations, and threat focus. The application also determines organization readiness levels with proof of date, time stamps, and artifacts (e.g., on the blockchain), which can be used to identify any gaps in the incident response plan. In some implementations, the response system 130 can automate the routing of incidents to pre-associated, panel vendors or organization-selected vendors at the point of response and immediately contracts and activates the incident room (e.g., when a cyber incident occurred or potentially occurred). Accordingly, the system 100 can determine that the organization can respond to an incident as quickly and efficiently as possible. Additionally, the response system 130 can decompose the response plan into associated actionable tasks and activities by the organization, incident response providers, and others. This allows users to better understand their response plan and identify areas for improvement.

In general, the application (e.g., graphical user interface provided by content management circuit 135) provides different users/partners with a unified view of tasks, activities, and progress/status tracking. For example, the status tracking can be tied back to incident readiness and managing the incident through resolution. Users can collaborate via the tool instead of via phone calls and emails, which can be used to determine that one or more persons are working from the same information and avoids any miscommunication. The application can also offers real-time (or near real-time) status tracking of policy aligned tasks to status updates provided for incident response, and can be used by users to quickly and easily see how their incident response plan is progressing. In some implementations, data regarding milestones is stored in an authoritative data source such as blockchain (e.g., database 140 (private ledger) or data sources 160 (public ledger)) such that results can be traceable and linkable. Thus, this can allow users to identify areas for improvement in their incident response plan and make changes. In some implementations, the response system 130 offers an instant intake feature that can be integrated into a remote embeddable widget on a website. For example, the widget can start an incident response process that starts with a proposal stage and continues through workflows to achieve response readiness based on pre-defined logic and automation. This can be used to determine that incidents are quickly identified and resolved, and that the organization is prepared for any potential incidents.

Still referring to FIG. 1A generally, the response system 130 of system 100 includes a data acquisition engine 180 and analysis circuit 136 that democratizes posture threats, incidents, and/or claim data. In particular, stakeholders in the incident response process can have access to relevant data to make informed decisions. The analysis circuit 136 can use the democratized data in underwriting, claims, and/or the resilience process to enhance the overall response to an incident. With the data acquisition engine 180, the response system 130 can collect and/or process data from various sources, such as third party computing systems 150 and/or data sources 160, to provide a comprehensive view of the security posture. In some implementations, the response system 130 also implement incident response protocols and/or features via analysis circuit 136 that provide a centralized location for managing and/or configuring incident responses. For example, an application can walk users through the steps of incident response readiness and/or integrates with technology and/or vendors to purchase services to resolve issues. The response system 130 can automate the routing of incident response tasks to pre-associated, panel vendors, or organization-selected vendors and/or immediately contracts and/or activates the incident room. By decomposing the response plan into associated actionable tasks and/or activities by the organization, incident response providers, and/or other stakeholders, the response system 130 can be used to determine that parties are working together to manage the incident through resolution.

In some implementations, the response system 130 includes a vendor-provider marketplace that allows organizations to purchase products, insurance, and/or services that enhance their incident response capabilities. For example, the marketplace can be integrated into the response system 130, allowing users to easily access relevant products and services during an incident. Additionally, the response system 130 can determine the capabilities, limitations, and threat focus of the organization to present readiness to incident response providers. In some implementations, the response system 130 can include collection, recall, and proof of state features that provide that data regarding milestones is stored in an authoritative data source such as the blockchain. This includes capabilities pre-incident, what happened after the incident occurred, what was the root cause, and recording. For example, results are traceable and linkable, and issues are identified, tasks are created, work is routed to vendors, and proof of resolution is recorded. In some implementations, the response system 130 can include a drag and drop file tokenization feature that allows users to securely tokenize and store sensitive files. In particular, this feature is useful when organizations desire to share sensitive information with third parties or with internal stakeholders. The system can be used to determine that the information is secure and that authorized parties can access it. Thus, this feature is designed to streamline the incident response process and allow better collaboration between stakeholders.

Referring now to FIG. 1A in more detail, a block diagram depicting an implementation of a system 100 for managing and/or configuring incident responses. System 100 includes client device 110, response system 130, third party computing systems 150, and data sources 160. In various implementations, components of system 100 communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. In various implementations, network 120 facilitates secure communication between components of system 100. As a non-limiting example, network 120 can implement transport layer security (TLS), secure sockets layer (SSL), hypertext transfer protocol secure (HTTPS), and/or any other secure communication protocol.

In general, the client device 110 and third party computing system 150 can execute a software application (such as application 112, e.g., a web browser, an installed application, or other application) to retrieve content from other computing systems and/or devices over network 120. Such an application can be configured to retrieve interfaces and/or dashboards from the response system 130. In one implementation, the client device 110 and/or third party computing system 150 can execute a web browser application, which provides the interface (e.g., from content management circuit 135) on a viewport of the client device 110 or third party computing system 150. The web browser application that provides the interface can operate by receiving input of a uniform resource locator (URL), such as a web address, from an input device (such as input/output circuit 118 or 158, e.g., a pointing device, a keyboard, a touch screen, or another form of input device). In response, one or more processors of the client device 110 or third party computing system 150 executing the instructions from the web browser application can request data from another device connected to the network 120 referred to by the URL address (e.g., the response system 130). The other device can then provide webpage data and/or other data to the client device 110 or third party computing system 150, which causes the interface (or dashboard) to be presented by the viewport of the client device 110 or third party computing system 150. Accordingly, the browser window presents the interface to facilitate user interaction with the interface. In some implementations, the interface (or dashboard) can be presented via an application stored on the client device 110 and third party computing system 150.

The network 120 can facilitate communication between various nodes, such as the response system 130, third party computing system 150, client device 110, and/or data sources 160. In some implementations, data flows through the network 120 from a source node to a destination node as a flow of data packets, e.g., in the form of data packets in accordance with the Open Systems Interconnection (OSI) layers. A flow of packets can use, for example, an OSI layer-4 transport protocol such as the User Datagram Protocol (UDP), the Transmission Control Protocol (TCP), or the Stream Control Transmission Protocol (SCTP), transmitted via the network 120 layered over an OSI layer-3 network protocol such as Internet Protocol (IP), e.g., IPv4 or IPv6. The network 120 is composed of various network devices (nodes) communicatively linked to form one or more data communication paths between participating devices. At least one (e.g., each) networked device includes at least one network interface for receiving and/or transmitting data, typically as one or more data packets. An illustrative network 120 is the Internet; however, other networks can be used. The network 120 can be an autonomous system (AS), e.g., a network that is operated under a consistent unified routing policy (or at least appears to from outside the AS network) and is generally managed by a single administrative entity (e.g., a system operator, administrator, or administrative group).

Client device 110 (sometimes referred to herein as a “mobile device”) can be a mobile computing device, smartphone, tablet, smart watch, smart sensor, or any other device configured to facilitate receiving, displaying, and interacting with content (e.g., web pages, mobile applications, etc.). Client device 110 can include an application 112 to receive and display content and to receive user interaction with the content. For example, application 112 can be a web browser. Additionally, or alternatively, application 112 can be a mobile application. Client device 110 can also include an input/output circuit 118 for communicating data over network 120 (e.g., receive and transmit to response system 130).

In various implementations, application 112 interacts with a content publisher to receive online content, network content, and/or application content. For example, application 112 can receive and/or present various dashboards and information resources from distributed by the content publisher (e.g., content management circuit 135). Dashboards and/or information resources can include web-based content such as a web page or other online documents. The dashboards information resources can include instructions (e.g., scripts, executable code, etc.) that when interpreted by application 112 cause application 112 to display a graphical user interface such as an interactable web page and/or an interactive mobile application to a user (e.g., dashboards). In various implementations, application 112 can include one or more application interfaces for presenting an application (e.g., mobile application, web-based application, virtual reality/augmented reality application, smart TV application and so on).

Application 112 is shown to include library 114 having an interface circuit 116. The library 114 can include a collection of software development tools contained in a package (e.g., software development kit (SDK), application programming interface (API), integrated development environment (IDE), debugger, etc.). For example, library 114 can include an application programming interface (API). In another example, library 114 can include a debugger. In yet another example, the library 114 can be an SDK that includes an API, a debugger, and/or IDE, and so on. In some implementations, library 114 includes one or more libraries having functions that interface with a particular system software (e.g., IOS, Android, Linux, etc.). Library 114 can facilitate embedding functionality in application 112. For example, a user can use library 114 to automatically transmit event logs whenever an event occurs on application 112. As a further example, library 114 can include a function configured to collect and/or report device analytics and a user can insert the function into the instructions of application 112 to cause the function to be called during specific actions of application 112 (e.g., during testing as described in detail below). In some implementations, interface circuit 116 functionalities are provided by library 114.

In various implementations, interface circuit 116 of system 100 can provide one or more interfaces to users, which can be accessed through an application interface presented in the viewport of client device 110. These interfaces can take the form of dashboards and other graphical user interfaces, offering a variety of functionality to the user. For example, a user can view incident responses, remediate claims, communicate with team members, purchase or extend products and services, and more. The interfaces provided by interface circuit 116 can be customizable and dynamic, allowing users to configure and adjust them to suit their specific attributes. They can also be designed to present real-time data associated with current incident responses, potential incidents or threats, and other information, allowing users to make informed decisions and take proactive steps to manage risk.

For example, interface circuit 116 can generate dashboards that provide real-time data and/or insights. These dashboards can be customized to suit the attributes of individual users or groups, providing a comprehensive view of incident responses, potential threats, and the status of remediation efforts. For example, a dashboard can show the status of incident responses across different regions, or highlight areas for additional resources. In another example, the interface circuit 116 can generate a landscape of currently connected devices to the entity, such as a company or institution. This can include information on the types of devices, their locations, and other details that can help inform incident response efforts. With this information, users can better understand the scope of potential threats, identify vulnerable areas, and take steps to improve security and resilience.

In another example implementation, the application 112 executed by the client device 110 can cause a web browser to the display the interfaces (e.g., dashboards) on the client device 110. For example, the user can connect (e.g., via the network 120) to a website structured to host the interfaces. In various implementations, interface can include infrastructure such as, but not limited to, host devices (e.g., computing device) and/or a collection of files defining the interface and stored on the host devices (e.g., in database 140). The web browser operates by receiving input of a uniform resource locator (URL) into a field from an input device (e.g., a pointing device, a keyboard, a touchscreen, mobile phone, or another form of input device). In response, the interface circuit 116 executing the interface in the web browser can request data such as from content (e.g., vendor information, settings, current incident response, other dashboards, etc.) from database 140. The web browser can include other functionalities, such as navigational controls (e.g., backward and forward buttons, home buttons). In some implementations, the debugging interface can include both a client-side interface and a server-side interface. For example, a client-side interface can be written in one or more general purpose programming and can be executed by client device 110. The server-side interface can be written, for example, in one or more general purpose programming languages and can be executed by the response system 130.

Interface circuit 116 can detect events within application 112. In various implementations, interface circuit 116 can be configured to trigger other functionality based on detecting specific events (e.g., transactions, in-app purchases, performing a test of a vendor, scrolling through an incident response plan, sending a contract to a vendor, spending a predefined amount of time interacting with an application, etc.). For example, interface circuit 116 can trigger a pop-up window (overlayed on an interface) upon selecting an actionable object (e.g., button, drop-down, input field, etc.) within a dashboard. In various implementations, library 114 includes a function that is embedded in application 112 to trigger interface circuit 116. For example, a user can include a function of library 114 in a transaction confirmation functionality of application 112 that causes interface circuit 116 to detect a confirmed transaction (e.g., purchase cybersecurity protection plans, partnering). It can be understood that events can include any action relevant to a user within an application and are not limited to the examples expressly contemplated herein. In various implementations, interface circuit 116 is configured to differentiate between different types of events. For example, interface circuit 116 can trigger a first set of actions based on a first type of detected event (e.g., selecting actionable objects within the static response plan) and can trigger a second set of actions based on a second type of detected event (e.g., running a test). In various implementations, interface circuit 116 is configured to collect event logs associated with the detected event and/or events and transmit the collected event logs to content management circuit 135.

In various implementations, the interface circuit 116 can collect events logs based on a designated session. In one example, the designated session can be active from when application 112 is opened/selected to when application 112 is closed/exited. In another example, the designated session can be active based on a user requesting a session to start and a session to end. At least one (e.g., each) session, the interface circuit 116 can collect event logs while the session is active. Once completed, the event logs can be provided to any system described herein. During the session, the event logs can trace at least one (e.g., each) event in the session such that the events are organized in ascending and/or descending order. In some implementations, the events can be organized utilizing various other techniques (e.g., by event type, by timestamp, by malfunctions, etc.).

In various implementations, the interface circuit 116 of the client device 110 (or third party computing system 150) can start collecting event logs when application 112 is opened (e.g., selected by the user via an input/output circuit 118 of the client device 110), thus starting a session. In some implementations, once the application is closed by the user the interface circuit 116 can stop collecting event logs, thus ending the session. In various implementations, the user can force clear event logs or force reset application 112 such that the current session can reset, thus ending a particular session and starting a new session.

The input/output circuit 118 is structured to send and receive communications over network 120 (e.g., with response system 130 and/or third party computing system 150). The input/output circuit 118 is structured to exchange data (e.g., bundled event logs, content event logs, interactions), communications, instructions, etc. with an input/output component of the response system 130. In one implementation, the input/output circuit 118 includes communication circuitry for facilitating the exchange of data, values, messages, and the like between the input/output circuit 118 and the response system 130. In yet another implementation, the input/output circuit 118 includes machine-readable media for facilitating the exchange of information between the input/output device and the response system 130. In some implementations, the input/output circuit 118 includes any combination of hardware components, communication circuitry, and machine-readable media.

In some implementations, the input/output circuit 118 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output circuit 118 can provide an interface for the user to interact with various applications (e.g., application 112) stored on the client device 110. For example, the input/output circuit 118 includes a keyboard, a keypad, a mouse, joystick, a touch screen, a microphone, a haptic sensor, a car sensor, an IoT sensor, a biometric sensor, an accelerometer sensor, a virtual reality headset, smart glasses, smart headsets, and the like. As another example, input/output circuit 118, can include, but is not limited to, a television monitor, a computer monitor, a printer, a facsimile, a speaker, and so on. As used herein, virtual reality, augmented reality, and mixed reality can be used interchangeably yet refer to any kind of extended reality, including virtual reality, augmented reality, and mixed reality.

In some implementations, input/output circuit 118 of the client device 110 can receive user input from a user (e.g., via sensors, or any other input/output devices/ports described herein). A user input can be a plurality of inputs, including by not limited to, a gesture (e.g., a flick of client device 110, a shake of client device 110, a user-defined custom gesture (e.g., utilizing an API), biological data (e.g., stress level, heart rate, hand geometry, facial geometry, psyche, and so on) and/or behavioral data (e.g., haptic feedback, gesture, speech pattern, movement pattern (e.g., hand, food, arm, facial, iris, and so on), or combination thereof, etc. In some implementations, one or more user inputs can be utilized to perform various actions on client device 110.

For example, a user can use a gesture, such as a flick or a shake, to quickly invoke an incident response through the response system 130 from their client device 110. With the use of biological and behavioral data, a user could trigger an incident response, access the vendor marketplace, or recall proof of state using custom-defined gestures via an API with input/output circuit 118. The drag and drop file tokenization feature can also be activated by a gesture, allowing a user to seamlessly tokenize files and secure them on the blockchain with a simple motion or touch on their client device 110.

Input/output circuit 118 can exchange and transmit data information, via network 120, to the devices described herein. In various implementations, input/output circuit 118 transmits data via network 120. Input/output circuit 118 can confirm the transmission of data. For example, input/output circuit 118 can transmit requests and/or information to response system 130 based on selecting one or more actionable items within the interfaces and dashboards described herein. In another example, input/output circuit 118 can transmit requests and/or information to third party computing systems 150 operated one or more vendors. In various implementations, input/output circuit 118 can transmit data periodically. For example, input/output circuit 118 can transmit data at a predefined time. As another example, input/output circuit 118 can transmit data on an interval (e.g., at ten minute intervals, twenty four hour intervals, etc.).

The third party computing system 150 includes application 152, library 154, interface circuit 156, and input/output circuit 158. The application 152, library 154, interface circuit 156, and input/output circuit 158 can function substantially similar to and include the same or similar components as the components of client device 110, such as application 112, library 114, interface circuit 116, and input/output circuit 118, described above. As such, it can be understood that the description of the client device 110, such as application 112, library 114, interface circuit 116, and input/output circuit 118 of the client device 110 provided above can be similarly applied to the application 152, library 154, interface circuit 156, and input/output circuit 158 of the third party computing system 150. However, instead of a user of a company or institution operations the third party computing system 150, a vendor or providers (e.g., goods or services) operates the third party computing system 150.

The response system 130 can include a logic device, which can be a computing device equipped with a processing circuit that runs instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and systems programming languages. The response system 130 can also include one or more databases for storing data and an interface, such as a content management circuit 135, that receives and provides data to other systems and devices on the network 120.

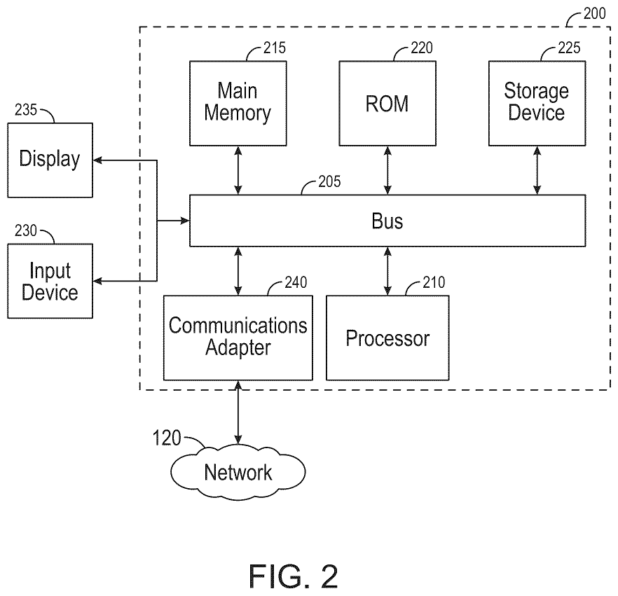

The response system 130 can be run or otherwise be executed on one or more processors of a computing device, such as those described below in FIG. 2. In broad overview, the response system 130 can include a processing circuit 132, a processor 133, memory 134, a content management circuit 135, an analysis circuit 136, a database 140, a front and 142. The interface and dashboards generated by content management circuit 135 can be provided to the client devices 110 and third party computing systems 150. Generally, the interfaces and dashboards can be rendered at the client devices 110 and/or third party computing systems 150. The content management circuit 135 can include a plurality of interfaces and properties. The interfaces and dashboards can execute at the response system 130, the client device 110, the third party computing systems 150, or a combination of the three to provide the interfaces and dashboards. In some implementations, the interfaces and dashboards generated and formatted by content management circuit 135 can be provided within a web browser. In another implementation, the content management circuit 135 executes to provide the interfaces and dashboards at the client devices 110 and third party computing systems 150 without utilizing the web browser.

The response system 130 can be a server, distributed processing cluster, cloud processing system, or any other computing device. Response system 130 can include or execute at least one computer program or at least one script. In some implementations, response system 130 includes combinations of software and hardware, such as one or more processors configured to execute one or more scripts. Response system 130 is shown to include database 140 and processing circuit 132. Database 140 can store received data. For example, the database 140 can include data structures for storing information such as, but not limited to, the front end information, interfaces, dashboards, incident information, claim information, user information, vendor information, contract information, invoices, a blockchain ledger, etc. The database 140 can be part of the response system 130, or a separate component that the response system 130, the client device 110, or the third party computing system 150 can access via the network 120. The database 140 can also be distributed throughout system 100. For example, the database 140 can include multiple databases associated with the response system 130, the client device 110, or the third party computing system 150, or three. Database 140 can include one or more storage mediums. The storage mediums can include but are not limited to magnetic storage, optical storage, flash storage, and/or RAM. Response system 130 can implement or facilitate various APIs to perform database functions (e.g., managing data stored in database 140). The APIs can be but are not limited to SQL, ODBC, JDBC, NOSQL and/or any other data storage and manipulation API.

Processing circuit 132 includes processor 133 and memory 134. Memory 134 can have instructions stored thereon that, when executed by processor 133, cause processing circuit 132 to perform the various operations described herein. The operations described herein can be implemented using software, hardware, or a combination thereof. Processor 133 can include a microprocessor, ASIC, FPGA, etc., or combinations thereof. In many implementations, processor 133 can be a multi-core processor or an array of processors. Memory 134 can include, but is not limited to, electronic, optical, magnetic, or any other storage devices capable of providing processor 133 with program instructions. Memory 134 can include a floppy disk, CD-ROM, DVD, magnetic disk, memory chip, ROM, RAM, EEPROM, EPROM, flash memory, optical media, or any other suitable memory from which processor 133 can read instructions. The instructions can include code from any suitable computer programming language.

The data sources 160 can provide data to the response system 130. In some implementations, the data sources 160 can be structured to collect data from other devices on network 120 (e.g., user devices 110 and/or third party computing systems 150) and relay the collected data to the response system 130. In one example, a user and/or entity can have a server and database (e.g., proxy, enterprise resource planning (ERP) system) that stores network information associated with the user and/or entity. In this example, the response system 130 can request data associated with specific data stored in the data source (e.g., data sources 160) of the user or entity. For example, in some implementations, the data sources 160 can host or otherwise support a search or discovery engine for Internet-connected devices. The search or discovery engine can provide data, via the data acquisition engine 180, to the response system 130. In some implementations, the data sources 160 can be scanned to provide additional data. The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases, generative artificial intelligence (GAI) data, and/or any other intelligence data associated with the specific entity of interest.

The system 100 can include a data acquisition engine 180. In various implementations, the response system 130 can be communicatively and operatively coupled to the data acquisition engine 180. The data acquisition engine 180 can include one or more processing circuits configured to execute various instructions. In various implementations, the data acquisition engine 180 can be configured to facilitate communication (e.g., via network 120) between the response system 130 and systems described herein. The facilitation of communication can be implemented as an application programming interface (API) (e.g., REST API, Web API, customized API), batch files, and/or queries. In various implementations, the data acquisition engine 180 can also be configured to control access to resources of the response system 130 and database 140.

The API can be used by the data acquisition engine 180 and/or computing systems to exchange data and make function calls in a structured format. The API can be configured to specify an appropriate communication protocol using a suitable electronic data interchange (EDI) standard or technology. The EDI standard (e.g., messaging standard and/or supporting technology) can include any of a SQL data set, a protocol buffer message stream, an instantiated class implemented in a suitable object-oriented programming language (e.g., Java, Ruby, C#), an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages can be implemented in any of the above or using another suitable technology.

In some implementations, data is exchanged by components of the data acquisition engine 180 using web services. Where data is exchanged using an API configured to exchange web service messages, one or more components of the computing environment can include or can be associated with (e.g., as a client computing device) one or more web service node(s). The web service can be identifiable using a network address, such as an IP address, and/or a URL. One or more components of the computing environment can include circuits structured to access and exchange data using one or more remote procedure call protocols, such as Java remote method invocation (RMI), Windows distributed component object model (DCOM). The web service node(s) can include a web service library including callable code functions. The callable code functions can be structured according to a predefined format, which can include a service name (interface name), an operation name (e.g., read, write, initialize a class), operation input parameters and data type, operation return values and data type, service message format, etc. In some implementations, the callable code functions can include an API structured to access on-demand and/or receive a data feed from a search or discovery engine for Internet-connected devices. Further examples of callable code functions are provided further herein as embodied in various components of the data acquisition engine 180.

The data sources 160 can provide data to the response system 130 based on the data acquisition engine 180 scanning the Internet (e.g., various data sources and/or data feeds) for data associated with a specific user or entity (e.g., vendor, insurer). That is, the data acquisition engine 180 can hold (e.g., in non-transitory memory, in cache memory, and/or in database 140) the executables for performing the scanning activities on the data sources 160. Further, the response system 130 can initiate the scanning operations. For example, the response system 130 can initiate the scanning operations by retrieving domain identifiers or other user/entity identifiers from a computer-implemented DBMS or queue. In another example, a user can affirmatively request a particular resource (e.g., domain or another entity identifier) to be scanned, which triggers the operations. In various implementations, the data sources 160 can facilitate the communication of data between the client devices 110 and third party computing systems 150, such that the data sources 160 receive data (e.g., over network 120) from the client devices 110 and third party computing systems 150 before sending the data other systems described herein (e.g., response system 130). In other implementations and as described herein, the client devices 110 and third party computing systems 150, and the data sources 160 can send data directly, over the network 120, to any system described herein and the data sources 160 can provide information not provided by any of the client devices 110 and third party computing systems 150.

As used herein, the terms “scan” and “scanning” refer to and encompass various data collection operations, which can include directly executing and/or causing to be executed any of the following operations: query(ies), search(es), web crawl(s), interface engine operations structured such that the data acquisition engine 180 can allow an appropriate system interface to continuously or periodically receive inbound data, document search(es), dataset search(es), retrieval from internal systems of previously received data, etc. These operations can be executed on-demand and/or on a scheduled basis. In some implementations, these operations include receiving data (e.g., device connectivity data, IP traffic data) in response to requesting the data (e.g., data “pull” operations). In some implementations, these operations include receiving data without previously requesting the data (e.g., data “push” operations). In some implementations, the data “push” operations are supported by the interface engine operations.

One of skill will appreciate that data received as a result of performing or causing scanning operations to be performed can include data that has various properties indicative of device properties, hardware, firmware, software, configuration information, and/or IP traffic data. For example, in an implementation, a device connectivity data set can be received. In some implementations, device connectivity data can include data obtained from a search or discovery engine for Internet-connected devices which can include a third-party product (e.g., Shodan), a proprietary product, or a combination thereof. Device connectivity data can include structured or unstructured data.

Various properties (sometimes referred to as “attributes”) (e.g., records, delimited values, values that follow particular pre-determined character-based labels) can be parsed from the device connectivity data. The properties can include device-related data and/or IP traffic data. Device-related data can encompass data related to software, firmware, and/or hardware technology deployed to, included in, or coupled to a particular device. Device-related data can include IP address(es), software information, operating system information, component designation (e.g., router, web server), version information, port number(s), timestamp data, host name, etc. IP traffic data can include items included in packets, as described elsewhere herein. Further, IP traffic data included in the device connectivity data can include various supplemental information (e.g., in some implementations, metadata associated with packets), such as host name, organization, Internet Service Provider information, country, city, communication protocol information, and Autonomous System Number (ASN) or similar identifier for a group of devices using a particular defined external routing policy. In some implementations, device connectivity data can be determined at least in part based on banner data exposed by the respective source vendor or insurer. For example, device connectivity data can include metadata about software running on a particular device of a source entity.

In various implementations, vendors and users can utilize Internet-wide scanning tools (e.g., port scanning, network scanning, vulnerability scanning, Internet Control Message Protocol (ICMP) scanning, TCP scanning, UDP scanning, semi-structured and unstructured parsing of publicly available data sources) for collecting data (e.g., states and performance of companies, corporations, users). Further, in addition to this data, other data collected and fused with the data obtained via scanning can be newsfeed data (e.g., articles, breaking news, television), social media data (e.g., Facebook, Twitter, Snapchat, TikTok), geolocation data of users on the Internet (e.g., GPS, triangulation, IP addresses), governmental databases, and any other data associated with the specific user or entity (e.g., vendor or insurer), their capabilities, configurations, cyber insurance policy, coverage, attestations, questionnaires and overall state of aforementioned attributes.

In some implementations, scanning occurs in real-time such that the data acquisition engine 180 continuously scans the data sources 160 for data associated with a specific vendor or user (e.g., real-time states of specific vendors or users, real-time threats, real-time performance). In various implementations, scanning can occur in periodic increments such that the data acquisition engine 180 can scan the Internet for data associated with the specific vendor or user periodically (e.g., by minute, hour, day, week, and any other increment of time.) In some implementations, data acquisition engine 180 can receive feeds from be various data aggregating systems that collect data associated with specific vendors or users. For example, the response system 130 can receive specific vendor or user data from the data sources 160, via the network 120 and data acquisition engine 180. The information collected by the data acquisition engine 180 can be stored in database 140. In some implementations, an entity (e.g., company, vendor, insurer, any service or goods provider, etc.) can submit data to response system 130 and provide information about their products or services, pricing, capabilities, statuses, etc., which can be stored in database 140.

Memory 134 can include analysis circuit 136. The analysis circuit 136 can be configured to perform data fusion operations, including operations to generate and/or aggregate various data structures stored in database 140, which can have been acquired as a result of scanning operations or via another EDI process. For example, the analysis circuit 136 can be configured to aggregate entity data stored in the database 140. The entity data can be a data structure associated with a specific entity and include various data from a plurality of data channels. In some implementations, the analysis circuit 136 can be configured to aggregate line-of-business data stored in the database 140. The line-of-business data can be a data structure associated with a plurality of line-of-business of an entity and indicate various data from a plurality of data channels based on line-of-business (e.g., information technology (IT), legal, marketing and sales, operations, finance and accounting).

The analysis circuit 136 can also be configured to receive a plurality of user and entity data. In some implementations, the analysis circuit 136 can be configured to receive data regarding the network 120 as a whole (e.g., stored in database 140) instead of data specific to particular users or entities. The received data that the analysis circuit 136 receives can be data that response system 130 aggregates and/or data that the response system 130 receives from the data sources 160 and/or any other system described herein. As previously described, the response system 130 can be configured to receive information regarding various entities and users on the network 120 (e.g., via device connectivity data). Further, the response system 130 can be configured to receive and/or collect information regarding interactions that a particular user or entity has on the network 120 (e.g., via IP traffic data). Further, the response system 130 can be configured to receive and/or collect additional information. Accordingly, the received or collected information can be stored as data in database 140. In various implementations, the database 140 can include user and entity profiles.

The response system 130 can be configured to electronically transmit information and/or notifications relating to various metrics, dashboards (e.g., graphical user interfaces) and/or models it determines, analyzes, fuses, generates, or fits to user data, entity data, and/or other data. This can allow a user of a particular one of the client devices 110 and third party computing systems 150 to review the various metrics, dashboards, or models which the response system 130 determines. Further, the response system 130 can use the various metrics to identify remediation actions for users and entities. The analysis circuit 136 implements data fusion operations of the response system 130. In various implementations, the analysis circuit 136 can be configured to receive a plurality of data (e.g., user and entity data) from a plurality of data sources (e.g., database 140, client devices 110, third party computing systems 150, data sources 160) via one or more data channels (e.g., over network 120). At least one (e.g., each) data channel can include a network connection (e.g., wired, wireless, cloud) between the data sources and the response system 130.

In some implementations, the analysis circuit 136 can also be configured to collect a plurality of data from a particular data source or from a plurality of data sources based on electronically transmitting requests to the data sources via the plurality of data channels, managed and routed to a particular data channel by the data acquisition engine 180. A request submitted via the data acquisition engine 180 can include a request for scanning publicly available information exposed by a user or entity. In some implementations, the request submitted via the data acquisition engine 180 can include information regarding access-controlled data being requested from the user or entity. In such cases, the request can include trust verification information sufficient to be authenticated by the target entity (e.g., multi-factor authentication (MFA) information, account login information, request identification number, a pin, certificate information, a private key of a public/private key pair). This information can be sufficient to allow the target entity to verify that a request is valid.

In various implementations, the analysis circuit 136 can be configured to initiate a scan, via the data acquisition engine 180, for a plurality of data from a plurality of data sources based on analyzing device connectivity data, vendor information, scheduling information (e.g., team members), network properties (e.g., status, nodes, element-level (sub-document level), group-level, network-level, size, density, connectedness, clustering, attributes) and/or network information (e.g., IP traffic, domain traffic, subdomain traffic, connected devices, software, infrastructure, bandwidth) of a target computer network environment and/or environments of the entity or associated with the entity. The operations to fuse various properties of data returned via the scan can include a number of different actions, which can parse device connectivity data, packet segmentation, predictive analytics, cross-referencing to data regarding known vulnerabilities, and/or searching data regarding application security history. These operations can be performed to identify costs of vendors, services offered, hosts, ports, and services in a target computer network environment. The target computer network environment can be identified by an identifier, such as a domain identifier (e.g., a top-level domain (TLD) identifier, a subdomain identifier, a URL string pointing to a particular directory), an IP address, a subnet, etc. Further, the target computer network environment can be defined with more granularity to encompass a particular component (e.g., an entity identified by an IP address, software/applications/operating systems/exposed API functions associated with a particular port number, IP address, subnet, domain identifier). In some implementations, one or more particular target computer network environments can be linked to an entity profile (e.g., in the database 140). In one example, scanning can include parsing out packet and/or device connectivity data properties that can indicate available UDP and TCP network services running on the target computer network environment. In another example, scanning can include parsing out packet and/or device connectivity data that indicates the operating systems (OS) in use on the target computer network environment.

In various implementations, vendor information can be determined based accessing a vendor device (e.g., 150) or website of the vendor to collect vendor information (e.g., via an API call). In various implementations, vulnerabilities and incidents can be determined based on any software feature, hardware feature, network feature, or combination of these, which could make an entity vulnerable to cyber threats, incidents, such as hacking activities, data breaches, and cyberattacks. In turn, cyber-threats (sometimes referred to herein as “cyber-indents” or “incidents”) increase the probability of cyber-incidents. Accordingly, a vulnerability or incident can be a weakness that could be exploited to gain unauthorized access to or perform unauthorized actions in a computer network environment (e.g., system 100). For example, obsolete computing devices and/or obsolete software can present vulnerabilities and/or threats in a computer network environment. In another example, network frameworks can present vulnerabilities and/or threats in a computer network environment. In yet another example, business practices of an entity can present vulnerabilities and/or threats in a computer network environment. In yet another example, published content on the Internet can present vulnerabilities in a computer network environment. In yet another example, third-party computing devices and/or software can present vulnerabilities and/or threats in a computer network environment. Accordingly, as shown, one or more devices (e.g., servers, computers, any infrastructure), data (e.g., network information, vendor data, network traffic, user data, certificate data, public and/or private content), practices (e.g., business practices, security protocols), software (e.g., frameworks, protocols), and any relationship an entity has with another entity can present vulnerabilities and/or threats in a computer network environment that could lead to one or more cyber-incidents.

In broad view, the analysis circuit 136 can also be configured to receive company and vendor information regarding the company/vendor. In some implementations, the analysis circuit 136 can receive a registration request and register user accounts (e.g., accounts). For example, a user of library 114 can register their user account with a client device such that the client device 110 can execute the library 114 and perform various actions. Registering a client device 110 or user (or vendor) can include, but not limited to, providing various identifying information (e.g., device name, geolocation, identifier, etc.), platform designations (e.g., IOS, Android, WebOS, BlackBerry OS, etc.), user actions (e.g., activation gesture, haptic, biometric, etc.), authentication information (e.g., username, password, two-step criteria, security questions, address information, etc.). Once the analysis circuit 136 approves a registration request, the information associated with the request can be stored in database 140. Additionally, a notification can be transmitted to the client device 110 indicating the user, vendor, or client device 110 (or third party computing system 150) is registered and can utilize the dashboards to perform actions associated with one or more applications.

In various implementations, analysis circuit 136 performs statistical operations on received data to produce statistical measurements describing the received data. For example, analysis circuit 136 can determine capabilities of individuals, objectives, cost estimates, etc. In various implementations, the statistical operations can be calculated based on performing various statistical operations and analysis. In some implementations, received data and previously collected data stored in database 140 can be used to train a machine-learning model. That is, predictions regarding vulnerabilities and incidents could be based on artificial intelligence or a machine-learning model. For example, a first machine-learning model can be trained to identify particular incidents and output a prediction. In this example, a second machine-learning model can be trained to identify remediation actions based on incident. In various implementations, machine learning algorithms can include, but are not limited to, a neural network, convolutional neural network, recurrent neural network, linear regression model, and sparse vector machine). The various computing systems/devices described herein can input various data (e.g., event logs, debugging information and so on) into the machine learning model, and receive an output from the model indicating a particular action to perform. In some implementations, analysis circuit 136 can be configured to perform source testing on one or more networks. Source testing on one or more networks can include performing various test plans. During the source testing, various malfunctions and exceptions can be identified. Additionally, the network can be identified such that the testing occurs on a designated network (e.g., or multiple designated content networks).

Memory 134 also includes content management circuit 135. The content management circuit 135 can be configured to generate content for displaying to users and vendors. The content can be selected from among various resources (e.g., webpages, applications). The content management circuit 135 is also structured to provide content (e.g., via a graphical user interface (GUI)) to the user devices 110 and/or third party computing systems 150), over the network 120, for display within the resources. For example, in various implementations, a claim dashboard or incident response dashboard can be integrated in a mobile application or computing application or provided via an Internet browser. The content from which the content management circuit 135 selects can be provided by the response system 130 via the network 120 to one or more user devices 110 and/or third party computing systems 150. In such implementations, the content management circuit 135 can determine content to be generated and published in one or more content interfaces of resources (e.g., webpages, applications).

The content management circuit 135 can be configured to interact with a database management system or data storage vault, where clients can obtain or store information. Clients can use queries in a formal query language, inter-process communication architecture, natural language or semantic queries to obtain data from the DBMS. In some implementations, one or more clients obtain data from the DBMS using queries in a custom query language such as a Visualization API Query Language. In some implementations, the content management circuit 135 can be configured to provide one or more customized dashboards (e.g., stored in database 140) to one or more computing devices (e.g., user devices 110, third party computing systems 150) for presentation. That is, the provided customized dashboards (also referred to herein as “customized interface”) can execute and/or be displayed at the computing devices described herein. In some implementations, the customized dashboards can be provided within a web browser or installed application. In some implementations, the customized dashboards can include PDF files. In some implementations, the customized dashboards can be provided via email. According to various implementations, the customized dashboards can be provided on-demand or as part of push notifications.

In various implementations, the content management circuit 135 executes operations to provide the customized dashboards to the user devices 110 and third party computing systems 150, without utilizing the web browser. In various implementations, the customized dashboards can be provided within an application (e.g., mobile application, desktop application). The dashboard from which the content management circuit 135 generates can be provided to one or more users or entities, via the network 120. In some implementations, the content management circuit 135 can select dashboards and/or interfaces associated with the user or entity to be displayed on the user devices 110 or third party computing systems 150.

In an example implementation, an application executed by the user devices 110 and/or third party computing systems 150 can cause the web browser to display on a monitor or screen of the computing devices. For example, the user can connect (e.g., via the network 120) to a website structured to host the customized dashboards. In various implementations, hosting the customized dashboard can include infrastructure such as host devices (e.g., computing device) and a collection of files defining the customized dashboard and stored on the host devices (e.g., in a database). The web browser operates by receiving input of a uniform resource locator (URL) into a field from an input device (e.g., a pointing device, a keyboard, a touchscreen, mobile phone, or another form of input device). In response, the content management circuit 135 executing the web browser can request data such as from the database 140. The web browser can include other functionalities, such as navigational controls (e.g., backward and forward buttons, home buttons, other navigational buttons or items). The content management circuit 135 can execute operations of the database 140 (or provide data from the database 140 to the user devices 110, and/or third party computing systems 150 for execution) to provide the customized dashboards at the user devices 110 and/or third party computing systems 150.

In some implementations, the content management circuit 135 can include both a client-side application and a server-side application. For example, a content management circuit 135 can be written in one or more general purpose programming languages and can be executed by user devices 110 and/or third party computing systems 150. The server-side content management circuit 135 can be written, for example, in one or more general purpose programming, or a concurrent programming language, and can be executed by the response system 130. The content management circuit 135 can be configured to generate a plurality of customized dashboards and their properties. The content management circuit 135 can generate customized user-interactive dashboards for one or more users and entities, such as the client device 110 and third party computing systems 150, based on data received, collected, and/or aggregated from the analysis circuit 136, any other computing device described herein, and/or any database described herein (e.g., 140).

The generated dashboards can include various data (e.g., data stored in database 140 and/or data sources 160) associated with one or more entities including scheduling information, profile information, cybersecurity risk and/or vulnerabilities cybersecurity vulnerabilities (e.g., malware, unpatched security vulnerabilities, expired certificates, hidden backdoor programs, super-user and/or admin account privileges, remote access policies, other policies and procedures, type and/or lack of encryption, type and/or lack of network segmentation, common injection and parameter manipulation, automated running of scripts, unknown security bugs in software or programming interfaces, social engineering, and IoT devices), insurer and vendor information (e.g., policies, contracts, products, services, underwriting, limitations), incident information, cyberattack information (e.g., phishing attacks, malware attacks, web attacks, and artificial intelligence (AI)-powered attacks), remediation items, remediation actions/executables, security reports, data analytics, graphs, charts, historical data, historical trends, vulnerabilities, summaries, help information, domain information, and/or subdomain information. As used herein, a “cyber-incident” can be any incident where a party (e.g., user, individual, institution, company) gains unauthorized access to perform unauthorized actions in a computer network environment. The database 140 can also include data structures for storing information such as system definitions for customized dashboards generated by content management circuit 135, animated or other content items, actionable objects, graphical user interface data, and/or additional information.

The analysis circuit 136 can be configured to determine organization incident readiness. Readiness is the process an organization follows to prepare for a cyber incident before it happens. This includes entering information at the initiation of an incident by incident response teams and breach counsel. Readiness levels are calculated by binary completion of the n tasks that are included in readiness activities. An organization with 10 readiness steps and 5 completed shows as 50%. In some implementations, determining organization incident readiness can include integrating readiness (e.g., insurer data and other vendor data) into third party computing systems 150. For example, the insurer data of a company insurer can be recorded and stored at a third party computing system 150. In various implementations, determining organization incident readiness can include the analysis circuit determining organization capabilities, limitations, cyber threats, and specific focus associated with cyber threats. Additionally, organization incident readiness can be provided to incident response providers (e.g., security providers, firmware providers, software providers, infostructure providers). The analysis circuit 136 can also be configured to automatically route incidents and claims to vendors associated with a company or user (e.g., client device 110) and in turn contracting and activating an incident response. In some implementations, a response plan can be submitted by a company and the analysis circuit 136 can decompose and analyze the response plan to determine actionable tasks and activities to complete (e.g., by the company or after contracting with a vendor).

In various implementations, the determined organization incident readiness can be stored (e.g., by the analysis circuit 136) as a block in a blockchain (or on a ledger) that can metadata identifying the readiness including, but not limited to, a time stamp, proof of date, and artifacts. In various implementations, the data regarding milestones (e.g., capabilities pre-incident, what happened after the incident occurred, root cause, recoding) can be stored on a blockchain (e.g., such that it is immutable). In particular, milestones can be traceable and linkable within a blockchain (or ledger) such that issues can be identified, actionable tasks can be tracked, work is routed to vendors (e.g., 150), and proof of resolution is recorded. In some implementations, database 140 can include a plurality of ledgers or blockchains and the database 140 can be a node of a plurality of nodes on a ledger or blockchain. It can be understood that the various data and information described herein can be implemented on a blockchain. For example, the blockchain can be used to provide for irrefutable proof in a data set of the data, locations, capabilities, configurations, that were in place prior to an incident. In another example, the block can be used to link the incident occurrence with what worked (e.g., effective in preventing an incident) and what did not work (e.g., vulnerability that led to the incident). For example, the irrefutable permanent ledgers (or blockchain) can be used by users at points in the process where they wish to record proofs on chain. This can include configurations, capabilities, assets, policies, threats, actors, claims, incident reports, cyber threat intelligence artifacts, and any other state-based attribute that is to be recorded and can be shared with others to irrefutably prove that the state of that attribute was “x” at time “t”. Combinations of attributes for different data, assets, configurations, capabilities, are collected and rolled up to show if any elements have changed through the use of Merkel Trees, allowing a check of the top hash of the combination of downstream values facilitating a single checkpoint to determine if any other elements and configurations, combinations of parameters is the same or if they have changed.

In various implementations, the analysis circuit 136 can intake potential or current incidents based on an embedded widget on remote web sites or within remote web applications. This allows an incident response provider or vendor (sometimes referred to herein as “IR providers” or IR vendors”) the ability to seamlessly intake incident response requests for assistance from their web site or one of their sales channel partner sites and have it load directly into the incident intake process within responder. In turn, an embedded widget could be communicably coupled to the analysis circuit 136 (e.g., via network 120) to allow the analysis circuit to start an incident response process (e.g., at proposal stage) and continue through a workflow to achieve response readiness based on pre-defined logic or rules. This rule mechanism can allow for the user to specify specific attributes, collection of attributes, order, and routing method for connecting inbound requests to those who are fit to execute on the requests. For example, when an inbound instance of an incident response can be routed to a claim manager based on pre-defined logic or rules, such as to route inbound cases to the IR provider that is active currently, or to the provider who specializes in ransomware extortion cases where the ransom exceeds 10 million, or to round-robin inbound cases among a set of panel IR providers, etc.

In some implementations, the analysis circuit 136 can facilities invoice processing within an incident response process across different insurers. Furthermore, throughout an incident response conditions can be modified, added, or removed to route tasks (or work) to different vendors or partners (e.g., 150). In some implementations, the analysis circuit 136 can also be configured to collect incident submission data, normalize the data (e.g., based on historical data or trends), and automatically submit insurance claims based on the normalized data. Moreover, the analysis circuit 136 can connect the underlying root cause to the capability failure or procedural issue and have that data submitted with the insurance claim. For example, the analysis circuit 136 can connect underlying root cause back to the insurers underwriting questions. In various implementations, the analysis circuit 136 can integrate organization incident readiness into related parties to a company. As such, the analysis circuit 136 can integrate incident response activation and collaborative across business, teams, insurers, etc. Further, the analysis circuit 136 can be configured to link the root cause of an incident to the capability failure or procedural issue and then link back the insurers underwriting questions.

The content management circuit 135 can also be configured to allow a user (e.g., of a company) to purchase and extended services via the generated dashboards. In some implementations, the content management circuit 135 allows the user (e.g., via a step through process) to integrate into technology and vendors to resolve issues (e.g., incidents) and/or prevent incidents in the future. For example, the dashboards can provide users integration points for incident response workflow management. As such, the content management circuit 135 can generate dashboards (and/or interfaces) on an application (e.g., 112 or 152) for purchasing products, insurances, and services. In particular, the generated dashboards can provide users of the application with a unified (or universal) view of tasks, activities, and progress/status tracking of incidents, claims, etc. The dashboards can also tie back to incident readiness and managing the incidents through resolution. The content management circuit 135 can also generate the dashboards to include collaboration tools (e.g., video calls, calendar, chats), and the dashboards can include real-time status tracking of policies, incidents, claims, insurers such that policy aligned tasks and status updated can be provide for incident responses and claims.

Referring now to FIG. 1B, a block diagram depicting a more detailed architecture of certain systems or devices of system 100. System 100 includes the data acquisition engine 180 and response system 130 described in detail with reference to FIG. 1A. However, it can be understood that the response system 130 also encompasses the capability to generate content and dashboards tailored for at least one (e.g., each) aspect of the response process, including the response, adapter, and designer components. These content and dashboards are generated by the content management circuit 135.

To illustrate further, the response system 130 facilitates the presentation of diverse information related to security and threats through the adapter dashboard and architecture. This facilitates a comprehensive understanding of the security landscape and helps inform decision-making processes. Additionally, the dashboard functionality can be customized by the vendor and/or organization using the designer dashboard and architecture. This empowers them to tailor the visual representation of data, making it more intuitive and aligned with their specific requirements. Furthermore, the responder dashboard and architecture provided by the response system 130 facilitate the vendor and/or organization to effectively prepare for, track, and update incidents and readiness. This comprehensive dashboard encompasses the incident response lifecycle, from the initial incident detection and response through to the final incident closure and claim submission. By leveraging the responder dashboard and architecture, the vendor and/or organization can facilitate smooth incident management, streamline processes, and facilitate efficient collaboration among stakeholders.

In the depicted architecture, both organizations and vendors operating the third party computing systems 150 or client devices 110 have the ability to store states 162 and indexes 163 within the library 154 (or library 114). In some implementations, these states 162 and indexes 163 can be determined based on data derived from various datasets, including the organization dataset 164, performance dataset 165, and vendor dataset 166.

In some implementations, the organization dataset 164 encompasses a wide range of information such as firmographics, data related to locations, assets, and capabilities of the third-party or client organization. This dataset provides a comprehensive understanding of the profile and resources of the organization. In some implementations, the performance dataset 165 includes diverse sets of data, including threat data, actor data, vector data, incident data, claim data, capability data, vendor data, organization data, and team member data. These performance-related datasets capture information for assessing the organization security posture, incident history, and overall operational performance. They facilitate effective monitoring, analysis, and decision-making in incident response activities. In some implementations, the vendor dataset 166 contains information related to offerings (cybersecurity protection plans), terms, team member data, configuration data, configuration state data, pricing details, detection data, alert data, incident data, and intelligence data. This dataset allows organizations to gain insights into the capabilities and services provided by vendors, facilitating informed decision-making when selecting and collaborating with specific vendors.

In general, the states 162 and indexes 163, derived from the datasets, are utilized as input by the data acquisition engine 180 (or analysis circuit 136) to output a security posture. In some implementations, the data acquisition engine 180 is configured to scan and perform data collection based on accessing vendor embedded applications 175, via ecosystem partner APIs 174. This facilitates seamless integration with vendor systems, allowing for efficient retrieval and synchronization of relevant data. In the depicted architecture, the states 162 and indexes 163 improve the efficient operations of the response system 130. These states 162 and indexes 163 can stored within the library 154 (or library 114) and are determined based on data from various datasets, including the organization dataset 164, performance dataset 165, and vendor dataset 166.

In some implementations, the states 162 represent the current condition or status of the organization or vendor operating the third party computing system 150 or client devices 110. They encapsulate information such as system configurations, security policies, incident response readiness, and other relevant parameters. By maintaining these states, the response system 130 can quickly access and reference up-to-date information about the environment of the organization or vendor. Additionally, in some implementations, the indexes 163 serve as pointers or references to specific data or resources within the library 154 (or library 114). They streamline the retrieval and access information by facilitating efficient data processing and analysis. These indexes are designed to provide efficient search operations and facilitate rapid access to relevant datasets, contributing to the overall responsiveness and effectiveness of the response system 130.

Accordingly, to facilitate accuracy and currency of the states 162 and indexes 163, the data acquisition engine 180 can be configured to scan and collect data by interacting with the vendor embedded applications 175. The communication can occur through ecosystem partner APIs 174, establishing a connection between the response system 130 and the embedded applications 175 used by vendors. Through this communication, the data acquisition engine 180 can retrieve real-time (or near real-time) information from the vendor systems, including offerings, configurations, alerts, incidents, and other relevant data. In some implementations, the engine 180 can utilize the retrieved data to update and synchronize the states 162 and indexes 163, providing that the response system 130 has updated and accurate information to support incident response activities.

Expand further on states 162 and indexes 163, the data acquisition engine 180 can maintain the security posture of the organization. That is, the data acquisition engine 180 can actively check a vendor API for any changes in the configuration “State,” the data acquisition engine 180 that the security posture remains up to date and aligned with the evolving environment. By recording these configuration updates to the corresponding index, the data acquisition engine 180 and response system 130 establishes a view of the security landscape of the organization. This approach goes beyond static assessments and provides a dynamic and real-time perspective of the entity security posture. By linking the configuration data with real incident data and other relevant metadata, the response system 130 enhances the accuracy and actionability of the match, facilitating quick and effective response to potential threats. In various implementations, this continuous monitoring and adaptation of the security posture over time is provided and/or presented in a posture stream, which captures and analyzes the evolving information. As new data points are gathered and recorded in the posture stream, the response system 130 can execute proactive incident response activities.

As used herein, a “security posture” refers to the current state and overall cybersecurity risk profile of an organization or vendor. It is determined based on various factors and information collected from entity data, including system configurations, security policies, incident response readiness, and other relevant parameters. In some implementations, the data acquisition engine 180 (or analysis circuit 136) scans and collects data from vendor embedded applications through ecosystem partner APIs to determine and/or maintain the accuracy and currency of the states and indexes used to represent the security posture. In various implementations, the analysis circuit 136 utilizes a distributed ledger to tokenize and broadcast the security posture, providing transparency and immutability. The analysis circuit 136 can also be configured to model the security posture and multiple security objectives to generate a set of cybersecurity attributes specific to the entity.

Furthermore, the data acquisition engine 180 is shown to gather data from blockchain 170 (e.g., ledgers storing various immutable information about entities, vendors, and corporations) via code 168 and smart contracts 169 that are executed by logic handling 167 (e.g., of the data acquisition engine 180). In some implementations, data acquisition engine 180 can communicate with response system 130 directly (e.g., via a wired or hard-wired connection) or via APIs 171. To facilitate user access and interaction with the dashboards and content generated by the response system 130, user access 172 is provided. Users, including organizations, vendors, and entities, can access the dashboards and content through dedicated applications such as application 112 or application 152. These applications can be accessed through user devices, such as client device 110, or through third party computing systems 150.

Additionally, user access 172 to the dashboards and content can be provided to users (e.g., organizations, vendors, entities) via an application (e.g., 112 or 152) a user device (e.g., 110) and/or third party computing system 150. Additional, fewer, or different systems and devices can be used. The depicted system and devices are not exhaustive, and additional, fewer, or different systems and devices can be employed depending on specific implementation requirements. The architecture can be tailored to suit the goals of organizations, vendors, and entities, allowing for flexibility and customization in the deployment of the response system 130.

In addition to gathering data from the blockchain 170, the response system 130 can establish a communication channel with the blockchain 170. This communication facilitates the response system 130 to interact with the blockchain 170 in a secure and decentralized manner. By directly accessing the blockchain 170, the response system 130 can leverage its properties of immutability, transparency, and distributed consensus to enhance the integrity and reliability of incident-related data and information. Accordingly, the response system 130 can use blockchain 170 to record and verify incident details, maintain an auditable trail of actions and transactions, and monitor the integrity of information throughout the incident response process.

It will be recognized that some or all of the figures are schematic representations for purposes of illustration. The figures are provided for the purpose of illustrating one or more implementations with the explicit understanding that they will not be used to limit the scope or the meaning of the claims.

Referring now to FIG. 2, a depiction of a computer system 200 is shown. The computer system 200 that can be used, for example, to implement a system 100, response system 130, client devices 110, third party computing systems 150, data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 can further include a read-only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 can be coupled via the bus 205 to a display 235, such as a liquid crystal display, or active matrix display, for displaying information to a user. An input device 230, such as a keyboard including alphanumeric and other keys, can be coupled to the bus 205 for communicating information, and command selections to the processor 210. In another implementation, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some implementations, the computing system 200 can include a communications adapter 240, such as a networking adapter. Communications adapter 240 can be coupled to bus 205 and can be configured to facilitate communications with a computing or communications network 120 and/or other computing systems. In various illustrative implementations, any type of networking configuration can be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein can be achieved by the computing system 200 in response to the processor 210 executing instructions contained in main memory 215. Such instructions can be read into main memory 215 from another computer-readable medium, such as the storage device 225. Execution of the instructions contained in main memory 215 causes the computing system 200 to perform the illustrative processes described herein. One or more processors in a multi-processing implementation can also be employed to execute the instructions contained in main memory 215. In alternative implementations, hard-wired circuitry can be used in place of or in combination with software instructions to implement illustrative implementations. Thus, implementations are not limited to any specific combination of hardware circuitry and software.

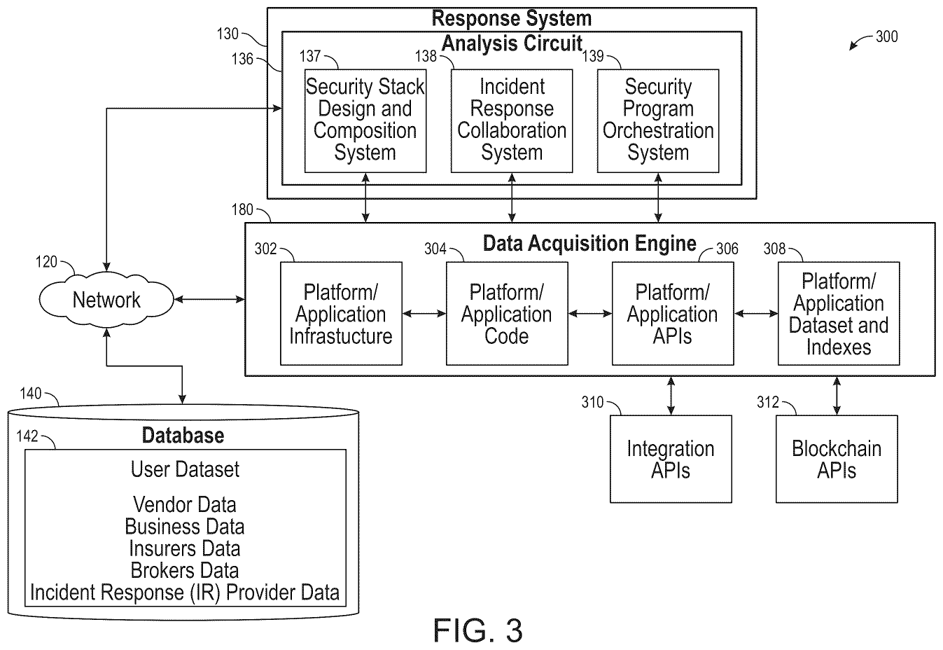

Referring now to FIG. 3, the data acquisition engine 180 and analysis circuit 136 of the response system 130, as depicted in FIGS. 1A-1B, depict an architecture that facilitates efficient data acquisition and analysis. In some implementations, a user dataset 142, containing diverse data associated with different entities and users, can be securely stored in the database 140. The systems and devices illustrated in FIG. 3 (e.g., components of system 300) communicate and exchange information over the network 120, which facilitates seamless integration and collaboration among the components.

The data acquisition engine 180 encompasses various components designed to support the execution of applications 112 and 152. These components include, but are not limited to, the platform application infrastructure 302, platform application code 304, platform application APIs 306, and platform application datasets and indexes 308. Together, these elements form the support of the data acquisition engine 180, providing the structures and resources to identify the efficient functioning of the applications. Additionally, integration APIs 310 and blockchain APIs 312 are integrated into the data acquisition engine 180 and facilitate seamless execution of API requests, data retrieval from blockchains, access to data sources 160, and integration with various vendors and third parties for streamlined data exchange. These integration APIs 310 facilitate the secure and reliable flow of information and validate the responsiveness and effectiveness of the data acquisition process.

The analysis circuit 136 is shown to include, but is not limited to, a security stack designer and composition (SSDC) system 137, an incident response collaboration (IRC) system 138, and a security program orchestration (SPO) system 139. For example, the SSDC system 137 walk users through identifying what data and computations are relevant, where the data resides, what vendor product, service, and procedural capabilities are in place to prevent/detect/respond to cyber-attacks, and based on these visualized gaps, determine what to prioritize.

The analysis circuit 136 includes several components that improve the capabilities of the response system 130. One of these components is the security stack designer and composition (SSDC) system 137, which is configured to guide users through the process of identifying and addressing potential vulnerabilities and gaps in their security infrastructure. In some implementations, the SSDC system 137 provides users with a systematic approach to evaluate the significance of their data and computational processes, determining a role of the data and/or computational processes in the context of cybersecurity. By utilizing the SSDC system 137, users can gain insights into the specific locations where their data is stored and processed, allowing for a comprehensive understanding of potential security risks. In general, the SSDC system 137 employs various techniques to identify specific locations where data is stored and processed within an organizational or entity infrastructure. In particular, by leveraging data mapping and inventory techniques that allow the SSDC system 137 to identify data repositories, databases, file systems, and other storage systems where data is stored. For example, the SSDC system 137 can analyze network traffic and data flows within an entity network to identify sources and destinations of data. By monitoring network communication and analyzing data packets, the SSDC system 137 can trace the path of data transmission and determine the endpoints where data is stored or processed.

Additionally, the SSDC system 137 can utilize data discovery and scanning mechanisms (e.g., using data acquisition engine 180) to identify data repositories within an entity infrastructure. This can include scanning file systems, databases, cloud storage, and other data repositories to identify the locations where sensitive data resides (e.g., cloud storage 173). In some implementations, the SSDC system 137 can integrate with data classification tools or metadata repositories (e.g., data sources 160) to gather information about the nature and sensitivity of the data. By understanding the characteristics and classification of data, the SSDC system 137 can identify the specific locations where sensitive data is stored or processed. By combining these techniques, the SSDC system 137 can provide organizations with a comprehensive view of the locations where data is stored and processed. It allows organizations to understand the data flow across their infrastructure and gain insights into the potential security risks associated with specific data storage and processing environments.

For example, an organization that utilizes both on-premises servers and cloud storage for data storage. The SSDC system 137 can perform an analysis of the entity network and infrastructure, monitoring data flows between different systems. It can identify the on-premises servers, databases, and file systems where one or more data objects are stored. Additionally, it can detect the cloud storage providers and specific cloud repositories where data is stored. By mapping out these locations, the SSDC system 137 provides the organization with a clear understanding of the data storage landscape and causes them to apply appropriate security measures to protect the data in at least one (e.g., each) location.

In some implementations, the SSDC system 137 facilitates an assessment of the existing vendor products, services, and procedural capabilities that are currently in place to prevent, detect, and respond to cyber-attacks. This evaluation allows users to identify any gaps or areas of improvement in their security stack. Through visualizations and analysis, the SSDC system 137 helps users prioritize their security measures based on identified gaps and vulnerabilities. By highlighting areas for attention, the SSDC system 137 empowers organizations to allocate their resources effectively and take proactive steps to enhance their overall security posture. Moreover, the SSDC system 137 is designed to be dynamic and adaptable, accommodating the ever-evolving threat landscape and the changing security parameters or attributes of organizations. It provides a user-friendly interface that simplifies the complex task of security stack design and composition, making it accessible to users with varying levels of technical expertise.

In some implementations, the IRC system 138 can be configured to collect, aggregate, and generate data and data structure that can be presented via application 112 and 152 and can be configured to determine level of importance related to matter pre-incidents, pre-associate to internal incident team members, cyber insurers, breach counsel, incident response firms, and security vendors to reduce the time it takes to activate and triage live incidents in the future. By leveraging the capabilities of the IRC system 138, organizations can efficiently manage incidents, reduce response times, and facilitate collaboration among various stakeholders.

In some implementations, the IRC system 138 can collect and aggregate relevant data. This can include gathering information from various sources such as incident reports, security logs, system alerts, and user-generated data. The IRC system 138 employs data collection mechanisms to capture and centralize this information such that incident responders have a comprehensive and consolidated view of the incident landscape. The term “incident landscape” refers to the overall environment and context in which incidents occur within entity systems and networks. It encompasses the various factors, elements, and conditions that shape the occurrence and impact of security incidents. The incident landscape includes aspects such as the entity infrastructure, network architecture, data assets, applications, user activities, potential vulnerabilities, and threat landscape. Understanding the incident landscape can be used by incident responders as it allows them to gain insights into the security challenges of the entity, identify potential attack vectors, assess risks, and develop effective incident response strategies. By comprehensively mapping and analyzing the incident landscape using the IRC system 138, organizations can proactively strengthen their defenses, detect and respond to incidents promptly, and reduce the impact of security breaches.

In some implementations, the IRC system 138 can generate data structures that facilitate the organization and presentation of incident-related information. These data structures facilitate the categorization, classification, and correlation of incident data, making it easier for incident responders to analyze and make informed decisions. The IRC system 138 can employ various techniques such as data modeling, schema design, and indexing to create efficient and structured data representations. By leveraging the data and data structures generated by the IRC system 138, organizations can determine the level of importance related to pre-incident matters. This includes assessing the potential impact and severity of different incident scenarios, identifying assets and systems, and evaluating the potential risks and vulnerabilities. This information helps organizations prioritize their incident response efforts, allocating appropriate resources and attention to high-priority incidents.

In some implementations, the IRC system 138 also facilitates pre-association of internal incident team members, cyber insurers, breach counsel, incident response firms, and security vendors. By establishing these pre-associations, organizations can expedite the activation and triaging of live incidents in the future. The IRC system 138 can maintain a database of trusted contacts and partners, allowing incident responders to quickly engage expertise and support when responding to incidents. This reduces response times and enhances the overall efficiency of technology and incident handling. Moreover, the IRC system 138 facilitates seamless collaboration among various stakeholders included in incident response. It provides a unified platform where team members can share information, communicate, and coordinate their efforts. The IRC system 138 can include features such as real-time messaging, task assignment, document sharing, and incident status tracking to facilitate effective collaboration and determine that all stakeholders are aligned and working towards a common goal.

The security program orchestration (SPO) system 139 can be configured to manage and adapt an entity security program to address changes in the security posture and cyber threats. In some implementations, it operates by receiving inputs that indicate the changing state of the security posture, which can come from various sources such as technical indicators or human-assisted inputs through APIs or social media sharing. These inputs provide information about emerging threats, vulnerabilities, or changes in the entity security landscape. Once the SPO system 139 receives these inputs, it analyzes and evaluates the information to determine adjustments and changes for the security program. This includes identifying specific areas or aspects of the security program that are to be modified, such as updating security policies, configurations, access controls, or implementing additional security measures.

The orchestration aspect of the SPO system 139 coordinates and manages the implementation of these changes across the various vendor tools and configurations. It can be used to determine that modifications are applied consistently and effectively across different security systems and technologies, minimizing any potential gaps or inconsistencies that could compromise the overall security posture. Furthermore, the SPO system 139 can be configured to automate and streamline the process of implementing security program changes, reducing the manual effort and potential errors associated with manual intervention. It can leverage automation capabilities to efficiently propagate the changes to the appropriate security tools, configurations, and policies such that the entity security program remains up-to-date and aligned with the evolving threat landscape.

Referring to the interplay of the analysis circuit 136 generally, the SSDC system 137 designs and composes the security stack. It guides users through the process of identifying data, determining its storage locations, and understanding the vendor products, services, and procedural capabilities to protect against, detect, and respond to cyber-attacks. By visualizing the existing gaps and vulnerabilities, the SSDC system 137 helps organizations prioritize their security efforts and make informed decisions to strengthen their security posture. The IRC system 138 focuses on collaboration and information sharing during incident response. It collects, aggregates, and generates data to be presented via applications 112 and 152. This system facilitates the efficient and effective communication among internal incident team members, cyber insurers, breach counsel, incident response firms, and security vendors. By pre-associating relevant parties and establishing clear lines of communication, the IRC system 138 reduces the time it takes to activate and triage live incidents in the future, leading to improved incident response capabilities. The SPO system 139, on the other hand, plays a role in managing the entity security program. It receives inputs indicating changes in the security posture or emerging cyber threats, whether through technical indicators or human-assisted inputs. Leveraging these inputs, the SPO system 139 determines the adjustments in the security program and orchestrates the implementation of those changes across the various vendor tools and configurations associated with the organization or entity such that that the security program remains up-to-date and aligned with the evolving threat landscape, improving overall security resilience.

Accordingly, together, these three systems create a powerful synergy within the entity security ecosystem. The SSDC system 137 helps design a robust security infrastructure, the IRC system 138 facilitates efficient collaboration and information sharing during incident response, and the SPO system 139 can be used to determine the agility and adaptability of the entity security program. By working in tandem, these systems contribute to a proactive and comprehensive approach to improve security, empowering organizations to mitigate risks, respond effectively to incidents, and continuously improve their security posture in a rapidly evolving threat landscape.

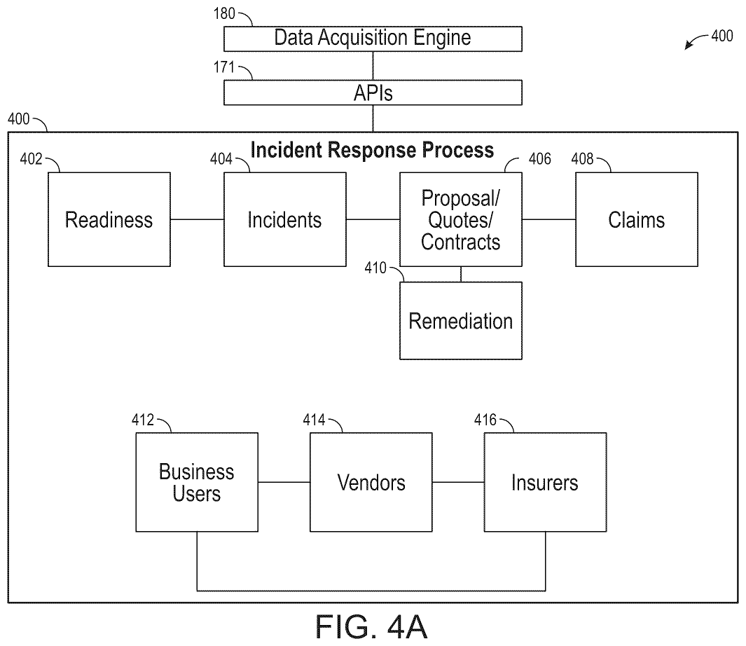

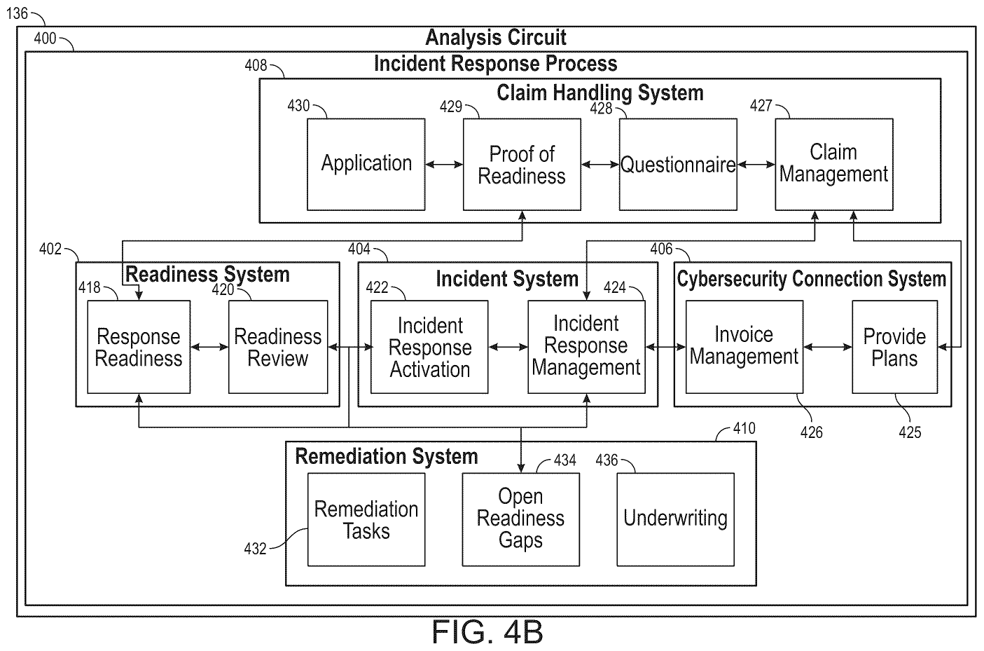

Referring now to FIGS. 4A-4B, a method 400 for incident response preparedness and readiness through the final incident closure and claim submission. Response system 130 (e.g., analysis circuit 136) or third party computing system 150 can be configured to perform method 400. Further, any computing device or system described herein can be configured to perform method 400. Additionally, one or more of the functions and features described in method 400 can be performed on an application. The data acquisition engine 180 can communicate using APIs with the response system 130.

In broad overview of the incident response process (e.g., method 400), the analysis circuit 136 can implement method 400. The analysis circuit can include various computing systems such as readiness system 402, incident system 404, cybersecurity connection system 406, claim handling system 408, and remediation system 410 can include systems configured to implement steps within an incident response process. In particular, FIG. 4B shows examples of activities or tasks performed in at least one (e.g., each) of the steps shown in FIG. 4A. Throughout the steps and activities data and data structures can be utilized (e.g., aggregate, collected, or generated) including data of business users 412, vendors 414, and insurers 416. APIs 171 and API request and returns can be sent and received by the one or more processing circuits to perform method 400. Additionally, fewer, or different operations can be performed depending on the particular implementation. In some implementations, some or all operations of method 400 can be performed by one or more processors executing on one or more computing devices, systems, or servers. In various implementations, at least one (e.g., each) operation can be re-ordered, added, removed, or repeated.

Referring to method 400 in more detail, the analysis circuit 136 can execute a readiness step by readiness system 402, where a readiness analysis is executed. In some implementations, during the readiness step by readiness system 402, the analysis circuit 136 can perform response readiness 418 and readiness review 420. During the response readiness 418, the analysis circuit 136 evaluates the level of preparedness of the entity or organization to effectively respond to incidents. It assesses various factors such as the availability of incident response teams, the adequacy of incident response plans and procedures, the integration of incident response tools and technologies, and the establishment of communication channels and protocols. This evaluation helps identify any gaps or deficiencies in the entity response capabilities and can be used to determine appropriate measures to be taken to address them.

Simultaneously (or in a logical order), the readiness review 420 conducted by the analysis circuit 136 includes a thorough examination of the overall readiness of the entity or organization for incident response. It encompasses a comprehensive review of the entity incident response framework, including its policies, procedures, documentation, and training programs. The analysis circuit 136 examines whether the incident response framework aligns with industry best practices, regulatory requirements, and internal objectives. It also assesses the ability of the entity to effectively coordinate and collaborate with external stakeholders, such as incident response providers, cyber insurers, breach counsel, and other relevant parties.

In some implementations, the readiness system 402 is configured to access the entity data of an organization and utilize this information to determine the entity security posture. The readiness system 402 can take into account various parameters such as the cybersecurity policies, system configurations, incident response readiness, and others parameters of an entity. It can then model the security posture along with a plurality of security objectives of the organization to generate a set of cybersecurity attributes.

The analysis circuit 136 can also execute an incident step by incident system 404, where an incident analysis is executed. In some implementations, during the incident step by incident system 404, the analysis circuit 136 can perform incident response activation 422 and incident response management 424. During the incident response activation 422, the analysis circuit 136 triggers the actions to initiate the incident response process. It activates the predefined incident response plans, procedures, and resources to provide a swift and coordinated response. This includes notifying the incident response team, engaging relevant stakeholders and vendors, and initiating communication channels to exchange information.

In some implementations, the incident system is configured to maintain the relationship between the entity and third-party cybersecurity providers. That is, it is configured to model a plurality of cybersecurity protection plans between the entity and a third-party. In particular, it provides a framework for integrating third-party cybersecurity solutions into the entity systems such that that these solutions align with the entity security objectives and can effectively address its cybersecurity goals.

Simultaneously (or in a logical order), the analysis circuit 136 executes incident response management 424, which includes the ongoing coordination, monitoring, and control of the incident response activities. For example, it can be used to determine that the incident response team follows the established procedures, communicates effectively, and collaborates seamlessly to address the incident. The analysis circuit 136 provides real-time insights and updates on the incident status, facilitates information sharing between team members, and tracks the progress of incident containment, eradication, and recovery efforts. By effectively managing the incident response, the analysis circuit 136 helps reduce the impact of the incident and accelerates the return to normal operations. By performing the incident response activation 422, it initiates a rapid and coordinated response, while the incident response management 424 can be used to determine effective coordination and control throughout the incident response process. This incident analysis and response approach facilitated by the analysis circuit 136 allows organizations to mitigate the impact of incidents, reduce downtime, and protect their assets and operations.

The analysis circuit 136 can also execute a proposal/quote/contract step by cybersecurity connection system 406, where a proposal/quote/contract generation is executed. In some implementations, during the proposal/quote/contract step by cybersecurity connection system 406, the analysis circuit 136 can perform invoice management 426. During the proposal/quote/contract step by cybersecurity connection system 406, the analysis circuit 136 leverages its capabilities to generate comprehensive and accurate proposals, quotes, and contracts. It takes into account the specific requirements, parameters, and preferences of the included parties such that the proposed terms align with their respective goals. The analysis circuit 136 utilizes relevant data, such as pricing information, service level agreements (SLAs), and contractual obligations, to generate customized proposals and quotes. In some implementations, within the proposal/quote/contract step by cybersecurity connection system 406, the analysis circuit 136 incorporates invoice management 426 functionality. This feature facilitates the efficient handling and tracking of invoices related to the proposed services or products. The analysis circuit 136 can be used to determine that accurate and timely invoices are generated, shared, and managed throughout the invoicing process. It can include features such as invoice creation, validation, tracking, and payment processing, streamlining the financial aspect of the proposal/quote/contract lifecycle.

In some implementations, the cybersecurity connection system 406 can be configured to determine and provide (e.g., connect) a cybersecurity protection plan, utilizing one or more protection parameters. The plans can correspond to a new cybersecurity attribute that has been identified to protect the organization. The cybersecurity connection system 406 makes this protection plan available to the entity, which can then choose to activate it based on its specific goals and acceptance of the plan terms.

The analysis circuit 136 can also execute a claims step by claim handling system 408, where claims are generated and tracked. In some implementations, during the claims step by claim handling system 408, the analysis circuit 136 can perform proof of readiness 429, provide an application 430 (e.g., application 112 and 152), generate and provide questionaries 428, and perform claim management 427. In some implementations, proof of readiness 429 includes gathering and presenting evidence to substantiate the readiness of the organization in handling incidents and responding effectively. The analysis circuit 136 collects relevant data, such as incident response plans, documentation, training records, and compliance certifications, to demonstrate the entity preparedness. Additionally, the analysis circuit 136 provides an application 430, such as application 112 and 152, to facilitate the claims process. This application serves as a centralized platform where users can access and submit their claims. It streamlines the claims workflow by facilitating efficient communication, documentation, and tracking of the claims from initiation to resolution.

In some implementations, the claim handling system 408 is configured to monitor the environmental data of the entity while modeling at least one of the plurality of cybersecurity protection plans. That is, the claim handling system 408 monitors for any anomalies or signs of potential cybersecurity incidents in the entity environment. When it detects a new cybersecurity incident associated with the entity from the environmental data, it generates a report such that the entity or vendor can use the report to promptly respond to the incident and prevent further damage.

In some implementations, as part of the claims step by claim handling system 408, the analysis circuit 136 also generates and provides questionnaires 428. These questionnaires are designed to gather specific information related to the incident or the claim being submitted. They serve as a structured means to collect relevant details and documentation for claim evaluation and processing. Moreover, the analysis circuit 136 encompasses claim management 427 functionalities during the claims step by claim handling system 408. This includes activities such as claim validation, documentation management, claim status tracking, and communication with included parties. The analysis circuit 136 can be used to determine that claims are effectively managed, providing transparency and visibility into the progress and status of at least one (e.g., each) claim.

The analysis circuit 136 can also execute a remediation step by remediation system 410, where remediations are executed. In some implementations, during the remediation step by remediation system 410, the analysis circuit 136 can perform remediation tasks 432, open readiness issues and gaps 434, and execute underwriting 436 (e.g., of organizations to determine what type of vendor plans, products, or services they can qualify for). The execution of remediation tasks 432 includes implementing specific actions or measures to mitigate vulnerabilities, resolve security gaps, and address any identified weaknesses in the entity security infrastructure. The analysis circuit 136 can provide guidance and instructions to stakeholders, outlining steps to remediate the identified issues effectively.

In some implementations, the remediation system 410 is configured to execute one or more remediation actions to mitigate a vulnerability or security gap. It bases its actions on the security posture of the entity. If a vulnerability is detected or a security gap is identified, the remediation system 410 executes to address the issue, employing a range of remediation actions such as patching software, modifying system configurations, or enhancing security policies.

Additionally, the analysis circuit 136 facilitates the process of opening readiness issues and gaps 434. It identifies areas where the organization can have shortcomings or deficiencies in its preparedness for potential incidents or security threats. By highlighting these gaps, the analysis circuit 136 helps organizations prioritize and allocate resources to address the identified issues and enhance their overall readiness posture. Moreover, the analysis circuit 136 can execute underwriting 436, which includes evaluating organizations to determine the type of vendor plans, products, or services they can qualify for. Through a comprehensive assessment, the analysis circuit 136 analyzes various factors, such as the entity security measures, incident response capabilities, risk management practices, and compliance with industry standards. Based on the evaluation, the analysis circuit 136 provides insights and recommendations on suitable vendor offerings that align with the entity specific requirements and level of readiness.

In some implementations, the readiness system 402 is configured to continuously update the security posture of the entity. It does this by monitoring dynamic changes in the entity data, which can include alterations in system configurations, updates to security policies, new cyber threats, and shifts in the cyber risk landscape. This continuous updating of the security posture can be used to determine that the entity security status continuously reflects the current conditions. It allows the analysis circuit 136 to react to emerging threats or vulnerabilities, providing real-time protection for the entity data and systems.

In some implementations, the readiness system 402 can also be configured to tokenize and broadcast the security posture to a distributed ledger. This process includes converting the security posture into a format suitable for recording on a blockchain (e.g., a type of distributed ledger). It then broadcasts this tokenized data across the network of computers that maintain the ledger. Additionally, the readiness system 402 provides a public address of the tokenized updated security posture on the distributed ledger. This public address can be accessed by a plurality of third-parties for verification. This transparent and immutable record-keeping enhances trust among stakeholders and provides a verifiable proof of the entity security posture.

In some implementations, the readiness system 402 is further configured to generate a security roadmap. This roadmap includes a plurality of phases associated with the modeling of the set of cybersecurity attributes. At least one (e.g., each) cybersecurity attribute of the set is assigned a phase associated with the security roadmap of the entity. For example, the roadmap serves as a strategic plan that outlines the steps the entity is to take to enhance its security posture. It provides a clear pathway to achieving the entity security objectives by validating that efforts are well-coordinated, and resources are efficiently utilized. By assigning at least one (e.g., each) cybersecurity attribute to a phase of the roadmap, the readiness system 402 can be used to determine that at least one (e.g., each) aspect of the entity security is appropriately addressed.

In some implementations, the cybersecurity connection system 406 can create and set in motion a cybersecurity protection obligation, in provide plans 425, between the entity and the third-party upon receiving an activation of the cybersecurity protection plan. The cybersecurity protection obligation can be a binding agreement or contract that outlines the responsibilities and roles of the entity and the third-party in securing the entity systems and data. This protection obligation is characterized by several protection attributes, which can include various elements such as the scope of protection, the duration of the contract, the specific cybersecurity services to be provided, the response time in the event of a security incident, and the terms of service termination or renewal. Moreover, the cybersecurity connection system 406 can identify multiple cybersecurity protection plans (e.g., at provide plans 425) associated with various third-parties. These could include a wide array of cybersecurity service providers, at least one (e.g., each) offering distinct protection plans. For example, a first cybersecurity protection plan could be offered by a first third-party, while a second cybersecurity protection plan could be offered by a different third-party. At least one (e.g., each) of these protection plans can be associated with the new cybersecurity attribute identified during the modeling process, indicating that they are specifically designed to address this aspect of the entity cybersecurity goals.

In some implementations, at least one (e.g., each) cybersecurity protection plan, in turn, is associated with one of several availability states. These states provide an immediate understanding of plan status regarding its accessibility for the entity. The “available now” state means that the plan is currently accessible for implementation. The “available pending” state signifies that the plan will become accessible in the future (e.g., subject to conditions or the passing of a period). Conversely, an “unavailable” state denotes that the plan is not currently accessible, possibly due to it being phased out, fully subscribed, or not being offered in the entity region. Additional or fewer states can be added. This system of availability states allows the entity to quickly determine which plans are viable options for enhancing their cybersecurity posture.

In some implementations, the incident system 404 can establish a data (e.g., continuous, in real-time, periodically) monitoring channel between the entity and the third-party. This communication stream allows for real-time (or near real-time) detection and response to any potential cybersecurity incidents. To achieve this, a first communication connection is established using a first application programming interface (API) between the entity computing system (e.g., 110) or one or more entity assets (e.g., 110) and the incident system 404. This connection allows the incident system 404 to continuously monitor the entity systems and data for any signs of a cybersecurity incident. Simultaneously, a second communication connection is established using a second API between a third party computing system (e.g., 150) and the incident system 404. This connection facilitates the third-party, often a cybersecurity service provider, to also monitor the entity systems and data, providing an additional layer of protection and vigilance.

Moreover, the claim handling system 408 can be configured to quickly respond to any detected cybersecurity incidents. Upon detection of a new cybersecurity incident, the claim handling system 408 generates alerts and provides a real-time dashboard for the entity and vendor. This dashboard provides an overview of the entity cybersecurity posture, details of the detected incident, recommended response actions, and updates on the response process. This real-time information allows the entity to rapidly understand and react to the cybersecurity incident, minimizing potential damage and downtime.

In some implementations, the remediation system 410 can use predictive analytics to identify potential security gaps before they can be exploited. It analyses patterns in the entity data and behaviors, as well as trends and threats in the broader cybersecurity landscape, to predict where vulnerabilities can arise. Upon identifying a potential security gap, the remediation system 410 proactively executes one or more remediation actions. These actions could include updating security policies, patching software vulnerabilities, reconfiguring system settings, providing cybersecurity training to employees, or implementing additional cybersecurity measures.

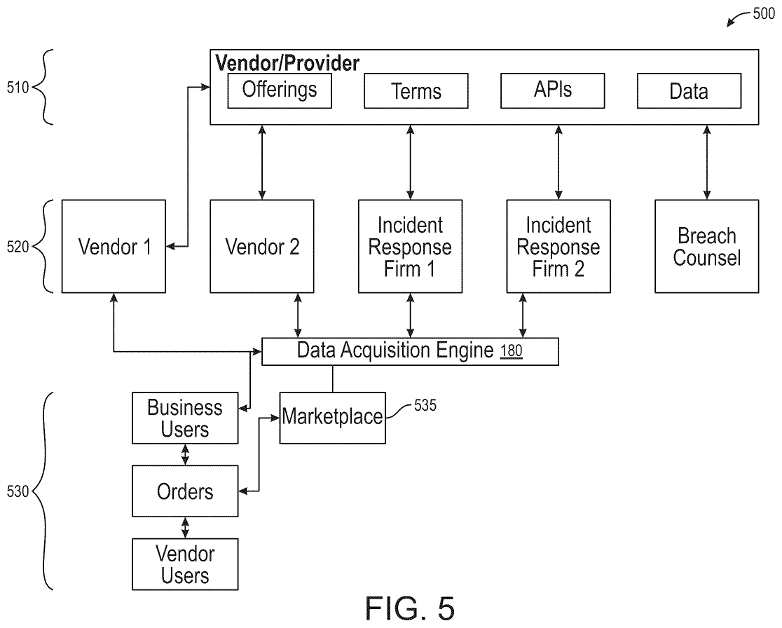

Referring now to FIG. 5, a vendor-provider marketplace 500, according to some implementations. The vendor-provider marketplace 500 depicts generally the interactions between vendors 510 and users 530 (e.g., directly or through partners) as well as vendors 510 to partners 520. For example, at least one (e.g., each) vendor 510 can include, but is not limited to, offerings, terms, APIs, and data that can be provided and/or exchanged with to the response system 130 via the data acquisition engine 180 and other vendors, incident response firms, and breach counsel (e.g., law firm) (collectively referred to as “partners 520”). In some implementations, those partners 520 can communicate with the data acquisition engine 180 of FIG. 1A to generate dashboards of an application (e.g., 112, 152) and store data in database 140 for future use.

Expanding on the vendor-provider marketplace 500 depicted in FIG. 5, this marketplace serves as a central hub for interactions between vendors 510, users 530, and partners 520, facilitating the exchange of offerings, terms, APIs, and data. At least one (e.g., each) vendor 510 within the marketplace encompasses a range of products, services, and resources that can be made available to users 530 directly or through the engagement of partners 520. These partners 520, which include incident response firms, breach counsel (such as law firms), and other relevant entities, play a role in providing expertise and additional support to enhance incident response capabilities (e.g., a type of cybersecurity attribute). Through seamless communication with the data acquisition engine 180, the partners 520 can actively engage in generating comprehensive dashboards within the application interfaces (e.g., 112, 152). These dashboards offer real-time insights and analytics such that users 530 can visualize and assess their incident response readiness, track ongoing incidents, and access relevant data stored in the database 140 for future reference. The data acquisition engine 180 serves as a communication bridge, allowing partners 520 to contribute information and leverage the functionalities of the response system 130. It can be understood that the vendors 510, partners 520, and users 530 depicted in the vendor-provider marketplace 500 can be executed by computer systems, exemplified by the computing system 200 shown in FIG. 2. These computer systems facilitate seamless collaboration, data exchange, and transactional activities within the marketplace to provide a dynamic and efficient ecosystem for incident response management.

In some implementations, the vendor-user interaction within the marketplace 535 extends beyond mere browsing and exploration. Vendors 510 and users 530 have the capability to place orders directly through the marketplace 535, initiating a streamlined process facilitated by the data acquisition engine. This integration of ordering functionality enhances the efficiency and convenience of the marketplace, providing seamless transactions between vendors and users. Notably, the marketplace 535 serves as a platform for programmatic connectivity and identifies new partners to establish collaborative relationships efficiently. The marketplace incorporates contracting workflows and partnering processes, which are seamlessly facilitated through the application interface. Once a partnership is ratified, the partners can immediately engage in business activities within the platform, leveraging the full range of services and offerings available. This includes the ability to submit proposals, engage in reselling, establish technical connectivity for provisioning and licensing, establish API connections for data sharing, utilization, and presentation on the platform, and leverage pre-defined programmable logic for user, vendor, and partner interactions.

In some implementations, the marketplace 535 introduces dynamic and automated workflows that facilitate efficient routing of inbound orders to the appropriate partner based on predefined criteria. This programmable logic facilitates that orders are seamlessly directed to the designated partner for processing and fulfillment. Furthermore, programmatic activation of contracts and seamless order fulfillment processes are executed, facilitating a smooth and rapid delivery of the purchased offering, whether it is a product or service. The marketplace ecosystem facilitates the seamless integration of vendors, partners, and users, streamlining the order management process and facilitating timely and efficient delivery of products and services.

Distinguishing itself from other vendor marketplaces, this embedded marketplace 535 is seamlessly integrated within the applications and APIs (171) spanning the system architecture. This integration facilitates vendor offerings to be presented to users dynamically, seamlessly integrating within the user flow during various stages of cybersecurity incident response planning, testing, and execution. Moreover, the marketplace becomes a part of the design and composition processes for constructing a robust cybersecurity stack, as well as during security program orchestration and adaptation to determine the ongoing effectiveness of the cybersecurity program. By embedding the marketplace within the applications and APIs, users 530 have immediate access to a comprehensive array of vendor offerings precisely at the point of vulnerability. Whether users are developing their incident response plans, conducting tests, executing response strategies, or adapting their security programs, the marketplace seamlessly integrates within their workflow, providing timely and relevant vendor options to enhance their cybersecurity capabilities (e.g., cybersecurity attributes). This approach eliminates users navigating separate platforms or search for vendors independently, streamlining the process and promoting efficiency in decision-making and procurement.

Additionally, this embedded marketplace fosters a holistic approach to cybersecurity management, facilitating collaboration between users 530 and vendors 510 throughout the ecosystem. By offering vendor options during incident response planning, testing, and execution, users can make informed decisions and select the suitable solutions to mitigate risks effectively. Similarly, during the design and composition of their cybersecurity stack, users 530 can access a diverse range of vendor offerings directly within the application interface and use the offerings to build a comprehensive and tailored security infrastructure. Additionally, during security program orchestration and adaptation, the marketplace 535 provides users with insights and options to enhance the effectiveness and resilience of their security programs by providing continuous protection against evolving threats.

It can be understood that the embedded marketplace architecture allows for flexibility and scalability, accommodating additional systems, devices, data structures, and data sources. The marketplace can adapt to the evolving goals of users and vendors, expanding its offerings and functionalities to meet the dynamic nature of the cybersecurity landscape. This adaptability can be used to determine that the marketplace remains a resource for users, providing access to the updated innovations and vendor solutions while facilitating seamless collaboration and partnership within the cybersecurity ecosystem.

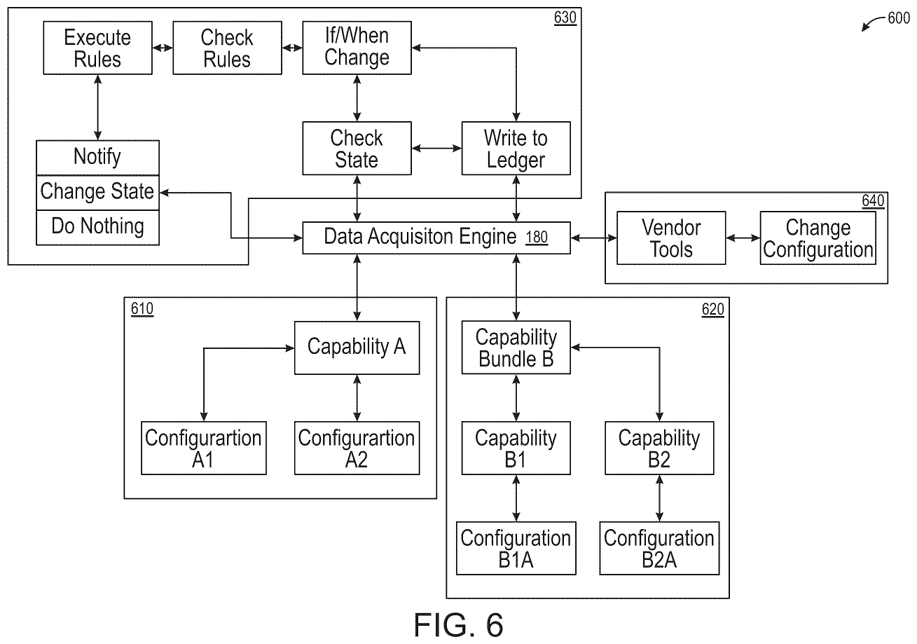

Referring now to FIG. 6, a method 600 for capturing the state of capabilities (sometimes referred to herein as “cybersecurity attributes”) (e.g., vendor technologies or configurations) in place and in use by users, retrieving state, and sharing of state at points in time as well as over a time period. Response system 130 (e.g., analysis circuit 136 or data acquisition engine 180) or third party computing system 150 can be configured to perform method 600. Further, any computing device or system described herein can be configured to perform method 600. Additionally, one or more of the functions and features described in method 600 can be performed on an application.

In broad overview of method 600, capabilities 610 and 620 associated with a corporation of business can be received (e.g., capability A with configuration A1 and configuration A2, and capability bundle B with capability B1 and B2, where capability B1 has a configuration B1A and capability B2 has a configuration B2A). The capabilities 610 and 620 can be checked (e.g., check state) and the capabilities can be written to a ledger (e.g., database and/or blockchain 170) in steps 630. Once the capabilities 610 and 620 are received, a thorough check is conducted to verify their state and determine their accuracy and validity. This check entails examining the current status and parameters of at least one (e.g., each) capability, evaluating factors such as readiness, compatibility, and compliance with established standards or requirements. By performing this comprehensive assessment, any discrepancies or issues pertaining to the capabilities can be identified and addressed.

In some implementations, following the verification process, the next step includes recording the capabilities into a ledger. This ledger serves as a secure and reliable storage medium, which can take the form of a database or a blockchain 170. The capabilities, along with their associated configurations, are meticulously documented and stored within the ledger to maintain the integrity and traceability of the information. This facilitates easy access to the capability details, their respective configurations, and any historical changes or updates that can occur over time. By writing the capabilities to the ledger, organizations gain a centralized and auditable repository that securely maintains a record of their capabilities. Additionally, the ledger facilitates transparency and accountability by providing an immutable and tamper-proof audit trail of the capabilities and their configurations.

In turn in steps 630, a process can occur if a state has changed including, but not limited to, checking rules, execute rules, and notifying, changing state, and/or performing no actions. If a change occurred (e.g., trigger condition, e.g., capability A changed, the data acquisition engine 180 can determine to change it back (or role it back), capability B changed and in turn then vendor technology is configured to change Y associated with the business or corporation) then the one more processing circuits can programmatically connect to vendor technology to change a configuration (e.g., utilizing API calls). In some implementations, at steps 640, the data acquisition engine 180 can communicate with vendor tools to change particular configurations.

Upon detecting a change in state, the data acquisition engine 180 evaluates the trigger condition, such as the alteration of capability A or capability B. Based on this evaluation, a decision is made regarding the appropriate course of action. For example, if capability A experiences a change, the data acquisition engine 180 can determine that a rollback is to be performed to revert the capability back to its previous state. Similarly, if capability B undergoes a change, the vendor technology associated with the business or corporation can be configured to adjust Y accordingly, aligning it with the modified capability. To effectuate these changes, the processing circuits within the data acquisition engine 180 (or within response system 130) establish programmatic connections with the vendor technology responsible for managing the configurations (e.g., at step 640). Moving forward to step 640, the data acquisition engine 180 actively engages in communication with the vendor tools to implement the desired changes. Through this interaction, the data acquisition engine 180 can efficiently orchestrate the configuration changes to align the capabilities with the desired state.

With reference to FIG. 6, the one or more processing circuits can utilize the various data structures (e.g., assets, locations, capabilities, threats) to collect, attribute, and adapt to determine if a trigger condition occurred (e.g., historical data of the corporation or business can be used to determine if a trigger condition occurred) In turn, the one or more processing circuits can execute one or more functions such as make an API request (e.g., to vendor, insurer, or business), store information in a database, and/or update a blockchain ledger (e.g., at step 630). Additionally, fewer, or different operations can be performed depending on the particular implementation. In some implementations, one or more operations of method 600 can be performed by one or more processors executing on one or more computing devices, systems, or servers.

In some implementations, in order to identify the occurrence of a trigger condition, historical data of the corporation or business is often utilized. This historical data provides insights into the past behavior and patterns of the organization, allowing the processing circuits to make informed decisions regarding trigger condition identification. Upon determining that a trigger condition has indeed occurred, the one or more processing circuits initiate a series of functions and operations to address the situation. These functions can include making API requests to relevant entities such as vendors, insurers, or other businesses. Through these API requests, the processing circuits can retrieve information or initiate specific actions to respond to the trigger condition effectively. Additionally, in some implementations, the processing circuits can update a blockchain ledger, providing a secure and immutable record of the trigger condition and any associated changes made as a result.

In various implementations, at least one (e.g., each) operation can be re-ordered, added, removed, or repeated. This system will be used to deliver state of a business security configuration to facilitate insurance underwriting, whereby the facts of the state of the business user computing environment are known, and provable. This provides the underwriting insurer the ability to collect irrefutable proof-of-state of the business environment as part of their pre-underwriting and risk selection process and can be then used for programmatic binding as part of their application process. The system can be further utilized to provide programmatically and dynamically adaptable insurance products that change the coverage level based on the factual changes in state of the computing environment at the insured through the policy period. This allows the insurer to determine that the insured has followed the underwriting criteria throughout the term of the policy. Cyber insurance renewals can be programmatically generated and automatically bound based on the binary data provided by the system during renewal as the insurer knows what the compliance history has been for the insured as well as the facts of the current state of the vendor capabilities and configurations in the insureds computing environment.

In various implementations, the underwriting process begins by collecting data from security tools and configurations of the insured. This data can then be analyzed and matched against the specific underwriting requirements defined by the insurer. The collected data acts as irrefutable proof of the security posture of the insured, providing the insurer with a holistic understanding of the risk associated with the business environment of the insured. In some implementations, once the data has been collected and matched to underwriting requirements, the processing circuits can wrap this information with context and metadata through a broker. The broker acts as an intermediary, consolidating and structuring the data in a standardized format that can be seamlessly transmitted to the quoting API of the insurer. This integration improves the underwriting application process by allowing the insurer to access the factual data of the insured security configurations and/or computing environment. With this data, the insurer can programmatically assess the risk and make informed decisions regarding coverage and policy terms. This automated and dynamic approach empowers insurers to offer adaptable insurance products that can be adjusted based on the factual changes in the insured computing environment throughout the policy period, facilitating ongoing compliance with underwriting criteria and tailored coverage for the insured. Additionally, the system facilitates the automatic generation and binding of cyber insurance renewals based on the binary data provided during the renewal process. By utilizing the compliance history and the up-to-date facts of the insured computing environment, the insurer can renew the policy while maintaining a comprehensive understanding of the insured risk profile and providing continuous coverage.

### Systems and Methods for Protection Modeling

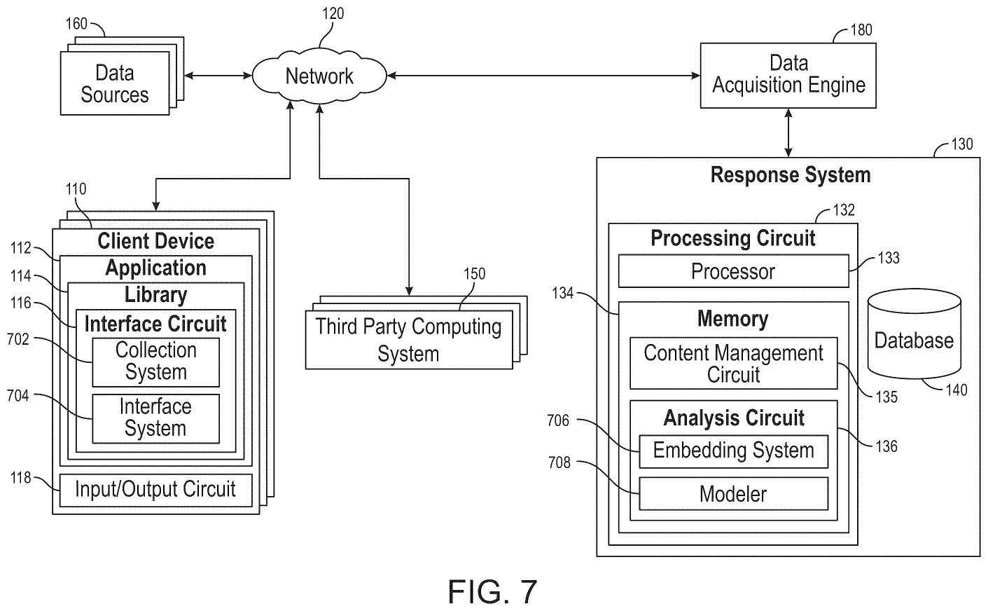

Referring to FIG. 7, a block diagram of an implementation of a security architecture for modeling a plurality of protection parameters or application of a third-party. The implementation shown in FIG. 7 includes a client device 110, response system 130, third party computing system 150, data sources 160, and data acquisition engine 180. These components can be interconnected through a network 120 that supports secure communications profiles (e.g., TLS, SSL, HTTPS, etc.). In some arrangements, the elements shown in FIG. 7 can incorporate similar features and functionality as described regarding the elements shown FIG. 1A. For example, the response system 130, as shown in FIG. 7, incorporates similar functionality as described regarding the response system 130 of FIG. 1A; the database 140, as shown in FIG. 7, can incorporate the same or similar functionality as described regarding the database 140 of FIG. 1A; etc. Specifically, like callout references of FIG. 1A are now further described, however the features and functionalities of components like the response system 130 in FIG. 7 still correspond to those referred to with the same callout reference in FIG. 1A. For example, response system 130 is described in FIG. 7 to include additional functionality and features related to the security architecture for modeling a plurality of protection parameters or application (e.g., protection application) of a third-party.

In some arrangements, the client device 110 can include an application 112 and an input/output circuit 118. The application 112 can include a library 114, and the library 114 can include an interface circuit 116. The interface circuit 116 can further include a collection system 702 and an interface system 704. In some arrangements, the response system 130 can include a processing circuit 132 and a database 140. The processing circuit 132 can include a processor 133 and memory 134. The memory 134 can further include a content management circuit 135 and an analysis circuit 136, and the analysis circuit 136 can include an embedding system 706 and a modeler 708, as further described herein.

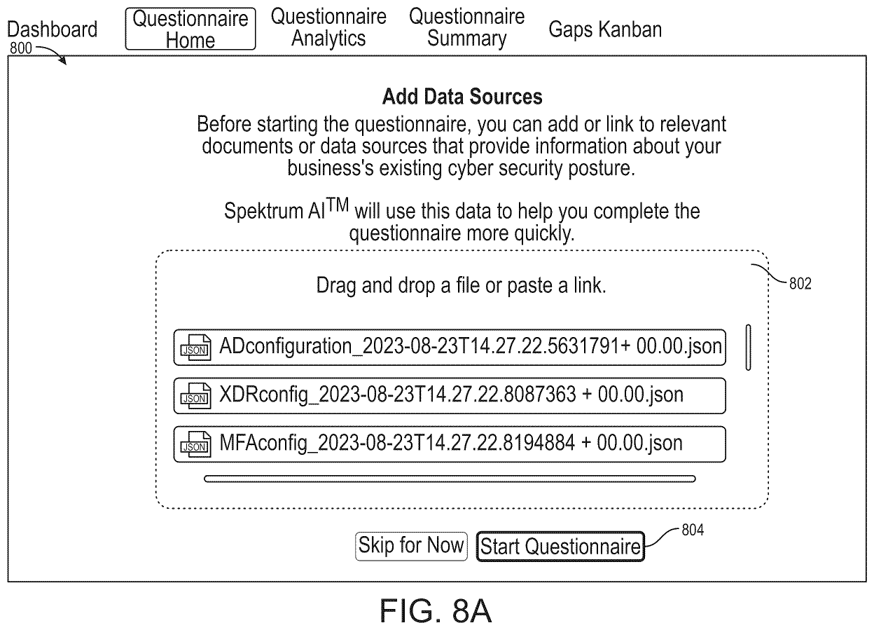

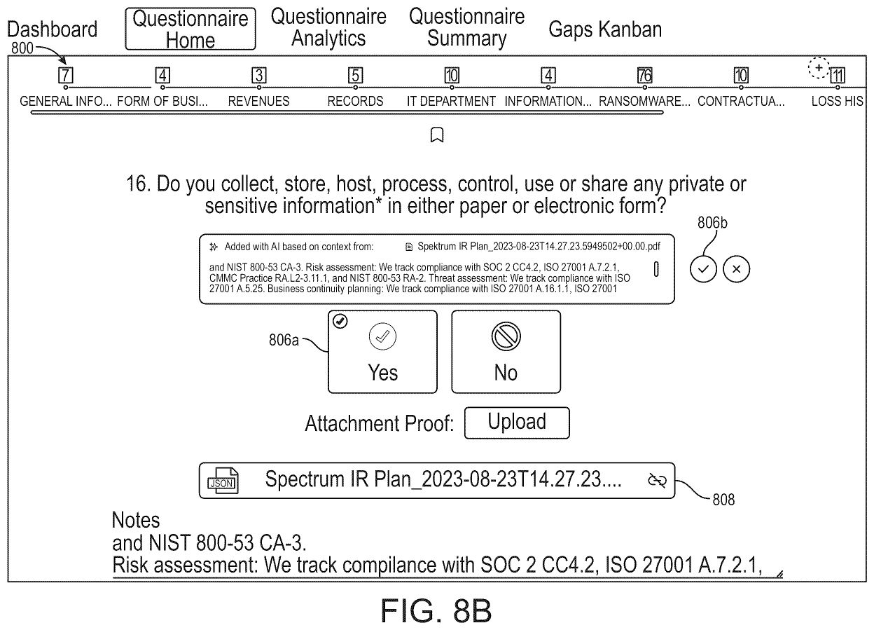

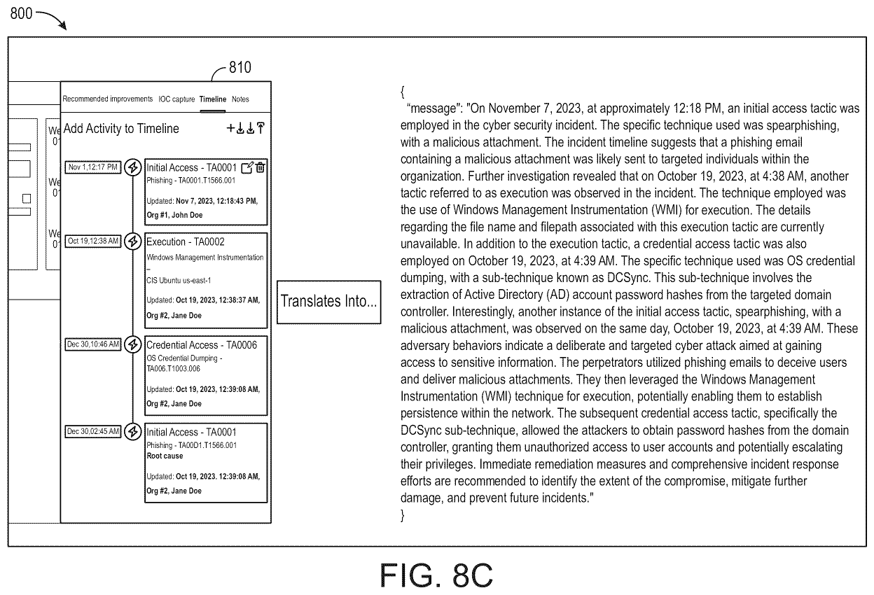

In some arrangements, the application 112 can guide users or entities through completing a protection application (e.g., cybersecurity protection application, insurance application). The application 112 can be designed to integrate with technology and databases (e.g., database 140, response system 130, etc.) to access information used in modeling the protection application and/or guide users/entities through completing the application. The user can access the application 112 through a variety of devices, including client device 110. The application 112 is described in greater detail below and with reference to FIGS. 8A-8C.

In some arrangements, the client device 110 can collect, access, or receive resilience (e.g., cybersecurity) data (e.g., data corresponding to cyber resilience modeling such as security posture data, cyber security data, protection data, protection control schemas, historical protection data, etc.) of a third party (e.g., an entity, user, etc.) via the application 112. As used herein, the third party can be an insurer, reinsurer, or any other entity providing a protection product (e.g., cybersecurity insurance plan). Furthermore, the resilience data can include information corresponding to an entity cybersecurity resilience (e.g., readiness, preparedness, etc.), such as information regarding security tools implemented by the entity (e.g., encryption standards, employee awareness programs, simulated phishing attacks for training, etc.); past and/or current cybersecurity incidents (e.g., previous data breach) and corresponding entity responses (e.g., shutdown of entity servers), and/or various other information related to the entity, cybersecurity, or cyber incidents (e.g., entity size, protection plan information, etc.). For example, the collection system 702 can collect, access, or receive the resilience data (e.g., entity data, environmental data, other cybersecurity data, etc.) of the entity, such as from entity computing and network systems. Furthermore. Additionally, cybersecurity (or resilience) data can be accessed in data stored on data sources (e.g., database 140, third party computing system 150, data sources 160, etc.) or by communicating with the data acquisition engine 180 (e.g., via the network 120). In some arrangements, a user can access or be presented (e.g., to interact with) a protection application via the client device 110. For example, the interface system 704 can provide the protection application to the user for interaction (e.g., to provide data, to embed data into content fields, etc.). In some arrangements, the interface system 704 can include a graphical user interface (GUI), and a user (e.g., entity) can access the protection application through the GUI using client device 110.

In some arrangements, the data collected by the collection system 702 and/or via the interface system 704 can be analyzed (e.g., by the response system 130) to update data used in modeling the protection application (e.g., for modeling a plurality of protection parameters of application of a third-party). For example, the collection system 702 and/or interface system 704 can receive state data and index data of an entity. The state data can include a protection parameter (e.g., security parameter) of the entity (e.g., encryption standards, data collection policy, etc.), and the index data can include a reference (e.g., pointer, etc.) to one or more security parameters. In some arrangements, the protection parameters can include configuration data, incident data, and/or metadata of the entity. The response system 130 can further generate a security posture based on the state data and index data, and the security posture can be used in modeling a plurality of protection parameters of application of third party. For example, entity data can include a security posture of the entity, and the response system 130 can generate the protection posture based on security data (e.g., encryption standards, data sharing policies, location-use policies, etc.). Further, the security data can include the historical and current resilience of the entity (e.g., cybersecurity) implementations (e.g., encryption standards currently implemented, past data collection policies, etc.).

In some arrangements, in response to receiving state data and index data (e.g., by the collection system 702 and/or interface system 704) and determining a security posture (e.g., by the response system 130), the collection system 702 and/or the response system 130 can synchronize the state data and the index data. For example, in synchronizing the state data and the index data, the response system 130 can identify an update to the state data (e.g., modification, insertion, deletion, etc.) by comparing or cross-referencing the state data to previous state data based on the index data. In some arrangements, this synchronization process can also include the validation of the updated state data against compliance standards or security frameworks to determine that the modifications adhere to predefined security policies and regulations. In some arrangements, the response system 130 can further update the index data based on the update to the state data (e.g., revising the index data to point to an updated/current iteration or version of the state data). For example, if an entity upgrades its encryption protocol from an older standard to a more secure, modern standard, the collection system 702 might record this change in the state data as a modification. The response system 130 then compares this new state data against the historical data indexed by the index data. Upon recognizing the upgrade, the response system 130 can update the index data to reflect the more secure encryption standard.

In some arrangements, the response system 130 is operably connected to data acquisition engine 180 and includes analysis circuit 136 to democratize posture threats, incidents, and claim data (e.g., cyber security data, protection data, protection control schemas, historical protection data, etc.) for modeling a plurality of protection parameters or application of a third-party. The analysis circuit 136 can use the democratized data in underwriting, claims, the resilience process, and more (e.g., in embedding data in a protection application). Using the data acquisition engine 180, the response system 130 can collect and process data (e.g., unstructured data) from various sources, such as client device 110, third party computing system 150 and data sources 160 to provide a view of a security posture of an organization.

In some arrangements, the modeler 708 of the response system 130 can generate and embed an output (e.g., from a model) within a protection parameter (e.g., content field) of the protection application. For example, the modeler 708 can model a protection application (e.g., cybersecurity protection application), identify at least one protection parameter (e.g., content field, user input field, etc.) of the plurality of protection parameters or application and entity data of the entity, and generate an output mapped to and embedded in the protection parameter (e.g., content field) of the protection application. In some arrangements, the embedding system 706 and/or the modeler 708 can implement similar features and functionality as described with reference to the response system 130 of FIGS. 1A-1B.

As described herein, the terms “generative AI,” “gen AI,” “GAI,” etc., includes a spectrum of AI technologies specifically designed for creating new outputs. These include, but are not limited to, large language models (LLMs) used to generate textual content, and generative adversarial networks (GANs), which can be used to generate novel images, videos, and other forms of media. These AI systems are characterized by the models training to synthesize new content that often cannot be extrapolated from their training data, but rather, is derived from the patterns and structures they have learned during their training process. While distinct from other types of AI (e.g., non-generative AI such as retrieval-based models), the terms “generative AI” and the like, as used herein, can include AI systems incorporating both a generative-based model and a retrieval-based model. The terms “large language model,” “LLM,” and the like refer to a specific type of generative AI trained on language and content datasets and configured to process, analyze, and generate natural language (e.g., GPT series by OpenAI, BERT by Google, XLNet, etc.). The terms “generative pre-trained transformer.” “GPT,” etc., as used herein, refer to a series of LLMs that generate output text using a transformer architecture (e.g., neural network optimized for handling sequences of data such as language, etc.).

In some arrangements, the modeler 708 can implement and execute a generative artificial intelligence (GAI) model. For example, the modeler 708 can model the protection application by identifying at least one protection parameter (e.g., content field, such as a user input field on an electronic form) of the plurality of protection parameters or application and generating an output (e.g., for the protection parameter/content field) using a trained GAI model (e.g., using a large language model (LLM)) based on receiving, accessing, or identifying unstructured data of the entity (e.g., from drag-n-drop file uploads, to data dumps, to accessing various data streams of the entity). For example, the output provided by the response system 130 can be provided to an entity computing system (e.g., client device 110, third party computing system 150, etc.). In some arrangements, the modeler 708 can identify names or identifiers of protection parameters/content fields (e.g., “IT Infrastructure Description,” “Data Sharing Policy,” etc.) by parsing the protection application and extracting identifiers corresponding to the input fields (e.g., numeric, string, etc.). In some arrangements, the modeler 708 can generate, using the trained GAI model (e.g., LLM), an output corresponding to the identified input protection parameters (e.g., text-based description of a “Data Sharing Policy” of the entity, etc.). For example, the modeler 708 can generate a prompt to be inputted into the trained GAI model based on the identified protection parameter (e.g., content field) of the protection application, receive a response from the prompt (e.g., in response to prompting the GAI using the prompt), and provide the response for modeling by GAI model.

In some arrangements, the modeler 708 can implement a generative pre-trained transformer (GPT) model (e.g., trained on a training dataset including cyber security data, protection data, protection control schemas, historical protection data, etc.) and can prompt the GPT model based on identified information (e.g., protection parameters) of the protection application and/or entity data of an entity (e.g., security posture). In some arrangements, the modeler 708 can incorporate the GAI model to parse and/or extract unstructured input data (e.g., incident response plans in PDF or HTML format, cybersecurity configuration data stored in JSON format, etc.), and the modeler 708 can use the parsed/extracted input data in performing the functionality described above (e.g., in generating an output, prompting a GAI, adjusting the output, etc.).

In some arrangements, the GAI model incorporated by the modeler 708 can be a retrieval-augmented generation (RAG) model and can implement both retrieval-based and generative-based models. For example, as described above, the retrieval-based model can include a database management system (DBMS) and can search a database (e.g., containing predefined outputs) for known queries and corresponding responses. For example, the retrieval-based model, via the DBMS, can receive queries (e.g., in a structured query language (SQL), etc.), parse and interpret the queries, locate data corresponding to the queries (e.g., stored on database 140), and retrieve and output the data (e.g., as formatted or structured data displayed on a GUI, etc.). As described above, the generative-based model can be an LLM trained using a training dataset and configured to generate outputs in response to a prompt.

In some arrangements, the modeler 708 can use the GAI model to generate at least one output based on the at least one protection parameter of the plurality of protection parameters or application and entity data of the entity. For example, the GAI model can generate a structured format (e.g., tabular) of tactics, techniques, and procedures (TTPs) (e.g., ransomware, phishing, domain fronting, zero-day exploit, privilege escalation, etc.) and incident facts (e.g., cybersecurity incident facts related to a security breach, such as data accessed, time period of breach, methods used by attackers, etc.). In some arrangements, the structured format of TTPs and incident facts corresponds to human-readable instructions outputted by the GAI model (e.g., as shown and described regarding FIG. 8C). For example, the modeler 708 can determine, using the trained GAI model, one or more tactics, techniques, or procedures (e.g., phishing email) used by one or more attackers, update a security posture (e.g., cybersecurity metric) based on the identified TTPs, and update (e.g., adjust, append to, delete from, etc.) the output based on the updated security posture.

In some arrangements, the embedding system 706 can map the protection parameter (e.g., content) field to the output and embed the protection parameter with data including the output. The embedding system 706, in embedding the protection parameter with data, can execute a call using an application programming interface (API) or predetermined script with a third-party computing system (e.g., third party computing system 150). For example, the embedding system 706 can implement a script-based approach for embedding and can use a script (e.g., Python, etc.) to map and programmatically populate protection parameters (e.g., content fields) with data including the output generated by the GAI model. In another example, the embedding system 706 can implement an API-based approach for mapping and embedding and can use an application programming interface (API) (e.g., RESTful, Webhooks, GraphQL, gRPC, Oath 2.0, etc.) to populate protection parameters with the data including the output generated by the GAI model.

In some arrangements, mapping can include using mapping parameters of the GAI model (e.g., settings/rules used by the GAI model in processing input data and generating an output, settings/rules used by the embedding system 706 in embedding the output in the protection parameter, etc.). In some arrangements, the embedding system 706 and/or response system 130 can update mapping parameters of the GAI model based on (1) an input by the entity computing system corresponding to the plurality of protection parameters or application and (2) a complexity (e.g., defined by data length, detail included in the data, presence of nested data, etc.) and type (e.g., numerical, string-based, etc.) of the protection parameter (e.g., content field). For example, the embedding system 706 can adjust mapping parameters implemented by the GAI based on outputs previously generated by the GAI for a variety of purposes, including to format data into a predefined format (e.g., converting numerical data into string format), to verify the accuracy of a generated output before embedding the generated output in the protection parameter (e.g., content field), etc. Furthermore, the one or more field-specific data integrity protections used by the GAI model in embedding data can used to determine that the embedded data satisfies one or more predefined quality or accuracy standards of the plurality of protection parameters or application (e.g., formatting requirements, proof requirements, etc.).

In some arrangements, the mapping parameters can correspond to one or more field-specific data integrity protections (e.g., formatting requirements, validation rules, encryption standards, etc.) used by the GAI model in embedding the data in the content field of the protection application. For example, the field-specific data integrity protections used by the GAI model in embedding the data can satisfy one or more predefined quality or accuracy standards of the plurality of protection parameters or application (e.g., requiring dates to be in MM/DD/YYYY format, preventing the embedding system 706 from embedding data that contradicts previously embedded data, cross-validating cybersecurity incident data with data stored on an external data source, etc.), which can be further updated based on outputs generated by the GAI (e.g., by self-training, reinforcement learning, etc.).

Further, the GAI model (e.g., incorporated into response system 130, accessed via embedding system 706, incorporated into modeler 708, etc.) can cross-validate the data embedded into the at least one protection parameter (e.g., content field) against an external data source. For example, the embedding system 706 can verify the accuracy of a generated output (e.g., cybersecurity incident, encryption standard, data collection/sharing policy, etc.) by comparing the generated output to external verification data (e.g., data stored in database 140, data source 160, etc.) and determining that the generated output aligns with the external verification data (e.g., comparing the generated output to model outputs that are known to satisfy conditions or criteria of the protection application, verifying that corresponding entries contain matching information, etc.). For example, the embedding system 706 can incorporate pattern and anomaly detection algorithms to identify errors in generated outputs and/or adjust the generated outputs based on model data before embedding the outputs in protection parameters (e.g., content fields) of the protection application.

In some arrangements, one or more elements of FIG. 7 can be communicably coupled (connected) to a distributed ledger (e.g., blockchain 170 of FIG. 1B) or other authoritative data source to provide data integrity and security. For example, as described above regarding FIG. 1A, the database 140 can be a private ledger and data source 160 can be a public ledger, and data transactions (e.g., updates to protection applications, cybersecurity parameters, state/index data, entity data, etc.) recorded on the database 140 can be validated against entries recorded on the data source 160 to validate that updates to entries are accurately reflected and can be audited against an immutable record (e.g., results can be traceable and linkable).

In some arrangements, modeling the protection application of the entity can include generating a metadata token based on tokenizing the plurality of protection parameters or application. For example, the response system 130 (e.g., using modeler 708) can generate a digital token (e.g., for use on a blockchain) by appending cybersecurity data (e.g., protection parameters) to the token as metadata for subsequent use/identification of the token. In some arrangements, the metadata token can be generated (e.g., by response system 130) based on tokenizing the plurality of protection parameters or application inclusive of the at least one output and the plurality of unstructured data. In some arrangements, response system 130 can further broadcast or store the metadata token to a distributed ledger or data source (e.g., by providing a public address of the tokenized protection application on the distributed ledger to third parties for verification). For example, the modeler 708 can create a digital token representing the protection plan (e.g., by generating a cryptographic token that encapsulates aspects of the protection plan, such as terms, conditions, activation triggers, etc.) stored on a distributed ledger (e.g., data source 160) and communicate data related to the digital token to the application 112 for display to the user, entity, or third party (e.g., to verify data integrity, to show modifications to data, etc.).

In some arrangements, the response system 130 can further link the metadata token to a security posture of the entity to the plurality of protection parameters or application. For example, the modeler 708 can link data corresponding with entity security posture (e.g., data indicating an entity desire for cybersecurity protection stored on a database, such as database 140) to the metadata token such that accessing the metadata token provides the information corresponding with the security posture (e.g., provides data indicating entity desire for cybersecurity coverage). In some arrangements, the response system 130 can further provide a public address of the metadata token on the distributed ledge or data source to a plurality of third parties for verification. For example, the response system 130 can store the metadata token using a distributed computing architecture as described above (e.g., with database 140 being a private ledger and data source 160 being a public ledger), and an insurer or other entity providing a protection product can access the metadata token via the public/private ledgers to verify the veracity of information contained in the metadata token (e.g., to verify cybersecurity posture information).

In some arrangements, modeling the protection application can include generating one or more smart contracts based on embedding the generated outputs with smart contract templates. For example, the embedding system 706 and/or modeler 708 can programmatically insert data (e.g., entity data) into corresponding fields (e.g., protection parameters) related to various security parameters (e.g., specific cybersecurity measures, compliance checkpoints, incident response triggers, etc.) within a predefined smart contract structure, and the completed smart contract can be deployed to a blockchain platform (e.g., Ethereum).

In some arrangements, modeling the protection parameters/application can include enforcing and executing the terms of the plurality of protection parameters or application using the one or more smart contracts deployed to the distributed ledger of the data source. For example, the smart contract can monitor various data related to enforcing the terms of the insurance application (e.g., cyber incident data, payment information, claims information, etc.). For example, the smart contract executed by the modeler 708 can monitor for incoming data (e.g., threat alerts associated with a breach) that matches the protection terms and, in response to triggering a protection term condition (e.g., by receiving data corresponding to the protection term), automatically execute a programmed response (e.g., updating the blockchain with the new threat information). In some arrangements, embedding the at least one protection parameter with data includes executing a call using an application programming interface (API) or predefined script with a third party computing system. Furthermore, the application can be an insurance application to obtain or renew an insurance plan (e.g., cybersecurity protection plan).

In some arrangements, the terms (e.g., insurance/protection terms executed by the smart contracts) can include a condition for protection activation (e.g., data breach attempt), a protection value methodology (e.g., algorithmic determination of severity and/or potential impact of detected threats, etc.), and/or an automated claim settlement (e.g., triggering disbursements from a cryptocurrency wallet). Further, generating the smart contracts can include encoding the mapping parameters and the terms in smart contract logic of the one or more smart contracts (e.g., by programming rules/conditions defining the operation of the smart contract based on the mapping parameters and/or terms).

In some arrangements, the embedding system 706 can prepare and report cyber incidents according to various governmental regulations. In some arrangements, the embedding system 706 can determine when a cyber incident is substantial based on a government regulation, which could range from significant losses in the confidentiality, integrity, or availability of information systems, to serious impacts on operational safety, disruptions in business activities, or unauthorized access stemming from third-party compromises. Upon identifying such incidents, the embedding system 706 can gather a set of data for reporting. This data collection can encompass correspondence with threat actors, indicators of compromise, relevant log entries, forensic artifacts, network data, and information on how the threat actor compromised the system, among others. Additionally, the embedding system 706 can track and document data related to any ransom payments, including the amount, the decision process, and the aftermath of the payment.

For example, a substantial cyber incident can lead to one or more of the following: a substantial loss of confidentiality, integrity or availability of an information system or network of a covered entity, a serious impact on the safety and resiliency of operational systems and processes of a covered entity, a disruption of ability of a covered entity to engage in business or industrial operations, or deliver goods or services, unauthorized access to information systems or networks of a covered entity, or any nonpublic information contained therein, that is facilitated through or caused by a compromise of a cloud service provider, managed service provider, or other third-party data hosting provider, or supply chain compromise.

Furthermore, in some arrangements, the embedding system 706 can also be configured to manage and submit follow-up reports. This can include generating supplemental reports when new or different information about a cyber incident becomes available or if additional ransom payments are made. Thus, the embedding system 706 can provide relevant data such that it is accurately preserved and maintained for a period (e.g., set at two years), following the submission of the recent report. This data preservation can include the initial detection of a compromise to the full resolution and analysis of the incident, including any payments made and the identification of exploited vulnerabilities.

In some arrangements, the operational framework of the embedding system 706 aligns with timely and detailed incident reporting and data preservation to assist organizations in maintaining compliance with regulatory requirements. By automating the process of collecting, preserving, and reporting detailed information about cyber incidents and ransom payments, the embedding system 706 reduces manual effort and enhances the accuracy of the information reported. This approach can be used to fulfil legal and regulatory obligations and strengthen the overall cybersecurity posture of organizations by identifying a structured response to incidents and facilitating continuous improvement through detailed incident analysis and feedback.

In some arrangements, the preservation requirement of the embedding system 706 can include correspondence with the threat actor, regardless of the forum or method; indicators of compromise; relevant log entries; relevant forensic artifacts; network data; data and information that can help identify how a threat actor compromised or potentially compromised an information system; system information that can help identify exploited vulnerabilities; information about exfiltrated data; data or records related to the disbursement or payment of any ransom payment; and any forensic or other reports concerning the incident, whether internal or prepared for the covered entity by a cybersecurity company or other third-party vendor.

Referring to FIGS. 8A-8C generally, example graphical user interfaces (GUIs) 800 are shown (e.g., depicting illustrative applications and interfaces used in modeling protection parameters or an application). At least one (e.g., each) of the GUIs 800 shown in FIGS. 8A-8C can be displayed via an application (e.g., application 112) executing on a computing system of the user (e.g., client device 110).

Referring now to FIG. 8A in detail, an example of the GUI 800 for collecting data used in modeling the protection parameters or application is shown. In some arrangements, the GUI 800 can incorporate the same or similar features and functionality as described above regarding the collection system 702 of FIG. 7. As shown in FIG. 8A, the GUI 800 can include an interactive element 802 and an interactive element 804. The interactive element 802 can be a user input field (e.g., protection parameter) and can be configured to receive information from the user (e.g., via manual input, automated input) and/or on behalf of the user (e.g., by a GAI embedding data into a content field). For example, the interactive element 802 can be a drag-and-drop (drag-n-drop) input field configured to receive and manage data of various data types (e.g., unstructured data such as free-form text, legal documents in PDF formation, JSON data, etc.) inputted by the user via the GUI 800. In some arrangements, a computing system incorporating a GAI model (e.g., security architecture shown in FIG. 7) can be used to embed data within protection parameters (e.g., content fields). In some arrangements, the interactive element 804 can be a button configured to update the appearance of the GUI 800 in response to the user interacting with the interactive element 804 (e.g., by the user pressing the button). For example, the interactive element 804 can be used to begin a questionnaire used to complete or assist in completing additional unfilled protection application content fields (e.g., by transitioning to displaying an updated GUI with protection parameters/content fields corresponding to the provided data, such as the GUI 800 of FIG. 8B).

For example, in utilizing GAI to prefill insurability applications, a user can drag and drop cybersecurity policies, risk framework documents, or insurance applications of a previous year into a designated area, where the GAI is executed to automatically extract relevant information and fill fields. In another example, for drag-and-drop prefill, the processing circuits can recognize and categorize documents based on their content, such as identifying a document as a policy manual and extracting relevant sections for the insurance application. In yet another example, in translating Tactics, Techniques, and Procedures (TTP) and incident facts for claim interpretation and decisions, GAI can receive as input disparate pieces of incident data, normalize them to a common format, and integrate (e.g., output) them with insurance claims.

Referring now to FIG. 8B, an example of the GUI 800 for interfacing with a user and collecting data used in modeling the protection parameters or application is shown. In some arrangements, the GUI 800 can incorporate the same or similar features and functionality as described above regarding the interface system 704 of FIG. 7. As shown in FIG. 8A, the GUI 800 can include interactive elements 806a-806b (collectively, interactive element 806) and content element 808. The interactive elements 806 can incorporate the same or similar functionality as described above regarding the interactive element 802 of FIG. 8A. For example, the interactive element 806a can be a multiple-choice selection field (e.g., displaying a “Yes” and “No” option to be selected in response to a cybersecurity question) and be user-interactive (e.g., selectable by the user pressing the “Yes” or “No” option displayed via interactive element 806a). For example, the interactive element 806b can be a text-based interactive element (e.g., displaying cybersecurity information related to the protection application) and be configured to interact with a GAI model (e.g., by the GAI modeling embedding data in protection parameters/content fields based on received information in the interactive element 806b). In some arrangements, as described regarding FIG. 8A, the interactive element 806 can be configured to receive information (e.g., unstructured data) from the user (e.g., via manual input) and/or on behalf of the user (e.g., by a GAI embedding data into protection parameters of the application based on received data in the interactive element 802). Generally, at FIG. 8B, the GAI model, executed by the processing circuits and systems of the response system 130 of FIG. 7, can analyze the questions and responses by the entity and access a vector database for the best answer, and then shows the recommended answer. Accepting or rejecting at 806b can be used to retrain the GAI model to improve the model based on the feedback. For example, if an entity consistently rejects the recommended cybersecurity practices in favor of more stringent measures, the model can learn to adjust its recommendations towards more comprehensive security protocols. In another example, when an entity frequently accepts suggestions on enhancing data encryption standards, the model can prioritize higher security encryption methods in future recommendations, reflecting a preference of the entity for stronger data protection measures. Additionally, content element 808 can be in a file format supporting the answer recommendation by the GAI model, which can then be attached to provide proof to support an attestation response by the entity.

Referring now to FIG. 8C, an example of output data generated using input data received through the GUI 800 is shown. In some arrangements, the GUI 800 can incorporate the same or similar features and functionality as described above regarding the modeler 708 of FIG. 7. As shown in FIG. 8C, the GUI 800 includes activity data 810 (e.g., related to a cyber incident or a plurality of cyber incidents). The processing circuits (e.g., modeler 708) can model data provided by Jane Doe and John Doe to output interruptible data for a protection application. For example, the entity employing Jane and John Doe can have an active protection plan. However, in response to an incident the insurer (or provider) can prompt for additional data to be collected. The modeler 708 can model the activity and inputted/collected data of the entity to generate the shown output. For example, the GUI 800 can receive unstructured data (e.g., activity data 810) as described above regarding FIG. 7 and model, using a GAI model, the protection application by generating an output based on a protection parameter (e.g., content field) of the protection application and entity data of an entity (e.g., by translating the activity data 810 into a plain text format). For example, input data (e.g., activity data 810) corresponding to cybersecurity incidents (e.g., time of access, execution, etc.) in a concise (e.g., sparse, indexed, etc.) format can be received via the GUI 800 and transformed, using the GAI model, into output data in a human-readable (e.g., paragraph-based) format, and the output data can include expanded (e.g., detailed) information related to the input data (e.g., by the GAI model using contextual interpretation functions, narrative expansion functions, detailing and enrichment functions, etc.).

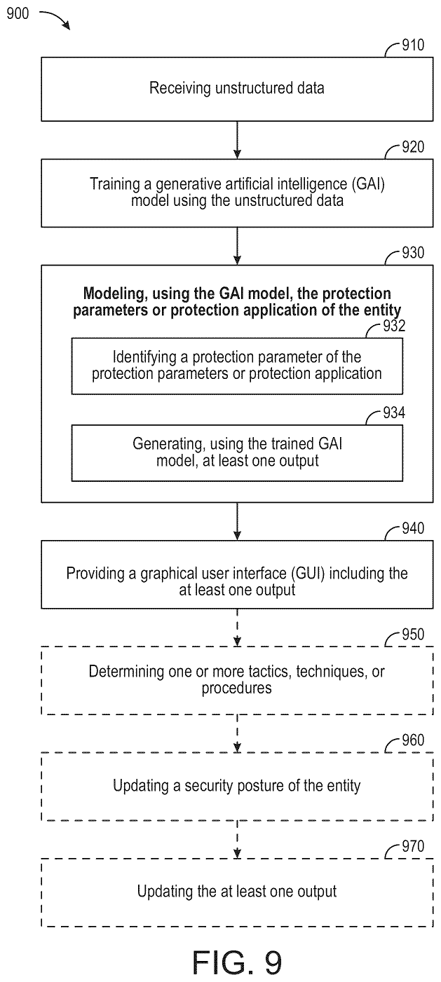

Referring now to FIG. 9, a flowchart for a method 900 to model a security application is shown, in accordance with present implementations. At least the computing/security architecture shown and described regarding FIG. 7 can perform method 900 according to present implementations.

In a broad overview of method 900, at block 910, the one or more processing circuits (e.g., response system 130 of FIG. 7) can receive unstructured data. At block 920, the one or more processing circuits can train a generative artificial intelligence (GAI) model using the unstructured data. At block 930, the one or more processing circuits can model, using the GAI model, the protection parameters or protection application of the entity by identifying a protection parameter (e.g., content field) of the plurality of protection parameters or protection application at step 932 and generating, using the trained GAI model, at least one output at step 934. At block 940, the one or more processing circuits can provide a graphical user interface (GUI) including the at least one output. At block 950, the one or more processing circuits can determine one or more tactics, techniques, or procedures. At block 960, the one or more processing circuits can update the security posture of the entity. At block 970, the one or more processing circuits can update the at least one output.

At block 910, the one or more processing circuits can receive a plurality of unstructured data corresponding to cybersecurity modeling (e.g., for modeling protection parameters or applications). In some arrangements, the unstructured data received at block 910 can include entity data related to cybersecurity information of an entity and/or other data corresponding to cybersecurity modeling. For example, at block 910, the processing circuits can receive a cybersecurity response plan via the user or the GAI model interacting with a graphical user interface, as described above. In some arrangements, the plurality of unstructured data can include a plurality of cyber resilience data, safeguard data, configuration data, insurance data, controls schemas, or historical insurance data. For example, the plurality of unstructured data can include previous protection applications, cybersecurity incident reports, compliance documents, historical incident/response data, etc. Generally, resilience data can be, but is not limited to, system architecture documentation, risk assessment reports, business continuity and disaster recovery plans, employee training and awareness records, third-party vendor security assessments, and technology upgrade and patch management schedules. That is, resilience data can be data from the entity shows and verifies their particular implementations and products used to prevent potential threats. For example, this can include detailed records of security audits, penetration testing results, security policy enforcement activities, and evidence of compliance with industry-standard cybersecurity frameworks. In another example, the processing circuits might receive a historical protection application document and a set of compliance audit reports to automatically prefill sections (e.g., protection parameters, content fields, etc.) of a new protection application.

At block 920, the one or more processing circuits can train a generative artificial intelligence (GAI) model using the unstructured data. In some arrangements, the unstructured GAI model trained at block 910 can be trained using various AI training techniques (e.g., supervised learning, unsupervised learning, semi-supervised learning, transfer learning, reinforcement learning, etc.) and using the unstructured data received at block 910 as training data. For example, the GAI model can correspond to a retrieval-based and generative-based model (e.g., RAG model). In some arrangements, training can include preprocessing steps such as data cleansing, normalization, and feature extraction to make the unstructured data more suitable for AI model consumption. Furthermore, the unstructured data can be the training dataset that is used to enrich the understanding and response accuracy of the GAI model to cybersecurity and protection application scenarios. In some arrangements, the unstructured data can be converted into one or more formats (e.g., PDF documents, email bodies, text files, HTML pages, system logs, incident reports, policy manuals, chat transcripts) that are structured for AI processing, sometimes including preprocessing steps like tokenization, normalization, and encoding. In some arrangements, the GAI model is a large language model (LLM).

In general, training the GAI for a protection application content field includes collecting, by the processing circuits, a diverse set of unstructured data relevant to cybersecurity and insurance, followed by preprocessing steps such as data cleansing, normalization, feature extraction, and encoding. This data can then be used to train the model through various machine learning techniques, including supervised, unsupervised, and semi-supervised learning methods, depending on the availability of labeled data and the specific task for outputting. The training process can also include validation and testing phases to assess the model performance and accuracy in generating outputs that align with the requirements of protection applications. Additionally, continuous learning or re-training can be employed to update the knowledge base for the model and improve its adaptability to new cybersecurity threats and protection application scenarios.

For example, the training of the GAI model can include a training to model to understand and process entity-specific security information and incident data. The training process can start with collecting an array of entity security protocols, network information, cyber protection measures, incident reports, and any related documentation that outlines the cybersecurity landscape of an organization. These documents, often in unstructured formats such as text files, PDFs, and logs, are then preprocessed to extract relevant features. In some arrangements, the training can occur on received structured data or semi-structured data. This preprocessing could include the identification and extraction of specific data points like types of security protocols in use, details of past cybersecurity incidents, and the current network infrastructure. Following the preprocessing phase in this example, the data can be used in a training regimen that might combine several machine learning approaches. For example, supervised learning could be applied to examples where the correct input-output mappings are known (e.g., teaching the model to predict the fields in a protection application based on the specifics of the cybersecurity information provided). This could be supplemented with unsupervised learning to discover patterns or categorizations within the cybersecurity data that are not directly labeled but can enhance the understanding and accuracy of the model. Upon training, the GAI model can be used to automatically interpret and fill out protection parameters or applications accurately, using cybersecurity data from entities. This includes understanding what information is relevant to an insurance application and translating (or mapping) technical security details into the standardized formats and terminologies used in insurance or any application documentation.

At block 930, the one or more processing circuits can model, using the GAI model, the protection application of the entity. Modeling can include performing steps 932-934. For example, modeling can include identifying at least one protection parameter (e.g., content field) of the protection parameters or protection application (step 932). For example, identifying at least one content field of the protection parameters or protection application (step 932) could include analyzing the structure of the application to determine fields relevant to cybersecurity measures, such as types of firewalls used, incident response protocols, and data encryption standards. Additionally, modeling can include generating, using the trained GAI model, at least one output based on the at least one content field of the protection application and entity data of the entity (step 934). For example, this could include outputting data for a content field related to previous cybersecurity incidents with a summary of past breaches and the responses undertaken. In some arrangements, generating includes mapping the at least one protection parameter (e.g., content field) to the at least one output and embedding the at least one content field with data including the at least one output. For example, this could include aligning specific incident data with content fields in the application that request for a description of previous cybersecurity events.

In some arrangements, mapping can include using mapping parameters of the GAI model. The processing circuits can update mapping parameters based on (1) an input by the entity computing system corresponding to the plurality of protection parameters of application and (2) a complexity and type of the at least protection parameter (e.g., content field). For example, the mapping parameters can correspond to one or more field-specific data integrity protections used by the GAI model in embedding data that satisfies one or more predefined quality or accuracy standards of the plurality of protection parameters or application. Furthermore, the mapping parameters of the GAI model can be dynamically adjusted to enhance the relevance and precision of the data mapping process such that the information embedded into at least one (e.g., each) content field is aligned with the specific requirements of those fields. Additionally, the processing circuits can cross-validate, using the GAI model, the data embedded into the at least one protection parameter against an external data source. In some arrangements, this cross-validation can provide a verification of the accuracy and timeliness of the data by comparing it with updated cybersecurity standards and incident databases. For example, this could include cross-referencing or comparing the embedded cybersecurity protocols against current best practices listed in a trusted cybersecurity framework to determine that the application reflects the up-to-date security measures.

Still referring to block 930, specifically at step 934, the processing circuits can generate a prompt based on the identified at least one protection parameter (e.g., content field) of the protection application. For example, the processing circuits can generate a prompt asking for detailed information on the cybersecurity incident response strategy of the entity, tailored to the specific requirements of a protection parameter (e.g., content field) detailing information related to incident management. Additionally, the processing circuits can receive a response to this prompt, such as a detailed account of the incident response protocol of the entity, and provide this response for modeling by the GAI model. In some arrangements, this modeling process can include analyzing the response to extract elements that align with insurance application criteria, such as response time, involved cybersecurity tools, and recovery procedures. In another example, the processing circuits could generate a prompt for the entity data encryption standards and, upon receiving a description of the encryption protocols used, use the GAI model to map this information to the appropriate field (e.g., protection parameter) in the insurance application.

In some arrangements, the GAI model is a large language model (LLM). For example, the processing circuits can utilize the GAI model to interpret and summarize cybersecurity documents, transforming verbose descriptions into a concise, structured format of tactics, techniques, and procedures (TTPs) and incident facts that can be inputted into the protection application. For example, the GAI model can analyze (model) a detailed incident report and distill it into a standardized list of TTPs used in a cybersecurity breach, suitable for inclusion in an insurance application risk assessment section. In another example, the GAI model could generate a timeline of cybersecurity incidents experienced by the entity, including facts and responses, in a format that aligns with the structured data requirements of insurance providers. In some arrangements, embedding the at least one content field with data (outputs) include executing a call using an application programming interface (API) or predefined script with a third-party computing system providing the protection application. For example, embedding the at least one content field with data (outputs) might include executing a call to a cybersecurity framework API, which automatically populates the application fields with updated compliance standards relevant to the entity industry.

At block 940, the one or more processing circuits can provide a graphical user interface (GUI) of the protection application including the at least one output. In some arrangements, the GUI can include one or more selectable elements, as described regarding interactive elements 802 (e.g., selectable elements), 806a-806b, and 808 of FIGS. 8A and 8B, respectively.

In some arrangements, the processing circuits can generate a metadata token based on tokenizing the plurality of protection parameters or application. For example, the one or more processing circuits can generate a digital token (e.g., for use on a blockchain) by appending cybersecurity data (e.g., protection parameters) to the token as metadata for subsequent use/identification of the token. In some arrangements, the metadata token can be generated based on tokenizing the plurality of protection parameters or application inclusive of the at least one output and the plurality of unstructured data. Further, in some arrangements, the one or more processing circuits can further broadcast or store the metadata token to a distributed ledger or data source (e.g., by providing a public address of the tokenized protection application on the distributed ledger to third parties for verification). For example, the one or more processing circuits can create a digital token representing the protection plan (e.g., by generating a cryptographic token that encapsulates aspects of the protection plan, such as terms, conditions, activation triggers, etc.) stored on a distributed ledger and can communicate data related to the digital token for a user, entity, or third party (e.g., to verify data integrity, to show modifications to data, etc.).

In some arrangements, the one or more processing circuits can further link the metadata token to a security posture of the entity to the plurality of protection parameters or application. For example, the one or more processing circuits can link data corresponding with entity security posture (e.g., data indicating an entity desire for cybersecurity protection stored on a database) to the metadata token such that accessing the metadata token provides the information corresponding with the security posture (e.g., provides data indicating entity desire for cybersecurity coverage). In some arrangements, the one or more processing circuits can further provide a public address of the metadata token on the distributed ledge or data source to a plurality of third parties for verification. For example, the one or more processing circuits can store the metadata token using a distributed computing architecture as described above (e.g., using private/public ledgers), and an insurer or other entity providing a protection product can access the metadata token via the public/private ledgers to verify the veracity of information contained in the metadata token (e.g., to verify cybersecurity posture information).

In some arrangements, after tokenizing and broadcasting the protection application to a distributed ledger or data source as described above, the processing circuits can provide a public address where the application is stored such that third parties (e.g., insurers or regulatory bodies) can independently verify the application contents and authenticity. For example, this process could be used to provide transparency and trust in the submission of cyber protection applications, with at least one (e.g., each) application detail verifiable through blockchain technology. In another example, the tokenization of the protection application can facilitate a streamlined verification process for insurers, reducing the time and resources used to assess the validity of the submitted information.

In some arrangements, the processing circuits can generate one or more smart contracts based on embedding the generated outputs using smart contract templates and deploy the one or more smart contracts to the distributed ledger. In some arrangements, the processing circuits can use the verified data within the tokenized protection application (e.g., protection parameters) to generate smart contracts using predefined templates. These smart contracts can then be enforced and executed according to the terms of the plurality of protection parameters or application using the one or more smart contracts deployed to the distributed ledger of the data source. For example, the smart contract can monitor various data related to enforcing the terms of the insurance application (e.g., cyber incident data, payment information, claims information, etc.). Furthermore, the one or more smart contracts can be configured by the processing circuits to enforce and execute protection terms of the protection application.

For example, a smart contract could automatically trigger coverage or payments based on specified conditions being met, such as the occurrence of a cybersecurity event detailed in the protection application. In another example, smart contracts could facilitate automatic renewals of the policy, adjustments in coverage, or premium calculations based on data updates to the distributed ledger. Furthermore, the one or more smart contracts can be configured by the processing circuits to automatically enforce and execute the terms of the protection parameters or application without manual intervention. For example, this could include the execution of claims processing and verification, directly linking the terms of the policy with real-time data and incident reports stored on the blockchain. In some arrangements, embedding the at least one protection parameter with data includes executing a call using an application programming interface (API) or predefined script with a third party computing system. Furthermore, the application can be an insurance application to obtain or renew an insurance plan (e.g., cybersecurity protection plan).

At block 950, the one or more processing circuits, in generating the at least one protection parameter of the plurality of protection parameters or application, can determine one or more tactics, techniques, or procedures (e.g., TTPs). In some arrangements, at block 950, the data received by the one or more processing circuits can include a plurality of unstructured data including TTP data (e.g., of the entity). For example, the processing circuits can utilize the GAI model to interpret and summarize cybersecurity documents, transforming verbose descriptions into a concise, structured format of tactics, techniques, and procedures (TTPs) and incident facts that can be inputted into the protection application (e.g., using protection parameters). For example, the GAI model can analyze (model) a detailed incident report and distill it into a standardized list of TTPs used in a cybersecurity breach, suitable for inclusion in an insurance application risk assessment section.

In another example, the GAI model could generate a timeline of cybersecurity incidents experienced by the entity, including facts and responses, in a format that aligns with the structured data requirements of insurance providers. In some arrangements, embedding the at least one protection parameter (e.g., with data (outputs)) can include executing a call using an application programming interface (API) or predefined script with a third-party computing system providing the protection application. For example, embedding the at least one content field with data (outputs) might include executing a call to an API of a cybersecurity framework, which automatically populates the application fields (e.g., protection parameters) with updated compliance standards relevant to the industry of the entity. In some arrangements, the application can be an insurance application to obtain or renew an insurance plan (e.g., cybersecurity protection plan).

At block 960, the one or more processing circuits can update the security posture of the entity. In some arrangements, the processing circuits can generate (or determine) a security posture of an entity based on a protection parameter or related cybersecurity data (e.g., using entity data/security data), the protection parameter or data corresponding to the historical and current cybersecurity implementations of the entity. Generating the security posture can include receiving state data and index data. For example, the state data includes at least one security parameter of the entity. For example, the index data includes at least one reference to the at least one security parameter. For example, the at least one security parameter includes at least one of configuration data, incident data, and metadata of the entity. Additionally, generating the security posture can include generating the security posture further based on comparing the state data to the index data and synchronizing the state data and the index data. For example, synchronizing includes identifying an update to the state data and the index data (e.g., based on the update to the state data). For example, identifying includes comparing the state data to previous state data based on the index data.

At block 970, the one or more processing circuits can update the at least one output. Additionally, in some arrangements, the plurality of unstructured data includes TTP data, and generating the at least one protection parameter (e.g., content field) of the protection application further includes (1) determining, using the trained GAI model, one or more tactics, techniques, or procedures (TTPs) of one or more attackers, (2) updating the security posture based on the one or more identified TTPs, and (3) updating the at least one output based on the updated security posture. For example, determining the one or more TTPs of attackers using the trained GAI model could include the one or more processing circuits analyzing incident reports and threat intelligence to identify patterns and methods used in cyber-attacks, such as phishing techniques or malware types, which are then used to update the entity security posture in the protection parameters or application, or are then used to update the at least one output based on the security posture. In another example, after identifying TTPs, such as the use of ransomware through email phishing, the GAI model updates the protection parameters or application to reflect enhanced security measures the entity has implemented in response (e.g., advanced email filtering, employee cybersecurity training, etc.).

### Systems and Methods for Modeling Micro-Protections Using Cybersecurity Data and Third-Party Parameters

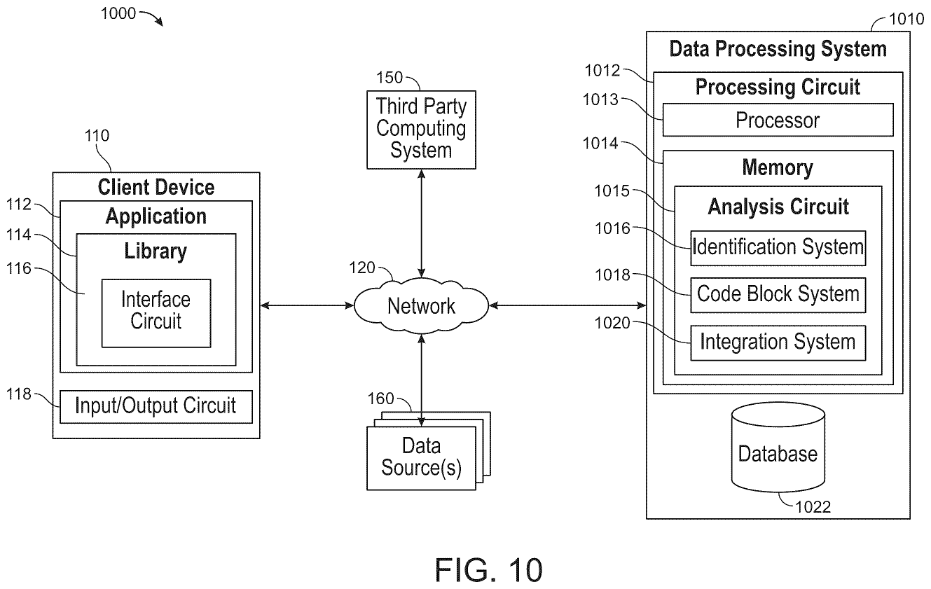

Referring to FIG. 10, a block diagram of an implementation of a system 1000 for modeling micro-protections using cybersecurity data and third-party parameters is shown, according to some arrangements. The implementation shown in FIG. 10 includes a client device 110 (also referred to herein as user computing system, entity computing system, etc.), third party computing system 150 (also referred to herein as third party computing system, etc.), data source(s) 160, and data processing system 1010. In some implementations, the client device 110 can include an application 112 and an input/output circuit 118. The application 112 can include a library 114, and the library 114 can include an interface circuit 116. In some implementations, the data processing system 1010 can include a processing circuit 1012 and a database 1022. The processing circuit 1012 can include a processor 1013 and memory 1014. The memory 1014 can include an analysis circuit 1015. In some implementations, the analysis circuit 1015 can include an identification system 1016, a code block system 1018, and an integration system 1020, as further described herein. The various components of FIG. 10 can be interconnected through a network 120 (e.g., decentralized network, centralized network, data source, etc.).

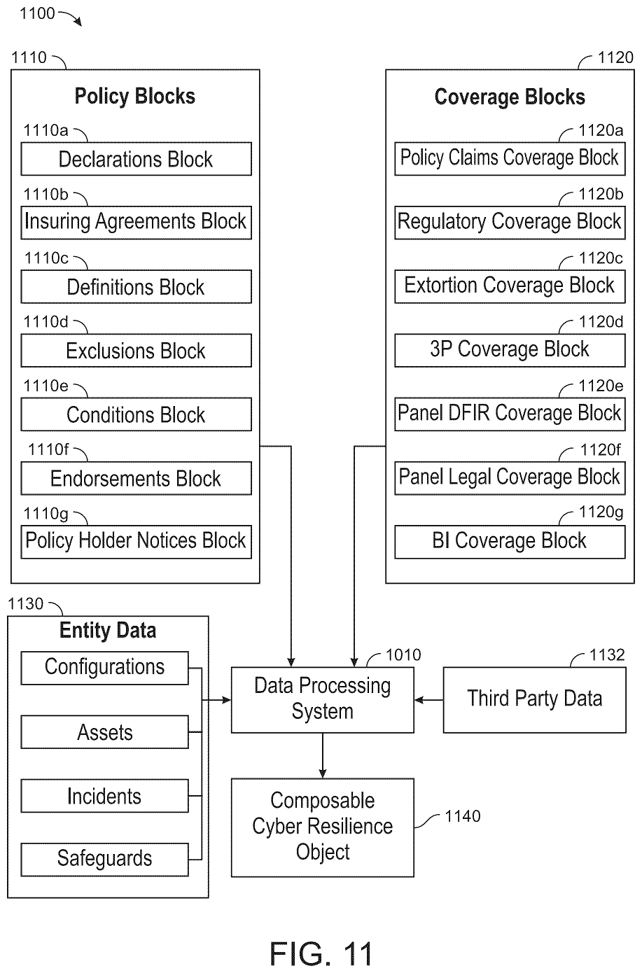

In some implementations, the elements shown in FIG. 10 can incorporate similar features and/or functionality as described regarding the elements shown on, for example, FIGS. 1A-1B. For example, the data processing system 1010, as shown in FIG. 10, can incorporate similar features and/or functionality as described regarding the response system 130 of FIGS. 1A-1B, and the client device 110 of FIG. 10 can incorporate the same or similar functionality as described regarding the client device 110 of FIGS. 1A-1B, and so on. Specifically, like callout references of FIGS. 1A-1B are now further described, however the features and/or functionalities of components like the client device 110, for example, in FIG. 11 still correspond to those referred to with the same callout reference in FIGS. 1A-1B.

In some implementations, at least one (e.g., each) system or device of FIG. 10 (e.g., client device 110, data processing system 1010, identification system 1016, code block system 1018, integration system 1020, third party computing system 150, etc.) can include and/or be communicatively coupled with one or more processors, memories, network interfaces (sometimes referred to herein as a “network circuit”) and/or user interfaces. For example, the client device 110, data processing system 1010, identification system 1016, code block system 1018, integration system 1020, and/or third party computing system 150 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions (e.g., a non-transitory computer readable storage medium (CRM)). The instructions can include code from various programming languages commonly used in the industry, such as high-level programming languages, web development languages, and/or systems programming languages. The client device 110, data processing system 1010, identification system 1016, code block system 1018, integration system 1020, and/or third party computing system 150, and/or other various devices or components of FIG. 10 can also include one or more databases for storing data that receive and/or provide data to other systems and devices on the network 120.

The memory (e.g., memory 1014) can store programming logic (e.g., a content management circuit or analysis circuit 1015) that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and/or devices to communicate wirelessly or otherwise. The various components of devices in system 1000 can be implemented via hardware (e.g., circuitry), software (e.g., executable code), or any combination thereof. Devices, systems, and/or components in FIG. 1000 can be added, deleted, integrated, separated, and/or rearranged in various implementations of the disclosure.

In some implementations, the client device 110 can include any computing system or device associated with an entity. For example, an entity can interact with client device 110 to cause client device 110 to transmit and/or receive data (e.g., perform data exchanges) to or from data processing system 1010 or third party computing systems 150 via network 120. In some implementations, client device 110 can transmit, receive, or cause transmission of cyber resilience data. Cyber resilience data can include or refer to any data of any type, such as attestation data, configuration data, safeguard data, incident data, effectiveness data, protectability data, insurability data, and so on. For example, attestation data can indicate whether an entity has implemented one or more protections (e.g., access controls, encryption mechanisms, etc.) in a computing or networking infrastructure. For example, configuration data can operational data associated with security tools, safeguards, or other systems or protocols deployed or implemented by the entity. For example, safeguard data can include metrics or values indicating implemented security measures (e.g., firewall throughput, endpoint coverage, etc.). For example, incident data can include historical data, documents, logs, or other information associated with cybersecurity events (e.g., breaches, ransomware attacks, etc.), such as event lists, attack types, affected systems, or remediation actions. For example, effectiveness data can include information related to the reliability or performance of cybersecurity controls or response protocols, such as threat detection accuracy, number and scope of incidents, and/or historical response times. For example, protectability data can include claims data, insurability assessments, levels of protection, predefined risk thresholds, and so on. In some implementations, the attestation data, configuration data, safeguard data, incident data, effectiveness data, and/or protectability data can be encapsulated in data structures (e.g., modular code blocks, tokens, etc.).

In some implementations, the network 120 can include or refer to any decentralized network, centralized network, or data source. For example, a decentralized network can include any distributed architecture where interconnected nodes (e.g., client device 110, third party computing system 150, data processing system 1010, etc.) exchange, process, and/or store data without reliance on a single central authority. For example, a decentralized network can include a blockchain in which data is maintained in an immutable ledger shared across nodes. Additionally, the network 120 can include a decentralized network configured to implement consensus algorithms, such as proof-of-work or proof-of-stake, to validate data exchanges between nodes. For example, the network 120 can include a centralized network including one or more servers or computing systems configured to manage and/or route data exchanges within the system 1000. For example, the network 120 can include a cloud-hosted environment or on-premises server infrastructure that aggregates, processes, and distributed data to various computing systems or components.

In some implementations, the third party computing system 150 can include any computing system or device associated with an external entity, such as a protection provider, vendor, partner organization, service provider, insurer, or compliance authority. The third party computing system 150 can interact with various systems or components of the system 1000, such as the client device 110 or data processing system 1010, via network 120 to transmit, receive, or process data (e.g., third party data). For example, the third party computing system 150 can transmit and/or otherwise provide one or more third-party parameters (e.g., policy attributes) to the data processing system 1010 for use in generation of a composable cyber resilience object. In some examples, the third party computing system 150 can be associated one or more of cybersecurity protection providers, insurers, security vendors, or compliance platforms that define protection terms or provide coverage logic. That is, the third party computing system 150 can supply data used by the data processing system 1010 generate composable cyber resilience objects aligned with external protection parameters.

In some implementations, the data source(s) 160 can include any system, repository, or database configured to provide or store data relevant to operations performed by the system 1100. For example, data source(s) 160 can include organizational databases, third party databases, external data feeds, system logs, or third-party APIs. Data source(s) 160 can provide various data that can be used in generating or verifying tokens, modeling zero-knowledge proofs (ZKPs), or evaluating compliance with posture or performance parameters. In some examples, data source(s) 160 can provide attestation data, configuration data, safeguard data, incident data, effectiveness data, or protectability data associated with one or more entities. For example, data source(s) 160 can include an organizational repository storing logs or historical records of cybersecurity events, such as incident response timelines, affected systems, or remediation actions. For example, data source(s) 160 can include an external compliance framework or database (e.g., repository of NIST or ISO security standards) that provides criteria or thresholds used to evaluate compliance. For example, data source(s) 160 can include one or more threat intelligence feeds configured to issue updated information on known vulnerabilities or incidents relevant to entity performance.

In some implementations, the database 1022 can include any system, repository, or storage medium configured to store, manage, or provide access to data relevant to operations performed by the data processing system 1010 or other components of the system 1000. For example, the database 1022 can store entity data or cyber resilience data (e.g., implemented safeguards, configuration records, incident logs, and/or posture scores or states). Additionally, the database 1022 can store structured or unstructured data used in generating composable cyber resilience objects, such as metadata (e.g., policy status indicators, coverage triggers, safeguard mappings) or policy descriptors (e.g., tokenized fields, code references, policy identifiers) associated with one or more modular code blocks. In some examples, the database 1022 can store a library of code blocks that correspond to policy information, third-party parameters, rules, conditions, and/or functions used to determine protection eligibility for an entity and/or provide one or more cyber protections (e.g., micro-protections) to the entity. The database 1022 can store various data used by the data processing system 1010, such as compliance responses, claims data, event correlation data, performance metrics, and so on. In some examples, the database 1022 can maintain a history (e.g., records or logs) of previously generated composable objects and/or associated data (e.g., logs of code block updates, references to protections delivered or executed based on posture state changes or incidents, etc.). For example, the data processing system 1010 can retrieve data from the database 1022 during generation, validation, modification, or deployment of composable cyber resilience objects.

In some implementations, the data processing system 1010 can perform various operations to model, generate, and/or provide a composable cyber resilience object (e.g., modeling micro-protections). In some implementations, the response system 130 can include and/or cause one or more sub-systems, such as identification system 1016, code block system 1018, and/or integration system 1020 to perform various operations to model, generate, or provide a composable cyber resilience object. In some implementations, the data processing system 1010 or identification system 1016 can identify a posture state of at least one entity based at least on configurations, assets, incidents, or safeguards of the at least one entity. That is, identifying the posture state can include the data processing system 1010 or identification system 1016 processing input data that reflects an operational or security state (e.g., a resilience to intrusion) of network infrastructure associated with the entity. For example, the data processing system 1010 or the identification system 1016 can analyze cyber information including deployed safeguards, past incident activity, or entity assets, and use the cyber information to determine a posture state (e.g., score, metric, indicator, etc.) representing a cyber resilience level or coverage level in accordance with a resilience of the entity to various cyber threats.

In some implementations, the data processing system 1010 and/or code block system 1018 can generate or select a first plurality of code blocks corresponding with a plurality of parameters of at least one third-party, and the plurality of parameters can correspond with one or more rules or conditions for providing at least one protection to the at least one entity. That is, generating can include the data processing system 1010 or code block system 1018 constructing and/or otherwise providing structured objects or code segments that encode entity data or policy data such as declarations (e.g., policy number, effective date, coverage limits), insuring agreements (e.g., listed covered incidents or reimbursable cost categories), definitions (e.g., cyber intrusion event or business interruption), exclusions (e.g., embargoed software or late reporting), conditions (e.g., proof-of-performance tracking or safeguard maintenance), endorsements (e.g., changes to policies affecting coverage), and/or policyholder notices (e.g., degradation of coverage or renewal terms). For example, a generated code block can include fields with data or metadata corresponding with coverage limits, effective dates, retention values, or exclusion types. That is, selecting can include the data processing system 1010 or code block system 1018 retrieving modular blocks from a stored library or other data source based on entity selections (e.g., a policy type or coverage option).

In some implementations, the data processing system 1010 and/or identification system 1016 can determine, by the one or more processing circuits, the at least one entity qualifies for the at least one protection based on the posture state and the one or more rules or conditions. That is, determining the at least one entity qualifies for the at least one protection can include the identification system 1016 comparing posture state data (e.g., posture score, compliance flags, safeguard status indicators) against one or more eligibility thresholds encoded in the first plurality of code blocks (e.g., conditions block, exclusions block, or endorsements block) and/or other code blocks (e.g., second plurality of code blocks). For example, the identification system 1016 can determine or evaluate that the entity meets a predefined safeguard implementation level or incident frequency threshold specified in a conditions block and determine a protection eligibility or coverage (e.g., second code block) based on the determination or evaluation. In some implementations, the data processing system 1010 can parse logic expressions or structured conditions stored within the first plurality of code blocks to identify and/or otherwise determine that entity data (e.g., posture state) satisfies rules and/or conditions for a particular protection.

In some implementations, the data processing system 1010 and/or code block system 1018 can generate or select a second plurality of code blocks comprising one or more functions to provide the at least one protection based on the one or more rules or conditions. That is, generating can include the data processing system 1010 or code block system 1018 constructing executable code segments that represent one or more operations for implementing coverage logic or response behavior (e.g., cost calculations, policy enforcement routines, or remediation triggers). For example, a generated code block can include one or more functions for routing event data, applying payout logic, referencing cost categories, or initiating response actions and/or workflows. That is, selecting can include the data processing system 1010 or code block system 1018 retrieving stored functions or templates associated with protections matched to the entity posture (e.g., business interruption coverage logic, regulatory fines processing, or third-party claim handling functions).

In some implementations, the data processing system 1010 and/or integration system 1020 can generate the composable cyber resilience object, and generating can include integrating at least a portion of the first plurality of code blocks and the second plurality of code blocks into at least one data structure corresponding with one or more functions or fields of the composable cyber resilience object. That is, the integration system 1020 can generate a unified object that embeds both declarative code segments (e.g., coverage terms, policy metadata, conditional triggers) and executable protection logic (e.g., reimbursement functions, compliance evaluators, incident response routines) into a structured format that can be deployed and executed within a distributed computing environment. For example, the integration system 1020 can construct the composable cyber resilience object as a serialized data structure (e.g., JSON object, protocol buffer message, or other typed container) where policy attributes are mapped to corresponding functions that reference runtime parameters. In some examples, the integration system 1020 can include logic pointers or callable functions embedded within the object (e.g., response handlers or eligibility check routines), such that the object can be parsed or invoked by downstream systems to perform protection actions in real time.

In some implementations, the data processing system 1010 and/or integration system 1020 can link the composable cyber resilience object and at least one computing or networking infrastructure of the at least one entity using a communication interface or structure. That is, the integration system 1020 can associate the composable object with one or more infrastructure components (e.g., monitored endpoints, containerized services, agents, etc.) of an entity computing system (e.g., client device 110) using a connection layer or interface protocol (e.g., API call, webhook, publish-subscribe channel, etc.). For example, the composable cyber resilience object can be linked to an endpoint associated with the entity such that updates to posture and/or triggering events at the entity computing system can be transmitted and/or received via the data processing system 1010. In some examples, the data processing system 1010 can use the linked interface to receive data (e.g., posture data, telemetry data, incident data, safeguard data, etc.) from the entity and transmit data (e.g., outputs of composable object functions) in response to observed conditions (e.g., a covered security event or posture update).

Referring now to FIG. 11, a block diagram of certain systems or device of FIG. 10 is shown, according to some implementations. The implementation shown in FIG. 11 (e.g., system 1100) can include the data processing system 1010, policy blocks 1110a-1110g (collectively, policy blocks 1110), coverage blocks 1120a-1120g (collectively, coverage blocks 1120), entity data 1130, third party data 1132, and composable cyber resilience object 1140. In some implementations, the elements shown in FIG. 11 can incorporate similar features and functionality as described regarding the elements shown on FIG. 10. For example, the data processing system 1010, as shown on FIG. 11, incorporates similar functionality as described regarding the data processing system 1010 shown on FIG. 10, and so on.

In some implementations, the data processing system 1010 can receive and/or otherwise identify entity data 1130. For example, the entity data 1130 can include configurations (e.g., deployed endpoint detection agents, active directory structures), assets (e.g., domain names, virtual machine instances, device inventories), incidents (e.g., logged ransomware events, reported phishing attempts), and/or safeguards (e.g., access controls, network segmentation policies, encryption protocols) associated with an entity computing and networking infrastructure. In some examples, the data processing system 1010 can identify and/or access data from remote storages, monitoring tools, or interfaces of an entity network. Additionally, the data processing system 1010 can identify or extract one or more portions of the received entity data (e.g., a part or subset of the entity data, the full entity data, etc.) and can process, parse, and/or structure the extracted portions for integration into one or more modular code blocks (e.g., policy blocks 1110).

In some implementations, the data processing system 1010 can receive and/or otherwise identify third party data 1132. For example, the third party data 1132 can include one or more third party parameters. A third party parameter can include or refer to any condition, value, criteria, threshold, or attribute associated a third party and/or applicable to entity data of an entity seeking protection. For example, a third party parameter can include standards or requirements instituted by a third party (e.g., protection provider) as a condition for providing a protection or micro-protection to an entity. That is, a protection provider can indicate that an entity demonstrate compliance with the ISO/IEC 27001 standard for information security management systems as a condition for providing one or more protections (e.g., coverage). For example, a third party parameter can include: “The organization is to implement an encryption mechanism for transmitted data,” and the entity data can include attestation data verifying that encryption protocols, such as TLS 1.3, are active for network communications within the entity network. For example, a third party parameter can include organizational metrics to verify security of a data exchange within an organizational architecture or network. That is, a third party parameter can include: “Data exchanges are to use encrypted channels with a key length of at least 256 bits.” and the entity data can include data verifying the use of AES-256 encryption for the data exchange. For example, a third party parameter can include a value or threshold associated with a security posture of a computing and networking infrastructure of one or more entities. For example, a third party parameter can include: “The organization is to demonstrate a patch management process with less than 5% of systems having unpatched vulnerabilities,” and the entity data can include effectiveness data documenting that 97% of entity computing systems are patched against known vulnerabilities.

In some implementations, the data processing system 1010 can generate and/or select one or more of the policy blocks 1110 (e.g., first plurality of code blocks) and/or coverage blocks 1120 (e.g., second plurality of code blocks) for integration into the composable cyber resilience object 1140 in accordance with the entity data 1130 and third party data 1132. For example, the policy blocks 1110 can include a declarations block 1110a, insuring agreements block 1110b, definitions block 1110c, exclusions block 1110d, conditions block 1110e, endorsements block 1110f, and policy holder notices block 1110g. For example, the data processing system 1010 can generate and/or populate a declarations block 1110a with metadata fields that represent attributes of a policy (e.g., policy period, insured entity identifier, applicable jurisdiction, etc.) based on entity data 1130 and/or third party data 1132. For example, the data processing system 1010 can generate and/or populate an exclusions block 1110d by identifying policy exclusions corresponding an entity configuration (e.g., unsupported geographic regions, disallowed technologies) identified from the entity data 1130 and/or third party constraints (e.g., sanctioned vendors, outdated systems) identified from the third party data 1132. In some implementations, the policy blocks 1110 can include declarative metadata blocks that parameterize the composable cyber resilience object 1140 with terms, constraints, and context for evaluating or activating one or more protections (e.g., coverage blocks 1120).

Generally, the policy blocks 1110 can be structured metadata segments referencing coverage constraints or conditions. In some implementations, the policy blocks 1110 can be used to codify coverage logic and reflect entity or third party parameters. That is, the data processing system 1010 can parse these blocks to align posture data with coverage requirements. For example, a policy block 1110 can store an exclusion for certain outdated operating systems. In this example, the data processing system 1010 can detect that OS in entity data and remove coverage. In another example, a policy block 1110 can specify coverage triggers for ransomware incidents. In this example, the data processing system 1010 can identify a flagged ransomware event and apply relevant coverage terms.

Generally, the policy blocks 1110 can be dynamic data structures for coverage conditions or exclusions. In some implementations, the policy blocks 1110 can be used to update coverage parameters when posture data changes. That is, the data processing system 1010 can evaluate stored policy fields and adjust coverage logic. For example, a policy block 1110 can identify a safeguard requirement for network segmentation. In this example, the data processing system 1010 can check segmentation data and apply coverage if the requirement is met. In another example, a policy block 1110 can reference a multi-factor authentication threshold. In this example, the data processing system 1010 can read MFA status and determine if coverage is activated.

In combination, the policy blocks 1110 and coverage blocks 1120 can provide an integrated set of declarative terms and functional coverage routines. That is, the policy metadata informs coverage execution by referencing posture data and external parameters. Additionally, while the policy blocks 1110 and coverage blocks 1120 are shown, it should be understood that they can be replaced or restructured based on evolving entity or third party conditions. For example, a new policy block can be introduced if additional exclusions are needed. In another example, an existing coverage block can be substituted with updated functions for changed incident response criteria. Thus, the composable cyber resilience object can dynamically reflect posture shifts or updated requirements.

For example, the declarations block 1110 can include fields for policy number, effective date, retroactive date, expiration date, insurer, named insured, address, coverage limits (e.g., policy provides an aggregate limit for the full policy period such that coverage applies to incidents occurring after a retroactive date), retention, term, and so on. For example, the declaration block 1110 can define a policy term associated with the composable cyber resilience object 1140 as a monthly term (e.g., a premiums are billed on a recurring monthly basis with automated renewals and the insured receives automated notifications for upcoming renewals and changes to premium rates or coverage terms) or annual term (e.g., premiums for annual policies are billed upfront and renewal notifications are issued at least 60 days before an expiration date of the policy and include a review of the asset registration, safeguard inventory, and compliance update).

For example, the insuring agreements block 1110b can define one or more triggering events and/or identify corresponding categories of covered incidents and covered costs. In some implementations, the insuring agreements block 1110b can define a trigger condition for activating coverage as a cyber intrusion event including unauthorized access to a network or system and resulting in harm (e.g., operational disruption, data compromise, or financial loss), where the triggering event is digitally provable and recorded in an internal system. For example, the insuring agreements block 1110b can identify covered incidents such as data breaches (e.g., unauthorized access to personal or financial data), ransomware attacks (e.g., encrypted systems with associated demands), phishing or social engineering events (e.g., deceptive credential harvesting), and supply chain compromises (e.g., vendor-originated disruptions within the insured environment). In some examples, the insuring agreements block 1110b can define one or more cost categories that qualify for reimbursement, including business interruption costs (e.g., income loss or extra expenses during system downtime), forensic and incident response costs (e.g., investigations to assess the scope and origin of an intrusion), legal costs (e.g., consultation and reporting expenses), extortion payments (e.g., amounts transferred to terminate ransom conditions), third-party losses (e.g., financial losses incurred by external entities), public relations costs (e.g., communication and mitigation efforts), data restoration costs (e.g., restoring or recreating data), privacy claims costs (e.g., breach notifications or credit monitoring), and regulatory fines (e.g., penalties assessed by oversight bodies where insurable).

In some implementations, the definitions block 1110c can include structured terms that define policy language and/or parameters used across other blocks of the composable cyber resilience object 1140. In some implementations, the definitions block 1110c can define a cyber intrusion event as unauthorized access to a network or system resulting in measurable harm, such as data breaches, operational disruption, or financial loss, where the event is digitally provable and recorded either programmatically or manually. The definitions block 1110c can define an in-network vendor as a third-party service provider (e.g., digital forensics or incident response teams, breach counsel) that meets predefined technical and compliance standards and is listed in an approved vendor platform. The definitions block 1110c can define digital forensics and incident response (DFIR) as investigation and remediation services that provide digitally verifiable evidence regarding the cause and scope of a cyber incident. The definitions block 1110c can define proof-of-performance as documentation confirming compliance with security controls or safeguards, maintained over time for coverage qualification or proactive discounts. The definitions block 1110c can also define policy term structures, including monthly policies where recurring premiums and automated renewals are applied, and annual policies where a single premium is billed upfront, and renewal notifications are issued in advance of expiration.

In some implementations, the definitions block 1110c can include terms for cost types, such as business interruption costs (e.g., income loss or added expenses due to operational downtime following a covered event) and/or extortion payments (e.g., ransom costs made to regain access to encrypted systems or avoid data exposure). The definitions block 1110c can specify mechanisms for prioritizing reimbursement, such as order of payments across vendor warranties, primary insurance, and layered coverages, and can define tower of coverage as a layered arrangement that places primary responsibility on vendor warranties or primary policies, with excess coverage applied thereafter. The definitions block 1110c can define sanctions screening as the process for verifying whether any party or region included in a claim is subject to restrictions imposed by regulatory authorities. In some examples, the definitions block 1110c can define safeguard inventory as a maintained list of security controls deployed by the entity (e.g., multi-factor authentication, encryption, firewall policies) and baseline safeguard requirements as baseline protections that are to remain active and monitored to qualify for one or more protections. The definitions block 1110c can include degradation of coverage to refer to reduction or removal of protections caused by safeguard failure or lack of compliance documentation. Additionally, the definitions block 1110c can include and/or define compliance update notice to refer to notifications about changes in regulatory obligations that affect coverage status, covered incidents to refer any qualifying event derived from a cyber intrusion, such as unauthorized access, ransomware, phishing, social engineering, or system compromise, and retroactive dates to refer to a defined point before which no coverage is applicable regardless of when an event is discovered.

In some implementations, the exclusions block 1110d can include one or more fields that define constraints and/or disqualifying factors associated with coverage under the composable cyber resilience object 1140. In some examples, the exclusions block 1110d can include fields indicating categories of non-covered incidents or conditions, such as intentional acts (e.g., losses linked to fraudulent or criminal actions by internal personnel), unapproved software (e.g., use of embargoed software or unsupported software that has reached end-of-life), or government actions (e.g., operational shutdowns or seizures by regulatory bodies). In some implementations, the exclusions block 1110d can include data fields representing risk categories that can reduce or eliminate eligibility for protection, such as war or terrorism (e.g., cyberattacks with attributed geopolitical origins), late reporting (e.g., incident disclosures falling outside a defined reporting window), unregistered or unqualified assets (e.g., devices or data stores not listed or tracked in a registration system), and unknown safeguards (e.g., assets lacking associated safeguard status such as firewall configuration, antivirus deployment, or backup system documentation).

In some implementations, the conditions block 1110e can include restrictions and/or limitations on protections provided by the composable cyber resilience object 1140. For example, the conditions block 1110e can define obligations, procedural parameters, and operational constraints associated with activating or maintaining protections represented by the composable cyber resilience object 1140. In some implementations, the conditions block 1110e can include fields defining the legal venue for any disputes related to the policy, including a jurisdiction field and a court designation field. In some examples, the conditions block 1110e can include claims handling and notification requirements, such as a reporting window field indicating an allowable time (e.g., 24 hours from discovery), a submission format identifier, and fields for incident metadata (e.g., affected systems, estimated damages, response actions taken). The conditions block 1110e can also include defense-related parameters, including a duty-to-defend field, a defense cost allocation field indicating that defense costs reduce available policy limits, and settlement control flags indicating provider rights to resolve claims within policy constraints.

In some implementations, the conditions block 1110c can include as cancellation and/or continuation fields, such as a notice period field for provider-initiated cancellation (e.g., 30 days for non-payment or compliance failure) and/or immediate cancellation flags for fraud or misrepresentation. In some example, the conditions block 1110 can include entity-initiated cancellation provisions as input fields linked with premium adjustment logic based on remaining policy duration. The conditions block 1110e can also encode tower of coverage fields, such as source priority indicators referencing vendor warranty coverage, primary insurance policies, and the composable policy as excess coverage, with related fields defining order of payments or inter-policy coordination logic. For example, the conditions block 1110e can further include security maintenance fields, such as safeguard tracking fields (e.g., MFA usage, patch cadence, monitoring status), proof-of-performance flags indicating daily documentation within a secure system, and compliance status indicators that affect eligibility for associated coverage blocks. For example, the conditions block 1110e can define subrogation rights through fields referencing authorized recovery pathways and cooperation obligations for third-party recovery actions. For example, the conditions block 1110e can include provider approval fields indicating that approved digital forensics and legal vendors are to be used for incident response and breach counsel, and a noncompliance flag can be used to indicate when using an unapproved vendor voids or limits applicable protections. Additions, the conditions block 1110e can include fields indicating the term type (e.g., monthly or annual) and/or fields indicating results of compliance evaluations. For example, a monthly term field can include an automated renewal flag conditioned on safeguard inventory status and asset registration, and an annual term field can include a scheduled compliance review flag and a notification trigger for changes to premium rates or requested actions.

In some implementations, the endorsements block 1110f can include fields that define conditional and/or supplemental policy extensions linked to vendor use, regulatory compliance, safeguard enforcement, or high-risk scenarios. In some implementations, the endorsements block 1110f can include vendor-specific coverage fields, such as vendor identifier fields, approved vendor list references, and/or safeguard compliance indicators. For example, the endorsements block 1110f can include an in-network vendor warranty field that restricts vendor-related coverage to those vendors designated as approved within a maintained list, and a vendor safeguard requirement field that indicates active safeguards to be monitored.

In some examples, the endorsements block 1110f can include sanctions compliance fields that incorporate exclusion criteria for entities or regions subject to sanctions (e.g., via a sanctions screening requirement field or programmatic alert trigger). The endorsements block 1110f can also include safeguard compliance fields, including safeguard type arrays (e.g., MFA, endpoint protection, backup completion), reporting frequency fields (e.g., weekly), and/or proof-of-performance fields that track compliance over time. In some implementations, the endorsements block 1110f can store and/or update safeguard definitions based on network incident telemetry. Additionally, the endorsements block 1110f can include extended coverage fields that indicate enhanced limits or broader protections. For example, the endorsements block 1110f can include a regulatory investigation coverage field referencing legal expenses associated with regulatory inquiries that exceed base limits, and an expanded cyber extortion field that references extended response logic or increased reimbursement thresholds for ransomware events. Various fields (e.g., endorsement entries) can be included in the endorsements block 1110f and linked to related functions within corresponding coverage blocks 1120.

Additionally, the endorsements block 1110f can include extended coverage fields that represent enhanced limits or broader protections. For example, the endorsements block 1110f can include a regulatory investigation coverage field referencing legal expenses associated with regulatory inquiries that exceed base limits, and/or an expanded cyber extortion field that references extended response logic or increased reimbursement thresholds for ransomware events. These endorsement entries can be incorporated into the composable cyber resilience object 1140 and/or linked to related functions and limits within corresponding coverage blocks 1120.

In some implementations, the policyholder notices block 1110g can include fields corresponding with automated renewal instructions, cancellation conditions, coverage degradation triggers, policy change alerts, and/or compliance update messaging. In some implementations, the policyholder notices block 1110g can include an automated renewal notice field that stores information for generating entity-facing alerts at least 60 days before an expiration date and/or with indicators to confirm that safeguard inventory and asset registration have been reviewed. The policyholder notices block 1110g can also include metadata fields representing any premium adjustments, revised coverage terms, or changes in entity eligibility. In some implementations, the policyholder notices block 1110g can include cancellation notice fields, such as a non-payment threshold, grace period indicator, non-compliance triggers, and fraud or misrepresentation flags, which can be referenced by the data processing system 1010 when generating policy state updates or notifications. In some examples, the policyholder notices block 1110g can include degradation of coverage indicators, including discount status flags, proof-of-performance compliance indicators (e.g., safeguard tracking, asset registration status), and associated claim denial conditions. Additionally, the policyholder notices block 1110g can include change of terms notice fields, such as policy adjustment triggers (e.g., risk assessment changes, vendor list updates) and notification timeframes. For example, a field can reference a notification period of 30 days prior to a term change. The policyholder notices block 1110g can also include compliance update notice fields referencing jurisdiction-specific regulatory changes and corresponding action items by the entity, and the entries can be linked to entity-facing notifications and referenced by other systems or components during policy enforcement, renewal, or claim evaluation workflows.

In some implementations, the coverage blocks 1120 can include a policy coverage block 1120a, a regulatory coverage block 1120b, an extortion coverage block 1120c, a 3P coverage block 1120d (e.g., coverage for losses including third party data processors or cloud providers), a panel DFIR coverage block 1120c (e.g., coverage for digital forensics or incident response services using a designated vendor panel), a panel legal coverage block 1120f (e.g., coverage for preapproved breach counsel or litigation response), and/or a BI coverage block 1120g (e.g., coverage for business interruption losses associated with downtime or degraded service). For example, the data processing system 1010 can use entity data 1130 indicating active protections, incident history, or asset types and third party data 1132 defining eligibility criteria or exclusions to determine one or more coverage blocks 1120 that apply to the entity (e.g., protections qualified for by the entity). In some implementations, the data processing system 1010 can generate and/or populate variable fields of the coverage blocks 1120 based on entity data 1130, third party data 1132, and/or data of the policy blocks 1110. For example, the data processing system 1010 can generate an extortion coverage block 1120c with functions for processing extortion-related costs (e.g., ransom reimbursements, data recovery actions) in response to a determination that the entity meets eligibility thresholds for extortion protections based on the entity data 1130, third party data 1132 (e.g., parameters), and/or declarative metadata from policy blocks 1110. In another example, the data processing system 1010 can select a regulatory coverage block 1120b including logic for applying penalties or triggering compliance workflows. In some examples, at least one (e.g., each) of the coverage blocks 1120 can encode executable logic used for performing protection actions based on claim types, and the coverage blocks 1120 can be selected or generated to correspond with the protections the entity qualifies for based on the evaluated inputs.

In some implementations, the data processing system 1010 can integrate one or more of the policy blocks 1110 and the coverage blocks 1120 into the composable cyber resilience object 1140. For example, the data processing system 1010 can construct the composable cyber resilience object 1140 by programmatically assembling, generating, and/or compiling a structured data object or representation (e.g., serialized object, compiled bundle, etc.) that includes selected and/or generated policy blocks 1110 and coverage blocks 1120. In some implementations, the data processing system 1010 can merge field values, rules, and identifiers from policy blocks 1110 with function definitions, triggers, or handlers from coverage blocks 1120 (e.g., extortion coverage logic, regulatory response routines, etc.). That is, at least one (e.g., each) of the coverage blocks 1120 can include one or more executable functions to provide a defined protection (e.g., the extortion coverage block 1120c including functions to provide coverage and/or protection for extortion payments, the BI coverage block including functions to provide coverage and/or protection for business interruption losses, and so on).

In some examples, the policy blocks 1110 can include declarative metadata (e.g., eligibility thresholds, entity descriptors, timing parameters) that is incorporated into the composable cyber resilience object 1140 as structured fields and/or configuration parameters used to evaluate conditions and/or modify execution behavior implemented by the coverage blocks 1120. Additionally, the coverage blocks 1120 can include executable functions (e.g., cost processing routines, automated payout handlers, compliance task invocations) that are embedded or linked within the composable cyber resilience object 1140 to facilitate dynamic response actions (e.g., provision of protections) based on posture states or triggering events, rules, conditions stored as metadata of policy blocks 1110. In some implementations, integrating the policy blocks 1110 and coverage blocks 1120 can include assigning references or bindings between declarative conditions and functional code segments such that the composable cyber resilience object 1140 can perform conditional operations and execute protection actions dynamically in response to detected events and/or postures states.

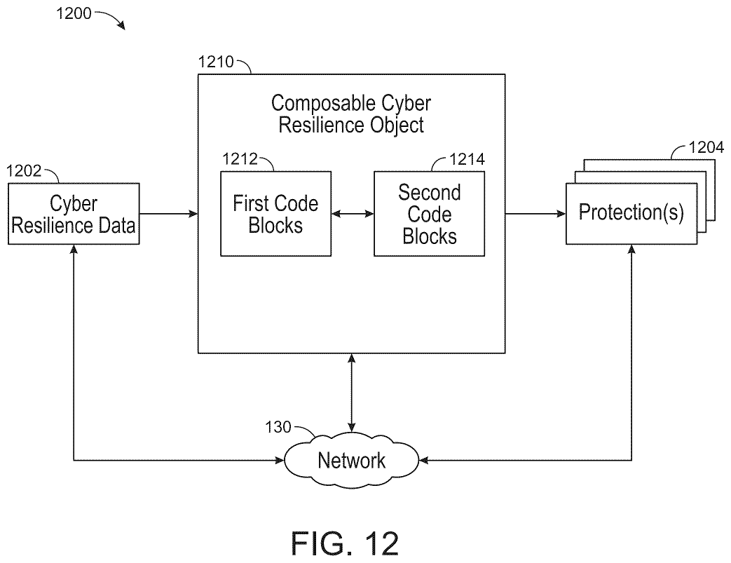

Referring now to FIG. 12, a block diagram of a system 1200 for providing a composable cyber resilience object 1210 is shown, according to some implementations. The implementation shown in FIG. 12 can include composable cyber resilience object 1210, which can include one or more first codes blocks 1212 (e.g., policy blocks) and second code blocks 1214 (e.g., coverage blocks). In some examples, the composable cyber resilience object 1210 can receive and/or otherwise identify cyber resilience data 1202 (e.g., security posture updates, cyber events, etc.) via the network 120 (e.g., using a network or communication interface). In some examples, the composable cyber resilience object 1210 can transmit and/or otherwise provide protection(s) 1204 (e.g., modular coverages) via the network 120. In some implementations, the composable cyber resilience object 1210 can include similar features and/or functionality as described regarding the composable cyber resilience object 1140 of FIG. 11.

In some implementations, the composable cyber resilience object 1210 can receive and/or otherwise identify cyber resilience data 1202 using a control structure (e.g., smart contract) that corresponds with the composable object 1210. For example, the control structure can include executable instructions and/or state logic that reference metadata fields from the first code blocks 1212 and callable functions from the second code blocks 1214. For example, the control structure can be linked with the composable cyber resilience object 1210, entity systems, and/or third party systems via the network 120. In some examples, the control structure of the composable cyber resilience object 1210 can monitor and/or collect cyber resilience data 1202 to identify one or more inputs (e.g., posture data, incident reports, safeguard changes) associated with a computing or networking infrastructure of the entity, and can further update metadata of one or more of the first code blocks 1212 and/or functions of the second code blocks 1214 based on the detected input (e.g., re-generating, re-selecting, and/or repopulating code blocks).

In some implementations, the control structure of the composable cyber resilience object 1210 can identify and/or detect cyber event or posture changes including in cyber resilience data 1202 and can further perform (e.g., cause execution of) one or more functions defined in the second code blocks 1214 based on the cyber event or posture change. That is, the control structure can include and/or otherwise operate as an execution layer linked to the composable cyber resilience object 1210 such that the metadata of the first code blocks 1212 (e.g., declarative blocks or policy blocks) governs or modifies the runtime behavior of the functions within the second code blocks 1214 (e.g., coverage code blocks).

In some implementations, the control structure of the composable cyber resilience object 1210 can provide the protection(s) 1204 using the one or more of the second code blocks 1214 to an entity via network 120. For example, in response to detecting a cyber event or posture change in the cyber resilience data 1202, the control structure can retrieve one or more metadata fields from a first code block 1212 (e.g., coverage threshold, exclusion condition, or effective date) to determine whether the cyber event or posture state qualifies for one or more protections defined by functions of the second code blocks 1214. Based on a result the determination, the control structure of the composable cyber resilience object 1210 can invoke or execute one or more functions defined in one or more of second code blocks 1214 (e.g., applying a payout calculation, logging a compliance alert, or initiating a panel response sequence) to provide the protection(s) 1204. In some implementations, execution of the second code block 1214 can cause the composable cyber resilience object 1210 to transmit protection(s) 1204 (e.g., response data packages, structured response data, triggered coverage data, etc.) via the network 120 to computing infrastructure associated with the entity and/or a third-party provider.

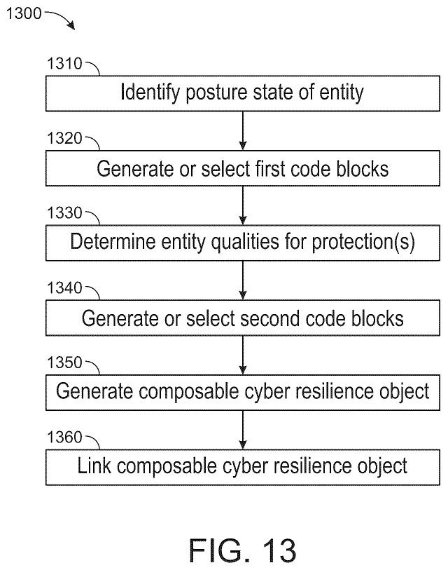

Referring now to FIG. 13, a flowchart of a method 1300 for modeling micro-protections using cyber resilience data and third-party parameters is shown, according to some implementations. In some implementations, one or more systems or components described here (e.g., with respect to FIGS. 1A-1B, FIG. 10, FIG. 11, FIG. 12, etc.) can perform the steps of method 1300. For example, the response system 130 of FIGS. 1A-1B or data processing system 1010 of FIG. 10 can perform one or more of the steps of the method 1300. Additional, fewer, or different operations can be performed depending on the particular implementation. In some implementations, one or more operations of method 1300 can be performed by one or more processors executing on one or more computing devices, systems, or servers. In some implementations, at least one (e.g., each) operation can be re-ordered, added, removed, or repeated.

In a broad overview of method 1300, at block 1310, the one or more processing circuits (e.g., data processing system 1010, etc.) can identify a posture state of an entity. At block 1320, the one or more processing circuits can generate or select first code blocks. At block 1330, the one or more processing circuits can determine the entity qualifies for protection(s). At block 1340, the one or more processing circuits can generate or select second code blocks. At block 1350, the one or more processing circuits can generate a composable cyber resilience object. At block 1360, the one or more processing circuits can link the composable cyber resilience object.

In some implementations, at block 1310, the one or more processing circuits (e.g., data processing system 1010, etc.) can identify and/or otherwise determine a posture state of an entity. In some implementations, at block 1310, the one or more processing circuits (e.g., data processing system 1010, etc.) can identify and/or otherwise determine a posture state of an entity. That is, the processing circuits can aggregate entity data to derive a security measure for the entity. For example, the processing circuits can correlate assets, incidents, and safeguard indicators to generate a posture score. In some implementations, identifying can be performed by executing analysis routines that parse configuration details and incident logs. For example, the processing circuits can read endpoint data and compare it with defined risk criteria. Additionally, the processing circuits can refresh the posture state upon detecting new or updated asset or incident data. For example, the processing circuits can recalculate risk levels when configuration changes are observed.

For example, the method 1300 can include identifying, by one or more processing circuits, a posture state of at least one entity based at least on configurations, assets, incidents, or safeguards of the at least one entity. Identifying can include the data processing system 1010 collecting, retrieving, and/or otherwise receiving input data corresponding with one or more configurations, assets, incidents, or safeguards provided by an entity or generated by one or more systems associated with the entity. For example, the data processing system 1010 can parse and/or analyze data storages and/or deployed security tools to identify a posture state of an entity, or can receive information used for determining the posture state via a submission from the entity (e.g., via a graphical user interface and/or responsive to a protection request). For example, identifying a posture state can include modeling patterns or conditions reflected in the received and/or collected entity data (e.g., configurations, assets, incidents, or safeguards) to generate a score, flag, or structured representation of resilience or readiness of the entity to respond to and/or prevent one or more security threats. That is, the data processing system 1010 can analyze or correlate entity data to determine a posture state that captures a cybersecurity risk or compliance level associated with the entity.

In some implementations, at block 1320, the one or more processing circuits the one or more processing circuits can generate or select and/or otherwise retrieve first code blocks. In some implementations, at block 1320, the one or more processing circuits the one or more processing circuits can generate or select and/or otherwise retrieve first code blocks. That is, the processing circuits can assemble code segments that define coverage parameters aligned with third party requirements. For example, the processing circuits can access a code block library indexed by policy constraints. In some implementations, generating and/or selecting can be performed by invoking routines that query a repository of policy definitions. For example, the processing circuits can retrieve a declarations block based on posture data or third party parameters. Additionally, the processing circuits can populate these blocks with metadata reflecting entity conditions. For example, the processing circuits can insert policy periods, excluded technologies, and/or required safeguards into structured fields.

For example, the method 1300 can include generating or selecting, by the one or more processing circuits, a first plurality of code blocks corresponding with a plurality of parameters of at least one third-party, and the plurality of parameters correspond with one or more rules or conditions for providing at least one protection to the at least one entity. That is, generating can include the data processing system 1010 constructing and/or populating structured code segments with values, constraints, or metadata derived from entity data and third-party data. For example, the one or more processing circuits can generate a declarations block with fields corresponding to policy period, effective dates, or entity identifier values. In some implementations, selecting can include retrieving one or more pre-defined code blocks from a library or data store based on matches between third-party parameters (e.g., third-party requirements for safeguards, compliance thresholds, etc.) and posture state data (e.g., resilience score, deployed configurations). For example, the one or more processing circuits can select an exclusions block that includes one or more exclusion terms defined by the rules or conditions (e.g., parameters) of the third party responsive to determining that exclusions (e.g., using unregistered devices, outdated data protected techniques, and/or geographic restrictions) are indicated and/or reflected by the posture state.

In some implementations, at block 1330, the one or more processing circuits can determine and/or otherwise identify the entity qualifies for protection(s). In some implementations, at block 1330, the one or more processing circuits can determine and/or otherwise identify the entity qualifies for protection(s). That is, the processing circuits can compare posture metrics to thresholds defined in the retrieved policy blocks. For example, the processing circuits can verify that encryption and patching satisfy listed prerequisites. In some implementations, determining can be performed by matching entity attributes against exclusion or condition fields derived from third party rules. For example, the processing circuits can confirm coverage if the entity meets a specified risk tolerance. Additionally, the processing circuits can classify coverage tiers according to the posture data outcome. For example, the processing circuits can categorize an entity as eligible for ransomware coverage based on validated safeguards.

For example, the method 1300 can include determining, by the one or more processing circuits, the at least one entity qualifies for the at least one protection based on the posture state and the one or more rules or conditions. That is, the data processing system 1010 can evaluate posture state data of the entity (e.g., safeguard status indicators, incident flags, configuration metrics) in relation to the third-party parameters associated with the one or more rules or conditions. For example, the data processing system 1010 can reference eligibility fields encoded in one or more first code blocks (e.g., conditions block or exclusions block) and determine that the posture state meets a defined threshold, matches a safeguard status, or does not conflict with a rule or condition that corresponds with one or more protections (e.g., coverages defined by second code blocks) available to the entity. In some examples, qualifying for a protection can include identifying that the posture reflects use of designated safeguards (e.g., encryption protocols, identity access management systems), operational metrics (e.g., patch frequency, uptime records), and/or compliance history aligned with the parameters defined by a third party. In some implementations, determining the entity qualifies for the protections can include selecting one or more coverage types that correspond to protections for which the entity meets the qualifying posture criteria.

In some implementations, at block 1340, the one or more processing circuits can generate or select and/or otherwise retrieve second code blocks. In some implementations, at block 1340, the one or more processing circuits can generate or select and/or otherwise retrieve second code blocks. That is, the processing circuits can create coverage modules that include executable functions for handling incidents. For example, the processing circuits can retrieve an extortion block containing logic for processing ransom-related disbursements. In some implementations, generating and/or selecting can be performed by referencing a coverage function library mapped to each protection scenario. For example, the processing circuits can load a regulatory coverage block when posture indicates relevant compliance data. Additionally, the processing circuits can adapt these coverage blocks to match posture or risk conditions. For example, the processing circuits can adjust function parameters in the extortion block if advanced encryption protocols are detected.

For example, the method 1300 can include generating or selecting, by the one or more processing circuits, a second plurality of code blocks including one or more functions to provide the at least one protection based on the one or more rules or conditions. That is, the data processing system 1010 can construct or retrieve code blocks that include executable functions for performing protection-related actions (e.g., loss reimbursement, data restoration, incident handling, compliance verification). For example, the data processing system 1010 can generate a code block that includes a function for initiating financial disbursement actions based on entity claims or a function for launching a data recovery process according to restoration parameters defined in the first and/or second code blocks. For example, the data processing system 1010 can generate a coverage block that includes one or more functions corresponding with an identified protection, such as a regulatory coverage function for assessing penalty coverage amounts, or an extortion coverage function for initiating response actions tied to ransom demands. Additionally, selecting can include the one or more processing circuits identifying coverage blocks associated with protections for which the entity qualifies and retrieving the corresponding blocks and included functions (e.g., protection action logic) based on the rules or conditions defined in the generated or selected first code blocks.

In some implementations, at block 1350, the one or more processing circuits can generate and/or otherwise build or populate a composable cyber resilience object. In some implementations, at block 1350, the one or more processing circuits can generate and/or otherwise build or populate a composable cyber resilience object. That is, the processing circuits can compile selected policy blocks and coverage blocks into a unified data construct. For example, the processing circuits can embed references to functional code segments within a serialized object. In some implementations, generating and/or building can be performed by executing routines that merge declarative fields and coverage functions into a single entity. For example, the processing circuits can produce an assembled artifact that contains policy metadata and callable coverage methods. Additionally, the processing circuits can link coverage triggers to policy constraints within the composable object. For example, the processing circuits can store condition checks in the object that dynamically invoke coverage logic upon posture changes.

For example, the method 1300 can include generating, by the one or more processing circuits, the composable cyber resilience object, and generating include integrating at least a portion of the first plurality of code blocks and the second plurality of code blocks into at least one data structure corresponding with one or more functions or fields of the composable cyber resilience object. For example, the data processing system 1010 can generate a composable cyber resilience object by constructing a structured data object (e.g., serialized object, typed container, compiled bundle) that integrates the first plurality of code blocks (e.g., policy blocks defining declarative metadata such as coverage terms, exclusions, or conditions) and the second plurality of code blocks (e.g., coverage blocks defining executable functions for performing protection actions). That is, generating can include embedding metadata fields from the first plurality of code blocks into fields of the object and linking those fields with callable functions from the second plurality of code blocks to perform protection-related operations. Additionally, the composable cyber resilience object can include references or bindings that associate individual functions of the second code blocks with governing terms or attributes from the first code blocks such that execution behavior is dynamically modifiable based on the embedded policy data (e.g., modifying metadata or attributes of the first code blocks can change how functions of the second code blocks execute and/or prompt re-generation or re-selection of one or more second code blocks, as described further herein).

In some implementations, at block 1360, the one or more processing circuits can link and/or otherwise associate the composable cyber resilience object. In some implementations, at block 1360, the one or more processing circuits can link and/or otherwise associate the composable cyber resilience object. That is, the processing circuits can establish a communication interface to integrate the composable object with the entity infrastructure. For example, the processing circuits can configure a network channel for transmitting posture updates to the composable object. In some implementations, generating and/or selecting can be performed by applying deployment procedures that associate object references with targeted systems. For example, the processing circuits can attach an identifier to each endpoint to synchronize coverage operations. Additionally, the processing circuits can transmit or receive data that triggers coverage workflows within the composable object. For example, the processing circuits can send an incident alert to invoke an automated response defined in a coverage block.

For example, the method 1300 can include linking, by the one or more processing circuits, the composable cyber resilience object and at least one computing or networking infrastructure of the at least one entity using a communication interface or structure. That is, linking can include the data processing system 1010 establishing a communicative association (e.g., data channel or feed) between the composable cyber resilience object and one or more systems or devices of the computing or networking infrastructure of the entity (e.g., systems or environments corresponding with the configurations, assets, incidents, or safeguards of the entity). For example, the one or more processing circuits can transmit data representing the composable cyber resilience object, a reference to the object, and/or related metadata to the network infrastructure of the entity using the communication interface or structure to deploy and/or activate the composable cyber resilience object. In some implementations, the one or more processing circuits can configure the composable cyber resilience object to receive cyber resilience data or provide protection(s) to the computing or networking infrastructure via the established link with the communication interface or structure (e.g., transmitting posture state updates, receiving incident notifications, or providing outputs from coverage functions). For example, the communication interface or structure can include one or more programmatic interfaces, API endpoints, socket connections, or service connections that can be used to transmit entity data, third-party data, requests, messages, responses, and/or protections between the composable cyber resilience object and the entity network.

In some implementations, the at least one data structure corresponds with at least one control structure. For example, the data structure (e.g., cyber resilience object) can include and/or be linked to a control structure (e.g., smart contract). That is, the control structure can include a rule-based or programmatically-executable set of instructions that governs the behavior of the composable cyber resilience object based on defined conditions, logic expressions, and embedded metadata. In some examples, the control structure can operate as a smart contract that is instantiated, stored, and/or executed within a distributed computing environment, and can include logic for evaluating policy terms, triggering conditional actions, and/or coordinating execution of protection-related functions based on changes in posture state or received incident data. That is, the control structure can function as an execution layer or state machine that interprets and applies declarative logic (e.g., from first code blocks) and coordinates function calls (e.g., from second code blocks) within a modular cyber resilience framework.

In some implementations, integrating at least a portion of the first plurality of code blocks and the second plurality of code blocks into the at least one data structure includes generating, by the one or more processing circuits, the at least one control structure configured to update metadata of the first plurality of code blocks and perform the one or more functions of the second plurality of code blocks based at least on the metadata. For example, the one or more processing circuits can generate a control structure that includes logic for parsing, modifying, or replacing metadata fields encoded within the first plurality of code blocks (e.g., policy blocks), and for invoking or executing one or more functions included in the second plurality of code blocks (e.g., coverage blocks). For example, the one or more processing circuits can generate a control structure that includes executable instructions for retrieving and modifying metadata associated with one or more policy blocks (e.g., coverage terms, compliance indicators, or eligibility flags). Additionally, the control structure can include function handlers or execution bindings for calling one or more protection functions associated with one or more of the second code blocks. That is, the one or more processing circuits can generate logic or instructions for the control structure such that an update to metadata of the first plurality of code blocks can dynamically affect which functions of the second code blocks are performed and/or how the functions are executed (e.g., by adjusting or modifying protection data packages, workflows, qualifications, coverages, payout amounts, and/or other protection actions provided via the functions).

In some implementations, integrating at least a portion of the first plurality of code blocks and the second plurality of code blocks into the at least one data structure includes identifying, by the one or more processing circuits using the at least one control structure, at least one of (i) an update to the metadata or the one or more functions or (ii) a cyber event or incident corresponding with the at least one computing or networking infrastructure of the at least one entity. For example, the one or more processing circuits can cause execution of logic of the control structure to monitor input data sources for changes to metadata fields of the first plurality of code blocks (e.g., updated coverage attributes, safeguard indicators, or compliance states) and/or changes to the availability or configuration of the second plurality of code blocks (e.g., modified or newly available protection functions). Additionally, the one or more processing circuits can cause execution of logic of the control structure to detect cyber events or incidents associated with the qualified protections based on posture data, incident logs, telemetry data, and/or other information associated with the computing or networking infrastructure of the entity.

In some implementations, in response to identifying the at least one of (i) the update to the metadata or the one or more functions or (ii) the cyber event or incident, the method 1300 can include updating, using the at least one control structure, the metadata of the first plurality of code blocks or the one or more functions. For example, the one or more processing circuits can execute logic defined by the control structure to modify policy-related data stored in the first plurality of code blocks (e.g., adjusting a safeguard status, coverage term, or eligibility condition) based on input indicating a posture state change or triggered event. In some examples, updating can include overwriting, adding, or adjusting metadata fields of first code blocks that govern evaluation or execution behaviors of the composable cyber resilience object, or adjusting function parameters (e.g., execution triggers, workflows, etc.) of second code blocks that perform protection actions based on at least one of the update to the metadata or the one or more functions or the cyber event or incident.

In some implementations, in response to identifying the at least one of (i) the update to the metadata or the one or more functions or (ii) the cyber event or incident, the method 1300 can include performing, using the at least one control structure, at least one function of the one or more functions to provide the at least one protection based on the metadata of the first plurality of code blocks. For example, the one or more processing circuits can perform one or more functions of the second plurality of code blocks by executing protection logic that corresponds to the metadata of the first plurality of code blocks (e.g., updated eligibility fields, modified safeguard requirements, or coverage terms) using a control structure or smart contract layer linked with the code blocks. For example, performing the one or more functions can include executing one or more operations to facilitate transmission, delivery, and/or deployment of a ransomware protection data package in response to a detected encryption-based intrusion, a fault protection data package in response to a system integrity failure, or an interruption protection data package in response to a service degradation fault, downtime event fault, and/or any other operational error or fault type. In some examples, performing the one or more functions can include the data processing system 1010 invoking functions or callable methods defined in the second plurality of code blocks to initiate remediation actions, allocate resources, and/or trigger workflows based on an identified incident type or posture state. Additionally, performing can include retrieving parameters from the first plurality of code blocks to determine execution scope or constraints (e.g., policy period limits, indemnification caps, in-network provider restrictions) for the functions and applying the retrieved parameters to the executed function logic. That is, the one or more processing circuits can cause execution of the one or more functions of the second code blocks in accordance with the metadata defined in the first code blocks.

In some implementations, the method 1300 can include generating, by the one or more processing circuits, a ledger record corresponding with the metadata of the first plurality of code blocks or the at least one function. For example, the data processing system 1010 can generate a structured record that includes representations of one or more fields, values, or state changes associated with the policy blocks (e.g., coverage terms, exclusions, safeguard inventory status, asset registration status) and/or performance data related to one or more functions of the coverage blocks (e.g., function calls, execution outcomes, trigger events). In some implementations, generating the ledger record can include generating data representing a state of the composable cyber resilience object at a given time (e.g., including changes to coverage eligibility, modification timestamps, or metadata). In some examples, the ledger record can incorporate function execution data, such as action identifiers, confidence levels, or event-response mappings that correspond to detection of a posture change or cyber event. Additionally, the data processing system 1010 can append a digital signature, certificate, or cryptographic digest to the ledger record to support verification of the provenance, authenticity, or temporal integrity of the ledger record in a distributed or external system (e.g., blockchain). In some implementations, the ledger record can include links to prior state entries, associated entity identifiers, and/or references to control structures.

In some implementations, the method 1300 can include recording, by the one or more processing circuits, the ledger record to a distributed ledger or data source. For example, the data processing system 1010 can transmit the ledger record to a distributed ledger network (e.g., blockchain or permissioned ledger) or to an external or internal data source associated with the composable cyber resilience object. In some examples, recording can include committing the ledger record as a transaction to a blockchain or storing the ledger record as an entry in a version-controlled data store, log stream, or audit database. In some implementations, recording the ledger record can include associating the ledger record with a time of recording, data of the current state of the composable cyber resilience object, and/or a reference identifier of the computing or networking infrastructure associated with the entity. Additionally, the data processing system 1010 can initiate a confirmation or consensus process with nodes of a distributed ledger to verify integrity of the ledger record prior to finalization and/or storage. In some examples, the one or more processing circuits can store the ledger record in an append-only sequence of records representing a lifecycle or history of protections associated with the composable cyber resilience object and/or entity.

In some implementation, the first plurality of code blocks can include at least a declarations block, and the method 1300 can include receiving, by the one or more processing circuits using the communication interface or structure, an update corresponding with the one or more rules or conditions or the at least one computing or networking infrastructure of the at least one entity. For example, the data processing system 1010 can receive an update from an internal or external source, such as a third-party data provider, entity interface, or monitoring tool. In some examples, the update can include a modification to one or more rules or conditions for providing protections (e.g., revised thresholds, eligibility changes, or amended coverage criteria) or can reflect changes to the computing or networking infrastructure of the entity (e.g., deployment of new safeguards, decommissioned assets, or detected configuration changes). In some arrangements, receiving the update can include the data processing system 1010 using the link with the communication interface or structure to detect and/or ingest data from the entity network. In some implementations, receiving the update can include the one or more processing circuits receiving updated rules or conditions (e.g., third party parameters) from third party computing system(s) and prompting the entity for a response (e.g., updated data) associated with the updated rules or conditions.

In some implementations, the method 1300 can include updating, by the one or more processing circuits, the composable cyber resilience object by (i) updating metadata of the declarations block and (ii) re-generating the second plurality of code blocks based at least on the declarations block. For example, the data processing system 1010 can update one or more metadata fields of the declarations block to reflect revised parameters, values, or entity information received via the communication interface or structure. For example, updating metadata of the declarations block can include modifying data representing policy period, premium type, jurisdiction, asset inventory, safeguard status, or third-party compliance references. That is, the updated metadata can reflect an updated status of the entity based on posture data, eligibility updates, or modified coverage conditions linked to the updated rules or infrastructure. In some implementations, re-generating the second plurality of code blocks based at least on the declarations block can include the one or more processing circuits dynamically constructing, replacing, or re-selecting coverage blocks based on the updated metadata of the declarations block. For example, the data processing system 1010 can identify that the updated declarations metadata triggers a change in qualified protections (e.g., due to a new safeguard being deployed or a compliance flag being cleared), and in response, can re-generate the second code blocks with updated executable functions, coverage types, or trigger logic. In some examples, re-generating can include modifying functional parameters (e.g., thresholds, execution paths), selecting alternative logic modules from a protection library, or deactivating outdated coverage functions no longer aligned with updated declarations.

In some implementations, the second plurality of code blocks can include one or more coverage blocks, and the one or more coverage blocks correspond with at least one agreement by the at least one third-party to provide the at least one protection and include at least one function of the one or more functions. For example, the one or more processing circuits can generate or select one or more coverage blocks that are associated with third-party agreements governing the provision of the at least one protection. In some implementations, at least one (e.g., each) of the one or more coverage blocks can include at least one function that performs a protection-related operation in accordance with the parameters or commitments defined by the third-party agreement. That is, the one or more coverage blocks can be selected or generated in accordance with a determination that the at least one entity qualifies for a protection corresponding with a third-party agreement, and the coverage block can include executable logic for fulfilling at least one protection action (e.g., triggering a payout condition, initiating a compliance review, or generating a response record) based on the one or more rules or conditions used to determine coverage eligibility.

In some implementations, the method 1300 can include performing, by the one or more processing circuits, the at least one function, wherein performing causes the one or more coverage blocks to provide at least one of a ransomware protection data package, a fault protection data package, or an interruption protection data package to the at least one computing or networking infrastructure using the communication interface or structure. For example, performing the at least one function can include executing protection logic encoded in the one or more coverage blocks based at least on metadata from the first plurality of code blocks and identified posture data to transmit and/or deploy a protection data package to the computing or networking infrastructure. That is, the one or more processing circuits can invoke a function associated with a coverage block that causes provision of a protection data package in response to detected posture changes, incidents, or conditions reflected in the entity data.

For example, a ransomware protection data package can include data and/or instructions for initiating technical or procedural countermeasures, such as invoking a decryption recovery routine, generating a notification or alert, triggering access restrictions, or activating a predefined incident response process. A fault protection data package can include remediation workflows or configuration patches to correct or mitigate the impact of detected hardware, software, or system faults. An interruption protection data package can include redirection logic, failover parameters, or service restoration steps to resume or stabilize operations following a disruption or downtime condition. In some examples, providing the protection data package can include transmitting the relevant information to a designated system component, triggering execution on a local or remote system, or updating system states to reflect activation of the protection on the entity network. Additionally, at least one (e.g., each) protection data package can be defined or selected based on metadata fields from the first code blocks (e.g., eligibility rules, conditions, scope of coverage) and/or posture data of the entity.

In some implementations, the first plurality of code blocks include at least an exclusion block, and the method 1300 can include determining, by the one or more processing circuits using the exclusion block, a restriction or limitation corresponding with providing the at least one protection based on modeling the configurations, assets, incidents, or safeguards of the at least one entity and the plurality of parameters of the at least one third-party. For example, the data processing system 1010 can evaluate and/or extract metadata from the exclusion block to identify one or more conditions or attributes associated with the entity or the entity infrastructure that conflict with parameters or align with restrictions defined by the at least one third-party (e.g., location-based restrictions, unsupported configurations, or safeguard deficiencies). That is, determining a restriction or limitation can include correlating posture data and third-party parameters with one or more exclusion criteria encoded in the exclusion block to determine that at least one protection can be limited, withheld, restricted, or conditioned based on a detected misalignment and/or other limitation. In some examples, the data processing system 1010 can perform modeling operations using current configuration or incident data to flag violations, restrictions, or exclusion, or to apply logic for selectively removing or deactivating protections from the composable cyber resilience object that can be otherwise available to the entity.

In some implementations, the method 1300 can include updating, by the one or more processing circuits, the composable cyber resilience object by (i) updating metadata of the exclusion block and (ii) re-generating the second plurality of code blocks based on the restriction or limitation. For example, the data processing system 1010 can modify one or more metadata fields of the exclusion block to reflect an identified restriction or limitation determined using posture data, third-party parameters, or exclusion conditions (e.g., adding a flag for geographic ineligibility, adjusting a field for unsupported vendor services, or appending exclusion reasoning linked to incident frequency or compliance status). That is, updating the metadata of the exclusion block can include adjusting declarative indicators that inform or constrain which protections can be included in or executed by the composable cyber resilience object. Additionally, re-generating the second plurality of code blocks based on the restriction or limitation can include the one or more processing circuits, modifying, replacing, omitting, and/or otherwise adjusting one or more coverage blocks in view of the updated exclusion metadata. In some examples, the data processing system 1010 can remove functions or blocks or update definitions that correspond to restricted protections, select alternative protection logic aligned with the updated conditions, or replace executable code blocks with modified blocks reflecting a reduced or adjusted scope of protection.

In some implementations, the first plurality of code blocks include at least a conditions block, and the method 1300 can include transmitting, by the one or more processing circuits using the conditions block, one or more compliance requests to the at least one computing or networking infrastructure of the at least one entity. For example, the data processing system 1010 can identify one or more compliance-related rules or conditions encoded in the conditions block (e.g., safeguard implementation standards, asset registration criteria, monitoring thresholds, etc.) and generate compliance requests that prompt the entity to submit data and/or confirm compliance status. In some examples, transmitting the compliance requests can include the one or more processing circuits transmitting or dispatching queries, validation prompts, or assessment messages via the communication interface or structure to collect posture data and/or cyber resilience data from components of the entity infrastructure. That is, the data processing system 1010 can transmit one or more compliance requests to initiate confirmation of configurations, assets, incidents, or safeguards to determine whether one or more parameters or requirements (e.g., third party parameters) for coverage remain satisfied.

In some implementations, the method 1300 can include updating, by the one or more processing circuits based on at least one response to the one or more compliance requests, the one or more rules or conditions for providing the at least one protection by updating metadata of the conditions block, wherein the at least one response to the one or more compliance requests includes compliance data corresponding with the configurations, assets, incidents, or safeguards of the at least one entity. For example, the data processing system 1010 can parse the received compliance data and update one or more metadata fields of the conditions block to reflect the current status of the entity infrastructure. In some examples, updating metadata of the conditions block can include the one or more processing circuits adjusting and/or otherwise modifying indicators or entries that govern or control an evaluation of compliance with third-party parameters (e.g., updating a field representing safeguard deployment confirmation, amending a timestamp reflecting the last patch cycle, or inserting a flag indicating resolution of a previously reported incident). That is, the data processing system 1010 can update the metadata of the conditions block such that subsequent determinations regarding eligibility for the at least one protection are based on an updated compliance state aligned with the configurations, assets, incidents, or safeguards associated with the entity.

In some implementations, the method 1300 can include configuring, by the one or more processing circuits using the conditions block, one or more additional compliance requests for the at least one entity based the plurality of parameters or the at least one response to the one or more compliance requests. For example, the data processing system 1010 can identify one or more attributes, fields, or values stored as metadata of the conditions block based on the previously received compliance data. In some implementations, configuring one or more additional compliance requests can include the one or more processing circuits generating one or more follow-up prompts, queries, or validation messages corresponding with updated or unresolved information derived from the posture data, third-party parameters, or previously received response data. For example, the data processing system 1010 can identify that the previously received compliance data indicates deployment of a safeguard without confirming associated monitoring or audit functionality, and in response, can configure an additional compliance request to obtain configuration values, timestamps, or audit trail indicators associated with the safeguard. That is, the data processing system 1010 can analyze the metadata of the conditions block and initiate a refined compliance request process by generating one or more follow-up requests linked to posture data or third-party parameters not confirmed by initial response data.

In some implementations, the method 1300 can include receiving, by the one or more processing circuits using the communication interface or structure, one or more updated configurations, assets, incidents, or safeguards of the at least one entity. For example, the data processing system 1010 can receive updated entity data, posture data, and/or compliance data indicating a current state of one or more entity systems or components in response to entity input, dynamic monitoring of the entity infrastructure, and/or previously transmitted compliance requests. In some implementations, the method 1300 can include modeling, by the one or more processing circuits, the one or more updated configurations, assets, incidents, or safeguards to determine an updated security posture. For example, the data processing system 1010 can analyze posture data received from the computing or networking infrastructure of the entity to compute an updated representation of cyber resilience. That is, modeling can include the one or more processing circuits analyzing and/or otherwise evaluating relationships between posture inputs and third party parameters to identify changes in risk exposure, operational readiness, or alignment with one or more protections. In some implementations, modeling can include the data processing system 1010 applying one or more transformation, scoring, or classification operations to generate an updated posture state derived from the received input data. That is, the data processing system 1010 can model the updated configurations, assets, incidents, or safeguards in relation to third-party parameters to determine whether the updated security posture reflects a change in qualification or scope for one or more protections.

In some implementations, the method 1300 can include updating, by the one or more processing circuits, the composable cyber resilience object by (i) updating metadata of the first plurality of code blocks and (ii) re-generating or re-selecting the second plurality of code blocks based on the updated security posture. For example, the data processing system 1010 can update one or more metadata fields encoded in the first plurality of code blocks to reflect changes in configurations, assets, incidents, or safeguards of the entity. In some implementations, the re-generated, re-selected, or updated metadata can include declarative indicators, flags, or structured values that correspond with posture data or entity attributes modeled by the data processing system 1010. For example, re-generating the second plurality of code blocks can include the data processing system 1010 constructing new coverage blocks that include updated protection functions or adjusted execution logic based on the updated posture state, such as modified safeguard coverage limits, added incident response handlers, or revised payout conditions. For example, re-selecting the second plurality of code blocks can include the data processing system 1010 removing one or more coverage blocks and identifying one or more pre-existing coverage blocks from a library or policy rule map that correspond with the updated metadata, and retrieving the matching coverage blocks based on alignment with updated eligibility indicators or third-party parameters.

In some implementations, the method 1300 can include determining, by the one or more processing circuits, the at least one entity qualifies for the at least one protection based on modeling a cyber resilience of the at least one computing or networking infrastructure using one or more of the configurations, assets, incidents, or safeguards and the plurality of parameters of the at least one third-party. For example, the data processing system 1010 can model a cyber resilience state by aggregating posture data (e.g., system configurations, asset inventories, incident logs, and deployed safeguards) and applying one or more comparison, scoring, or matching operations to determine whether the aggregated data satisfies thresholds, rules, or dependencies defined by a cybersecurity platform and/or a third-party provider. In some examples, modeling cyber resilience can include the one or more processing circuits determining a numerical cyber resilience metric based on weighted attributes of the infrastructure (e.g., presence of patches, incident frequency, safeguard coverage) and comparing the metric to a qualification level used to determine eligibility for one or more protections. In other examples, modeling can include the data processing system 1010 comparing entity posture data and third-party criteria to confirm the presence of expected safeguards, absence of disqualifying events, or alignment with temporal, geographic, or configuration-based parameters (e.g., encryption standards). In some implementations, determining that the entity qualifies can include the one or more processing circuits assigning a pass/fail score, a metric, and/or an indicator to one or more protections based on the modeling outcome.

In some implementations, linking the composable cyber resilience object to the at least one computing or networking infrastructure at block 1360 can include identifying, by the one or more processing circuits, at least one resource of the at least one computing or networking infrastructure using the communication interface or structure, wherein the at least one resource corresponds to at least one of the configurations, assets, incidents, or safeguards of the at least one entity. For example, the data processing system 1010 can identify one or more resources of the entity infrastructure by retrieving configuration records, scanning network endpoints, querying asset inventories, or parsing incident reports. In some examples, a resource can include a virtual machine, storage volume, software module, endpoint device, or network node associated with the computing infrastructure of the entity. In other examples, a resource can include a configuration file, log stream, incident record, or safeguard setting that reflects operational or security posture of the entity infrastructure. In some implementations, identifying the resource can include determining a link or association between one or more fields of the composable cyber resilience object (e.g., metadata fields, coverage identifiers) and one or more components of the entity infrastructure, such that a protection can be applied, monitored, or triggered in relation to and/or based on the identified resource.

In some implementations, linking the composable cyber resilience object to the at least one computing or networking infrastructure at block 1360 can include storing, by the one or more processing circuits, in a distributed ledger or data source corresponding with the at least one computing or networking infrastructure, at least one of an identifier or metadata corresponding with the composable cyber resilience object in association with the at least one resource. For example, the data processing system 1010 can store an identifier that references the composable cyber resilience object, such as a hash value, object label, or pointer to a code structure, and associate that identifier with a resource corresponding with a configuration, asset, incident, or safeguard of the entity. In some implementations, storing can include writing an entry to a distributed ledger or other data source that links the composable cyber resilience object to the identified resource by associating object metadata (e.g., coverage status, version information, or control structure references) with resource-related data. That is, the one or more processing circuits can generate a record that preserves the relationship between the composable cyber resilience object and the underlying entity infrastructure to facilitate dynamic tracking, auditability, or policy enforcement related to one or more protections.

### Configuration of Exemplary Implementations

While this specification contains many specific implementation details, these cannot be construed as limitations on the scope of any of what can be claimed, but rather as descriptions of features specific to particular implementations of the systems and methods described herein. Certain features that are described in this specification in the context of separate implementations can also be implemented and/or arranged in combination in a single implementation. Conversely, various features that are described in the context of a single implementation can also be implemented and arranged in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Additionally, features described with respect to particular headings can be utilized with respect to and/or in combination with illustrative implementations described under other headings; headings, where provided, are included solely for the purpose of readability and cannot be construed as limiting any features provided with respect to such headings.

Similarly, while operations are depicted in the drawings in a particular order, this cannot be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing can be advantageous. Moreover, the separation of various system components in the implementations described above cannot be understood as requiring such separation in all implementations, and it can be understood that the described program components and systems can generally be integrated together in a single software product or packaged into multiple software products.

Having now described some illustrative implementations, it is apparent that the foregoing are illustrative and not limiting, having been presented by way of example. In particular, although many of the examples presented herein include specific combinations of method acts or system elements, those acts, and those elements can be combined in other ways to accomplish the same objectives. Acts, elements and features discussed only in connection with one implementation are not intended to be excluded from a similar role in other implementations.

The phraseology and terminology used herein is for the purpose of description and cannot be regarded as limiting. The use of “including” “including” “having” “containing” “including” “characterized by” “characterized in that” and variations thereof herein, is meant to encompass the items listed thereafter, equivalents thereof, and additional items, as well as alternate implementations consisting of the items listed thereafter exclusively. In one arrangement, the systems and methods described herein consist of one, each combination of more than one, or all of the described elements, acts, or components.

Any references to implementations or elements or acts of the systems and methods herein referred to in the singular can also embrace implementations including a plurality of these elements or acts, and any references in plural to any implementation or element or act herein can also embrace implementations including only a single element or act. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation, and references to “an implementation.” “some implementations,” “an alternate implementation,” “various implementations.” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the implementations disclosed herein.

References to “and,” “or,” and “and/or” can be construed as inclusive so that any terms described using “and,” “or,” and “and/or” can indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein can be embodied in other specific forms without departing from the characteristics thereof. Although the examples provided herein relate to controlling the display of content of information resources, the systems and methods described herein can include applied to other environments. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for providing a composable cyber resilience object, the method comprising:
identifying, by one or more processing circuits, a posture state of at least one entity based at least on configurations, assets, incidents, or safeguards of the at least one entity;
generating or selecting, by the one or more processing circuits, a first plurality of code blocks corresponding with a plurality of parameters of at least one third-party, wherein the plurality of parameters correspond with one or more rules or conditions for providing at least one protection to the at least one entity;
determining, by the one or more processing circuits, the at least one entity qualifies for the at least one protection based on the posture state and the one or more rules or conditions;
generating or selecting, by the one or more processing circuits, a second plurality of code blocks comprising one or more functions to provide the at least one protection based on the one or more rules or conditions;
generating, by the one or more processing circuits, the composable cyber resilience object, wherein generating comprises integrating at least a portion of the first plurality of code blocks and the second plurality of code blocks into at least one data structure corresponding with one or more functions or fields of the composable cyber resilience object; and
linking, by the one or more processing circuits, the composable cyber resilience object and at least one computing or networking infrastructure of the at least one entity using a communication interface or structure.

2. The method of claim 1, wherein the at least one data structure corresponds with at least one control structure, and wherein integrating at least a portion of the first plurality of code blocks and the second plurality of code blocks into the at least one data structure comprises:
generating, by the one or more processing circuits, the at least one control structure configured to update metadata of the first plurality of code blocks and perform the one or more functions of the second plurality of code blocks based at least on the metadata; and
identifying, by the one or more processing circuits using the at least one control structure, at least one of (i) an update to the metadata or the one or more functions or (ii) a cyber event or incident corresponding with the at least one computing or networking infrastructure of the at least one entity.

3. The method of claim 2, comprising:
in response to identifying the at least one of (i) the update to the metadata or the one or more functions or (ii) the cyber event or incident:
updating, by the one or more processing circuits, using the at least one control structure, the metadata of the first plurality of code blocks or the one or more functions; or
performing, by the one or more processing circuits, using the at least one control structure, at least one function of the one or more functions to provide the at least one protection based on the metadata of the first plurality of code blocks;
generating, by the one or more processing circuits, a ledger record corresponding with the metadata of the first plurality of code blocks or the at least one function; and
recording, by the one or more processing circuits, the ledger record to a distributed ledger or data source.

4. The method of claim 1, wherein the first plurality of code blocks comprise at least a declarations block, and the method comprising:
receiving, by the one or more processing circuits using the communication interface or structure, an update corresponding with the one or more rules or conditions or the at least one computing or networking infrastructure of the at least one entity; and
updating, by the one or more processing circuits, the composable cyber resilience object by (i) updating metadata of the declarations block and (ii) re-generating the second plurality of code blocks based at least on the declarations block.

5. The method of claim 1, wherein the second plurality of code blocks comprise one or more coverage blocks, the one or more coverage blocks corresponding with at least one agreement by the at least one third-party to provide the at least one protection and comprising at least one function of the one or more functions, and the method comprising:
performing, by the one or more processing circuits, the at least one function, wherein performing causes the one or more coverage blocks to provide at least one of a ransomware protection data package, a fault protection data package, or an interruption protection data package to the at least one computing or networking infrastructure using the communication interface or structure.

6. The method of claim 1, wherein the first plurality of code blocks comprise at least an exclusion block, and the method comprising:
determining, by the one or more processing circuits using the exclusion block, a restriction or limitation corresponding with providing the at least one protection based on modeling the configurations, assets, incidents, or safeguards of the at least one entity and the plurality of parameters of the at least one third-party; and
updating, by the one or more processing circuits, the composable cyber resilience object by (i) updating metadata of the exclusion block and (ii) re-generating the second plurality of code blocks based on the restriction or limitation.

7. The method of claim 1, wherein the first plurality of code blocks comprise at least a conditions block, and the method comprising:
transmitting, by the one or more processing circuits using the conditions block, one or more compliance requests to the at least one computing or networking infrastructure of the at least one entity;
updating, by the one or more processing circuits based on at least one response to the one or more compliance requests, the one or more rules or conditions for providing the at least one protection by updating metadata of the conditions block, wherein the at least one response to the one or more compliance requests comprises compliance data corresponding with the configurations, assets, incidents, or safeguards of the at least one entity; and
configuring, by the one or more processing circuits using the conditions block, one or more additional compliance requests for the at least one entity based the plurality of parameters or the at least one response to the one or more compliance requests.

8. The method of claim 1, comprising:
receiving, by the one or more processing circuits using the communication interface or structure, one or more updated configurations, assets, incidents, or safeguards of the at least one entity;
modeling, by the one or more processing circuits, the one or more updated configurations, assets, incidents, or safeguards to determine an updated security posture; and
updating, by the one or more processing circuits, the composable cyber resilience object by (i) updating metadata of the first plurality of code blocks and (ii) re-generating or re-selecting the second plurality of code blocks based on the updated security posture.

9. The method of claim 1, comprising:
determining, by the one or more processing circuits, the at least one entity qualifies for the at least one protection based on modeling a cyber resilience of the at least one computing or networking infrastructure using one or more of the configurations, assets, incidents, or safeguards and the plurality of parameters of the at least one third-party.

10. The method of claim 1, wherein linking the composable cyber resilience object to the at least one computing or networking infrastructure comprises:
identifying, by the one or more processing circuits, at least one resource of the at least one computing or networking infrastructure using the communication interface or structure, wherein the at least one resource corresponds to at least one of the configurations, assets, incidents, or safeguards of the at least one entity; and
storing, by the one or more processing circuits, in a distributed ledger or data source corresponding with the at least one computing or networking infrastructure, at least one of an identifier or metadata corresponding with the composable cyber resilience object in association with the at least one resource.

11. A system for providing a composable cyber resilience object, the system comprising:
one or more processing circuits configured to:
identify a posture state of at least one entity based at least on configurations, assets, incidents, or safeguards of the at least one entity;
generate or select a first plurality of code blocks corresponding with a plurality of parameters of at least one third-party, wherein the plurality of parameters correspond with one or more rules or conditions for providing at least one protection to the at least one entity;
determine at least one entity qualifies for the at least one protection based on the posture state and the one or more rules or conditions;
generate or select a second plurality of code blocks comprising one or more functions to provide the at least one protection based on the one or more rules or conditions;
generate the composable cyber resilience object, wherein generating comprises integrating at least a portion of the first plurality of code blocks and the second plurality of code blocks into at least one data structure corresponding with one or more functions or fields of the composable cyber resilience object; and
link the composable cyber resilience object and at least one computing or networking infrastructure of the at least one entity using a communication interface or structure.

12. The system of claim 11, wherein the at least one data structure corresponds with at least one control structure, and wherein to integrate at least a portion of the first plurality of code blocks and the second plurality of code blocks into the at least one data structure, the one or more processing circuits to:
generate the at least one control structure configured to update metadata of the first plurality of code blocks and perform the one or more functions of the second plurality of code blocks based at least on the metadata;
identify, using the at least one control structure, at least one of (i) an update to the metadata or the one or more functions or (ii) a cyber event or incident corresponding with the at least one computing or networking infrastructure of the at least one entity.

13. The system of claim 12, the one or more processing circuits to:
in response to identifying the at least one of (i) the update to the metadata or the one or more functions or (ii) the cyber event or incident:
update, using the at least one control structure, the metadata of the first plurality of code blocks or the one or more functions; or
perform, using the at least one control structure, at least one function of the one or more functions to provide the at least one protection based on the metadata of the first plurality of code blocks; and
generate a ledger record corresponding with the metadata of the first plurality of code blocks or the at least one function; and
record the ledger record to a distributed ledger or data source.

14. The system of claim 11, wherein the first plurality of code blocks comprise at least a declarations block, and the one or more processing circuits to:
receive, using the communication interface or structure, an update corresponding with the one or more rules or conditions or the at least one computing or networking infrastructure of the at least one entity; and
update the composable cyber resilience object by (i) updating metadata of the declarations block and (ii) re-generating the second plurality of code blocks based at least on the declarations block.

15. The system of claim 11, wherein the second plurality of code blocks comprise one or more coverage blocks, the one or more coverage blocks corresponding with at least one agreement by the at least one third-party to provide the at least one protection and comprising at least one function of the one or more functions, and the one or more processing circuits to:
perform the at least one function, wherein performing causes the one or more coverage blocks to provide at least one of a ransomware protection data package, a fault protection data package, or an interruption protection data package to the at least one computing or networking infrastructure using the communication interface or structure.

16. The system of claim 11, wherein the first plurality of code blocks comprise at least an exclusion block, and the one or more processing circuits to:
determine, using the exclusion block, a restriction or limitation corresponding with providing the at least one protection based on modeling the configurations, assets, incidents, or safeguards of the at least one entity and the plurality of parameters of the at least one third-party; and
update the composable cyber resilience object by (i) updating metadata of the exclusion block and (ii) re-generating the second plurality of code blocks based on the restriction or limitation.

17. The system of claim 11, wherein the first plurality of code blocks comprise at least a conditions block, and the one or more processing circuits to:
transmit, using the conditions block, one or more compliance requests to the at least one computing or networking infrastructure of the at least one entity;
update, based on at least one response to the one or more compliance requests, the one or more rules or conditions for providing the at least one protection by updating metadata of the conditions block, wherein the at least one response to the one or more compliance requests comprises compliance data corresponding with the configurations, assets, incidents, or safeguards of the at least one entity; and
configure, using the conditions block, one or more additional compliance requests for the at least one entity based the plurality of parameters or the at least one response to the one or more compliance requests.

18. The system of claim 11, the one or more processing circuits to:
receive, using the communication interface or structure, one or more updated configurations, assets, incidents, or safeguards of the at least one entity;
model the one or more updated configurations, assets, incidents, or safeguards to determine an updated security posture; and
update the composable cyber resilience object by (i) updating metadata of the first plurality of code blocks and (ii) re-generating or re-selecting the second plurality of code blocks based on the updated security posture.

19. The system of claim 11, the one or more processing circuits to:
determine the at least one entity qualifies for the at least one protection based on modeling a cyber resilience of the at least one computing or networking infrastructure using one or more of the configurations, assets, incidents, or safeguards and the plurality of parameters of the at least one third-party.

20. A non-transitory computer readable storage medium (CRM) comprising one or more instructions stored thereon, one or more instructions executable by one or more processing circuits to:
identify a posture state of at least one entity based at least on configurations, assets, incidents, or safeguards of the at least one entity;
generate or select a first plurality of code blocks corresponding with a plurality of parameters of at least one third-party, wherein the plurality of parameters correspond with one or more rules or conditions for providing at least one protection to the at least one entity;
determine at least one entity qualifies for the at least one protection based on the posture state and the one or more rules or conditions;
generate or select a second plurality of code blocks comprising one or more functions to provide the at least one protection based on the one or more rules or conditions;
generate a composable cyber resilience object, wherein generating comprises integrating at least a portion of the first plurality of code blocks and the second plurality of code blocks into at least one data structure corresponding with one or more functions or fields of the composable cyber resilience object; and
link the composable cyber resilience object and at least one computing or networking infrastructure of the at least one entity using a communication interface or structure.
